(19) United States
(12) Patent Application Publication
(10) Pub. No.: US 2025/0029240 A1
(43) Pub. Date: Jan. 23, 2025

(54) MACHINE LEARNING TECHNIQUES FOR TERTIARY LYMPHOID STRUCTURE (TLS) DETECTION

(71) Applicant: BostonGene Corporation, Waltham, MA (US)

(72) Inventors: Vladimir Kushnarev, Yerevan (AM); Anna Belozerova, Novosibirsk (RU); Daniil Dymov, Moscow (RU); Pavel Ovcharov, Moscow (RU); Viktor Svekolkin, Ulyanovsk (RU); Alexander Bagaev, Waltham, MA (US); Zhongmin Xiang, Winchester, MA (US)

(73) Assignee: BostonGene Corporation, Waltham, MA (US)

(21) Appl. No.: 18/711,053

(22) PCT Filed: Feb. 14, 2023
(86) PCT No.: PCT/US2023/013050

§ 371 Date: May 16, 2024

Related U.S. Application Data
(60) Provisional application No. 63/310,072, filed on Feb. 14, 2022.

(51) Int. Cl. G06T 7/00; G06T 7/12; G06T 7/13; G06V 10/44; G06V 10/46; G06V 10/764

(52) U.S. Cl. CPC G06T 7/0012; G06T 7/12; G06T 7/13; G06V 10/44; G06V 10/46; G06V 10/764; G06T 2207/20084; G06T 2207/30024

(57) ABSTRACT

Techniques for identifying a tertiary lymphoid structure (TLS) in an image of tissue. The techniques include obtaining a set of overlapping sub-images of the image; processing the set of overlapping sub-images using a neural network model to obtain a set of pixel-level sub-image masks, each of the set of pixel-level sub-image masks indicating, for each of multiple pixels in a respective sub-image, a probability that the pixel is part of a TLS; determining a pixel-level mask for at least a portion of the image covered by at least some of the sub-images, the determining comprising determining the pixel-level mask using at least some of the set of pixel-level sub-image masks; identifying boundaries of a TLS in at least the portion of the image using the pixel-level mask; and identifying one or more features of the TLS using the identified boundaries and at least the portion of the image.

### CROSS-REFERENCE TO RELATED APPLICATIONS

This application claims the benefit of priority under 35 U.S.C. § 119(e) to U.S. provisional application Ser. No. 63/310,072, filed Feb. 14, 2022, entitled “TERTIARY LYMPHOID STRUCTURES (TLS) IN LUNG ADENOCARCINOMA (LUAD)”, the entire contents of which is incorporated by reference herein.

### BACKGROUND

Transcriptomic and morphological features of the tumor microenvironment (TME) can serve as biomarkers for clinical decision making by providing prognostic information and predicting response to specific therapies. Among these features are tertiary lymphoid structures (TLSs), which are organized aggregates of immune cells. Previous studies of non-small lung cell carcinoma (NSCLC) have shown that tertiary lymphoid structures (TLS) can be predictive of therapeutic response and a positive prognostic factor for survival.

### SUMMARY

Some embodiments provide for a method for using a trained neural network model to identify at least one tertiary lymphoid structure (TLS) in an image of tissue obtained from a subject having, at risk of having, or suspected of having cancer. The method comprises using at least one computer hardware processor to perform: obtaining a set of overlapping sub-images of the image of tissue; processing the set of overlapping sub-images using the trained neural network model to obtain a respective set of pixel-level sub-image masks, each of the set of pixel-level sub-image masks indicating, for each particular pixel of multiple individual pixels in a respective particular sub-image, a respective probability that the particular pixel is part of a tertiary lymphoid structure; determining a pixel-level mask for at least a portion of the image of the tissue covered by at least some of the sub-images in the set of overlapping sub-images, the determining comprising determining the pixel-level mask using at least some of the set of pixel-level sub-image masks corresponding to the at least some of the set of overlapping sub-images covering at least the portion of the image; identifying boundaries of at least one TLS in at least the portion of the image using the pixel-level mask; and identifying one or more features of the at least one TLS using the identified boundaries and at least the portion of the image.

In some embodiments, the image of the tissue is a whole slide image (WSI). In some embodiments, the tissue comprises hematoxylin-eosin stained tissue.

In some embodiments, the image is a three-channel image comprising at least 10,000 by 10,000 pixel values per channel, at least 50,000 by 50,000 pixel values per channel, or at least 100,000 by 100,000 pixel values per channel.

In some embodiments, the set of overlapping sub-images comprises at least 100, 1000, or 10,000 sub-images, each of the sub-images overlapping with at least one other image in the set of overlapping sub-images.

In some embodiments, each of the sub-images in the set of overlapping sub-images is a three-channel image comprising at least 2^{k} by 2^{k} pixel values per channel, where k is an integer equal to 8, 9, 10, 11, or 12.

In some embodiments, the trained neural network model comprises a deep neural network model.

In some embodiments, the trained neural network model comprises at least 10 million, at least 25 million, at least 50 million, or at least 100 million parameters.

In some embodiments, the trained neural network model comprises an encoder sub-model, a decoder sub-model, and an auxiliary classifier sub-model.

In some embodiments, the encoder sub-model comprises a plurality of resolution-separation neural network portions and a plurality of resolution-fusion neural network portions.

In some embodiments, the encoder sub-model comprises: an adapter neural network portion; a bottleneck neural network portion having an input coupled to the output of the adapter neural network portion; a first resolution-separation neural network portion having an input coupled to the output of the bottleneck neural network portion; a first resolution-fusion neural network portion having an input coupled to the output of the first resolution-separation neural network portion; a second resolution-separation neural network portion having an input coupled to the output of the first resolution-fusion neural network portion; and a second resolution-fusion neural network portion having an input coupled to the output of the second resolution-separation neural network portion.

In some embodiments, the encoder sub-model further comprises: a third resolution-separation neural network portion having an input coupled to the output of the second resolution-fusion neural network portion; and a third resolution-fusion neural network portion having an input coupled to the output of the third resolution-separation neural network portion.

In some embodiments, the decoder sub-model further comprises: an atrous spatial pyramid pooling (ASPP) neural network portion; an upsampling layer having an input coupled to the output of the ASPP neural network portion; a projection neural network portion; a classification neural network portion having an input coupled to the output of the upsampling layer and the projection neural network portion, wherein the classification neural network portion is configured to output a pixel-level mask, indicating, for each particular pixel of multiple individual pixels in an image being processed by the trained neural network model, a respective probability that the particular pixel is part of a tertiary lymphoid structure.

In some embodiments, the decoder sub-model further comprises: an atrous spatial pyramid pooling (ASPP) neural network portion having an input coupled to an output of the third resolution-fusion neural network portion; an upsampling layer having an input coupled to the output of the ASPP neural network portion; a projection neural network portion having an input coupled to an output of the bottleneck neural network portion; and a classification neural network portion having an input coupled to the output of the upsampling layer and the projection neural network portion, wherein the classification neural network portion is configured to output a pixel-level mask, indicating, for each particular pixel of multiple individual pixels in an image being processed by the trained neural network model, a respective probability that the particular pixel is part of a tertiary lymphoid structure.

In some embodiments, the auxiliary classifier sub-model comprises an average pooling layer, a dropout layer, a linear layer, and an activation layer.

In some embodiments, determining the pixel-level mask for at least the portion of the image by at least some of the sub-images comprises: determining weighting matrices for the at least some of the set of pixel-level sub-image masks; and determining the pixel-level mask as a weighted combination of the pixel-level sub-image masks weighted, element-wise, by the respective weighting matrices.

In some embodiments, identifying the boundaries of the at least one TLS in at least the portion of the image comprises: generating a binary version of the pixel-level mask; and identifying contours of the at least one TLS by applying a border-following algorithm to the binary version of the pixel-level mask.

In some embodiments, identifying the one or more features of the at least one TLS comprises identifying at least one feature selected from the group consisting of: a number of TLSs in at least the portion of the image, the number of TLSs in at least the portion of the image normalized by area of at least the portion of the image, a total area of TLSs in at least the portion of the image, the total area of TLSs in at least the portion of the image normalized by the area of at least the portion of the image, median area of TLSs in at least the portion of the image, the median area of TLSs in at least the portion of the image normalized by the area of at least the portion of the image.

In some embodiments, the method further comprises: obtaining an annotated set of WSI images of tissue obtained from subjects having a common type of cancer, the WSI images annotated to indicate locations of any TLS structures in the WSI images; generating batches of sub-images from the annotated set of WSI images; and training a neural network model using the generated batches of sub-images to obtain the trained neural network model.

In some embodiments, generating batches of sub-images comprises generating batches of sub-images to have target proportions of: (1) sub-images containing at least one TLS region (2) sub-images containing tissue but no TLS region; and (3) sub-images containing neither any TLS region nor tissue.

In some embodiments, the method further comprises: generating multiple sub-images containing at least one TLS region at least in part by, for each particular sub-image to be generated: (a) sampling a centroid from among a set of TLS centroids identified in the annotated WSI images with a probability depending on a characteristic of a TLS corresponding to the centroid; (b) identifying coordinates for a centroid for the particular sub-image; (c) determining that the identified coordinates for the centroid fall within a TLS region; and (d) when it is determined that the identified coordinates for the centroid fall within the TLS region, generate the particular sub-image having a center at the centroid.

In some embodiments, generating multiple sub-images containing tissue but no TLS at least in part by, for each particular sub-image to be generated: (a) identifying coordinates for a centroid for the particular sub-image by sampling the coordinates uniformly at random from a tissue region in one of the annotated WSI images; (b) determining that the identified coordinates do not intersect with a TLS region; and (c) when it is determined that the identified coordinates do not fall within the TLS region, generate the particular sub-image having a center at the centroid.

In some embodiments, the cancer is non-small cell lung cancer (NSCLC). In some embodiments, the cancer is lung adenocarcinoma. In some embodiments, the cancer is breast cancer. In some embodiments, the cancer is selected is lung adenocarcinoma, breast cancer, cervical squamous cell carcinoma, lung squamous cell carcinoma, head&neck squamous cell carcinoma, gastric adenocarcinoma, colorectal adenocarcinoma, liver adenocarcinoma, pancreatic adenocarcinoma, or melanoma.

In some embodiments, the method further comprises: determining, based on the one or more features of the at least one TLS, to administer an immunotherapy to the subject.

In some embodiments, the method further comprises administering the immunotherapy to the subject.

In some embodiments, the immunotherapy is an immune checkpoint inhibitor.

In some embodiments, administering the immunotherapy comprises administering pembrolizumab, nivolumab, atezolizumab, or durvalumab.

In some embodiments, at least the portion of the image consists of at least 75%, at least 80%, at least 90%, at least 95%, at least 99%, or 100% of pixels of the image.

Some embodiments provide for at least one non-transitory computer readable storage medium storing processor executable instructions that, when executed by at least one processor, cause the at least one processor to perform the method of any one of the foregoing embodiments.

Some embodiments provide for a system, comprising: at least one computer hardware processor; and at least one non-transitory computer readable storage medium storing processor executable instructions that, when executed by at least one processor, cause the at least one processor to perform the method of any one of the foregoing embodiments.

### BRIEF DESCRIPTION OF DRAWINGS

FIG. 1A is a diagram depicting an illustrative technique for using a trained neural network model to identify at least one tertiary lymphoid structure (TLS) in an image of tissue, according to some embodiments of the technology described herein.

FIG. 1B is a block diagram of a system 150 including example computing device 108 and software 112, according to some embodiments of the technology described herein.

FIG. 2A is a flowchart of an illustrative process 200 for using a trained neural network model to identify at least one TLS in an image of tissue, according to some embodiments of the technology described herein.

FIG. 2B is a flowchart of an illustrative process 250 for determining a weighted combination of pixel-level sub-image masks, according to some embodiments of the technology described herein.

FIGS. 2C-1, 2C-2, and 2C-3, 2D-1, 2D-2, 2D-3, and 2E show an example of using a trained neural network model to identify at least one TLS in an image of tissue, according to some embodiments of the technology described herein.

FIG. 3A illustrates an example architecture of a neural network model which may be used to identify at least one TLS in an image of tissue, according to some embodiments of the technology described herein.

FIG. 3B illustrates an example architecture of the adapter neural network portion 302 of FIG. 3A, according to some embodiments of the technology described herein.

FIG. 3C illustrates an example architecture of a portion of the encoder 310 of FIG. 3A including the bottleneck neural network portion 303, resolution-separation neural network portions, and resolution-fusion neural network portions, according to some embodiments of the technology described herein.

FIG. 3D illustrates an example architecture of the bottleneck neural network portion 303 if FIG. 3A, according to some embodiments of the technology described herein.

FIG. 3E illustrates an example architecture of a resolution-separation neural network portion, according to some embodiments of the technology described herein.

FIG. 3F illustrates an example architecture of a resolution-fusion neural network portion, according to some embodiments of the technology described herein.

FIG. 3G illustrates an example architecture of the projection neural network portion 323 of FIG. 3A, according to some embodiments of the technology described herein.

FIG. 3H illustrates an example architecture of the atrous spatial pyramid pooling (ASPP) neural network portion 321 of FIG. 3A, according to some embodiments of the technology described herein.

FIG. 3I illustrates an example architecture of the classification neural network portion 324 of FIG. 3A, according to some embodiments of the technology described herein.

FIG. 3J illustrates an example architecture of the auxiliary sub-model 330 of FIG. 3A, according to some embodiments of the technology described herein.

FIG. 4A is a flowchart of an illustrative process 400 for training a neural network model to identify at least one TLS in an image of tissue, according to some embodiments of the technology described herein.

FIG. 4B is a flowchart of an illustrative process 450 for sampling data for training a neural network model to identify at least one TLS in an image of tissue, according to some embodiments of the technology described herein.

FIG. 4C is a schematic showing an example separation of data for training and testing the neural network model, according to some embodiments of the technology described herein.

FIG. 4D is a schematic depicting an example data pre-processing and sampling strategy for training a neural network model, according to some embodiments of the technology described herein.

FIGS. 5A-5B show that the TLS prediction results obtained using embodiments of the machine learning techniques described herein correlate with TLS-defining gene signatures.

FIGS. 6A-6C show representative data comparing performance of human annotators (pathologists) and embodiments of the technology described herein for TLS detection from a lung adenocarcinoma prospective cohort. FIG. 6A shows detection of nuclear counts per TLS. FIG. 6B shows nuclear density per TLS. FIG. 6C shows TLS area.

FIGS. 6D-6E shows representative data for intraclass correlation coefficient (ICC) between embodiments of the neural network techniques described herein and human annotators (pathologists) using a Validation data cohort.

FIGS. 7A-7E shows representative data for overall survival (OS) analysis.

FIG. 8 depicts an illustrative implementation of a computer system that may be used in connection with some embodiments of the technology described herein.

### DETAILED DESCRIPTION

The inventors have developed machine learning techniques for identifying tertiary lymphoid structures (TLSs) in images of tissue obtained from a subject having, suspected of having, or at risk of having cancer. In some embodiments, the techniques include using a trained neural network model to determine a pixel-level mask for at least a portion of an image of tissue. For example, the pixel-level mask may indicate, for each of multiple pixels in the image, a respective probability that the particular pixel is part of a TLS. In some embodiments, the pixel-level mask may be used to identify features of at least one TLS in the image, and the identified features may be used to recommend a therapy (e.g., an immunotherapy) to be administered to the subject.

As used herein, “tertiary lymphoid structure” or “TLS” refers to ectopic lymphoid organs that develop in non-lymphoid tissues at sites of chronic inflammation, including tumors. Structural features of TLS have been described, for example by Sautés-Friedman et al., Nature Reviews Cancer volume 19, pp. 307-325 (2019). In some embodiments, the presence of TLS in a biological sample obtained from a subject is indicative of the subject having a better prognosis (e.g., relative to subjects not having TLS), and/or responding efficiently to immunotherapies (e.g., relative to subjects not having TLS), for example as described by Dieu-Nosjean et al. Immunol Rev. 2016 May; 271(1):260-75. doi: 10.1111/imr.12405.

The presence of TLSs in tumor tissue has been shown to be associated with prolonged patient survival and a positive therapeutic response to immunotherapy. Accordingly, tumor tissue may be analyzed for the presence of TLSs, and characteristics of the identified TLSs may be used to predict how a patient will respond to a particular therapy, to diagnose the patient, or to estimate patient survival. For example, tumor tissue having a greater number of TLSs and/or a greater area occupied TLSs may suggest that a patient will have prolonged survival and may respond positively to a particular immunotherapy.

Conventionally, TLS identification is manually performed by pathologists. For example, the pathologist may obtain an image of tissue, visually assess the image, and manually label regions of the image that they identify as including a TLS. There are multiple problems associated with such conventional techniques. One problem is that identifying TLSs is a subjective procedure that results in issues of reproducibility caused by different pathologists making different decisions about how to label an image. Accordingly, treatment recommendations and/or survival outcomes estimated based on such data may also differ. Another problem with conventional techniques is that the manual analysis of such data is very inefficient. Manually labelling such image data is extremely time-consuming, leading to high costs, which in turn affects the quality of the data processing results or the study overall.

Recently, there have been developments towards automated approaches for detecting the presence of TLSs in tumor tissue. In particular, machine learning techniques have been developed to automate the process of detecting the presence of TLSs in tumor tissue. However, the inventors have recognized that there are a number of problems associated with such existing machine learning techniques. First, such techniques do not have consistently high performance, leading to inaccurate predictions that make such techniques unreliable for clinical applications. For example, treatment recommendations and survival outcome predictions that are based on inaccurate TLS identification predictions will also be inaccurate. Accordingly, this precludes such techniques from being a reliable tool for making treatment decisions and informing diagnoses.

Another problem with the existing machine learning techniques that have been developed to detect the presence of TLS in tumor tissue is that they require large volumes of training data. Using a large volume of training data increases the computational burden of the training procedure, increasing the processor and memory resources that need to be consumed to train the machine learning model. Furthermore, using large volumes of training data increases the expenses in time and cost associated with manually annotating such data.

Accordingly, the inventors have developed techniques that address the above-described limitations associated with existing automated TLS identification techniques. In some embodiments, the techniques involve using a trained neural network model to determine a pixel-level mask for at least a portion of an image of tissue. For example, the pixel-level mask may indicate, for each of multiple pixels in the image, a respective probability that the particular pixel is part of a TLS. In some embodiments, the pixel-level mask is determined by (a) obtaining a set over overlapping sub-images of the image of tissue; (b) processing the set of overlapping sub-images using the trained neural network model to obtain a respective set of pixel-level sub-image masks; and (c) determining the pixel-level mask using at least some of the set of pixel-level sub-image masks corresponding to the at least some of the set of overlapping sub-images. In some embodiments, the pixel-level mask may be used to identify features of at least one TLS in the image, and the identified features may be used to recommend a therapy (e.g., an immunotherapy) to be administered to the subject.

The TLS identification neural network models developed by the inventors have been shown to have improved performance, increased generalizability, and a more efficient training process, as compared to existing TLS identification machine learning techniques. In particular, a number of aspects of the TLS identification neural network developed by the inventors contribute to these improvements.

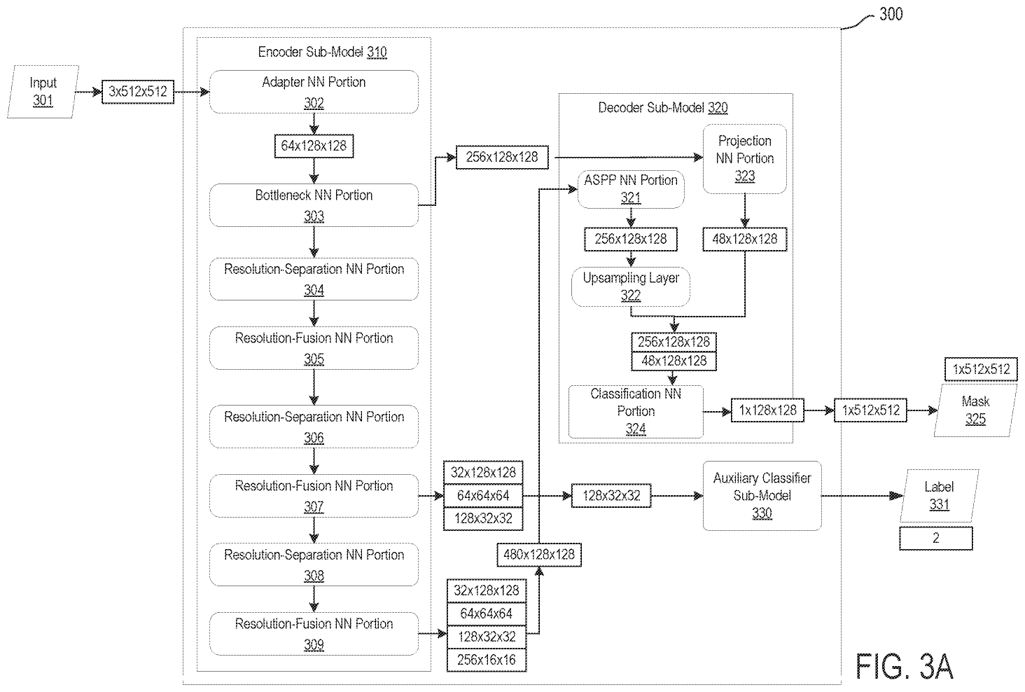

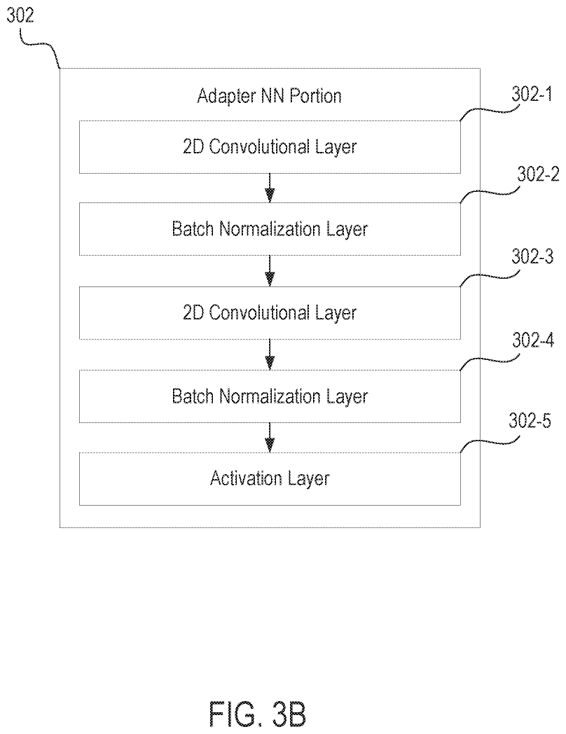

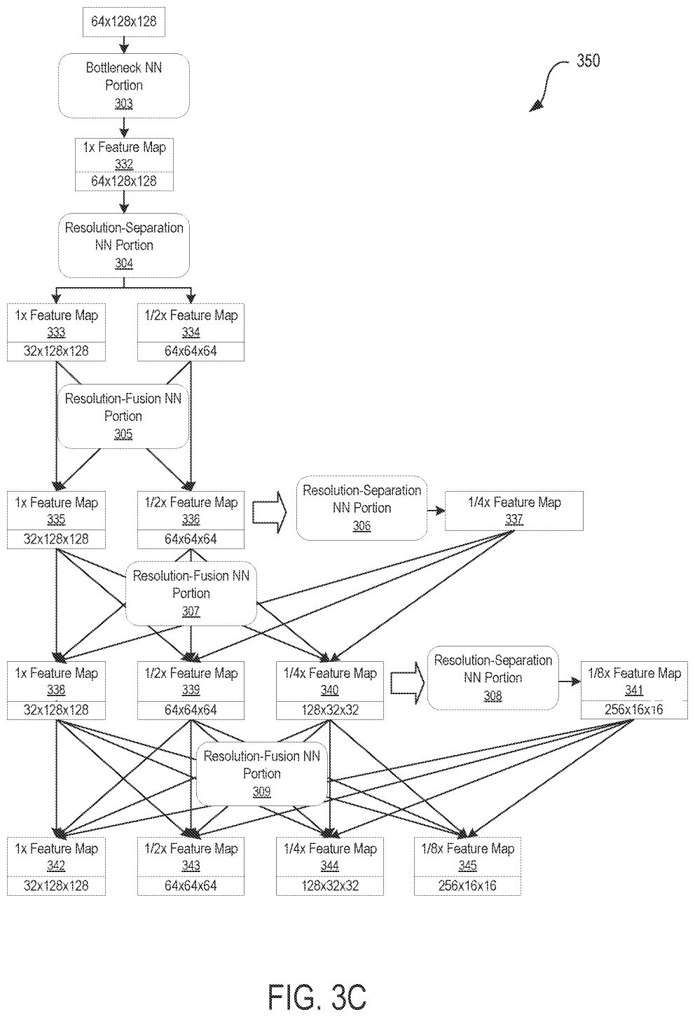

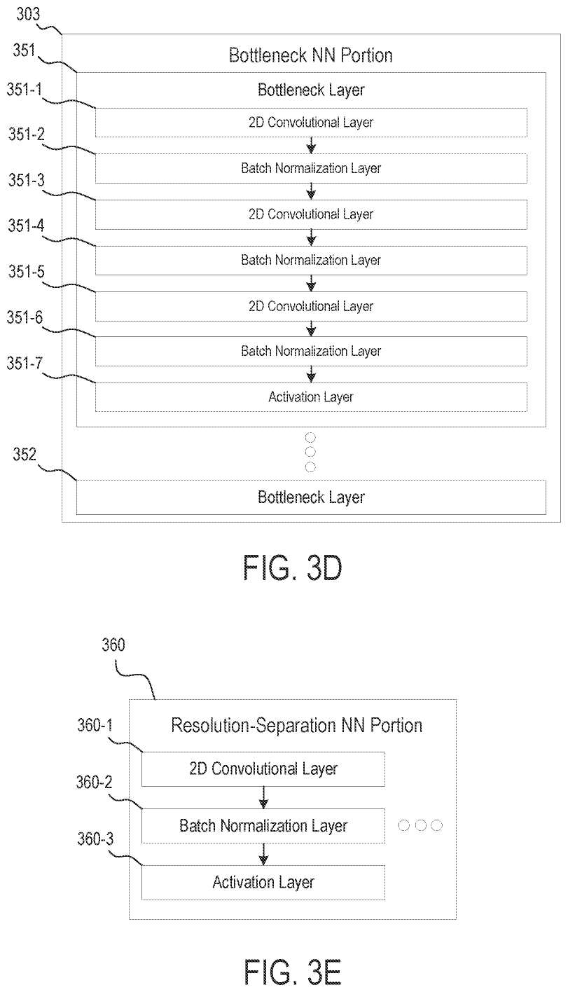

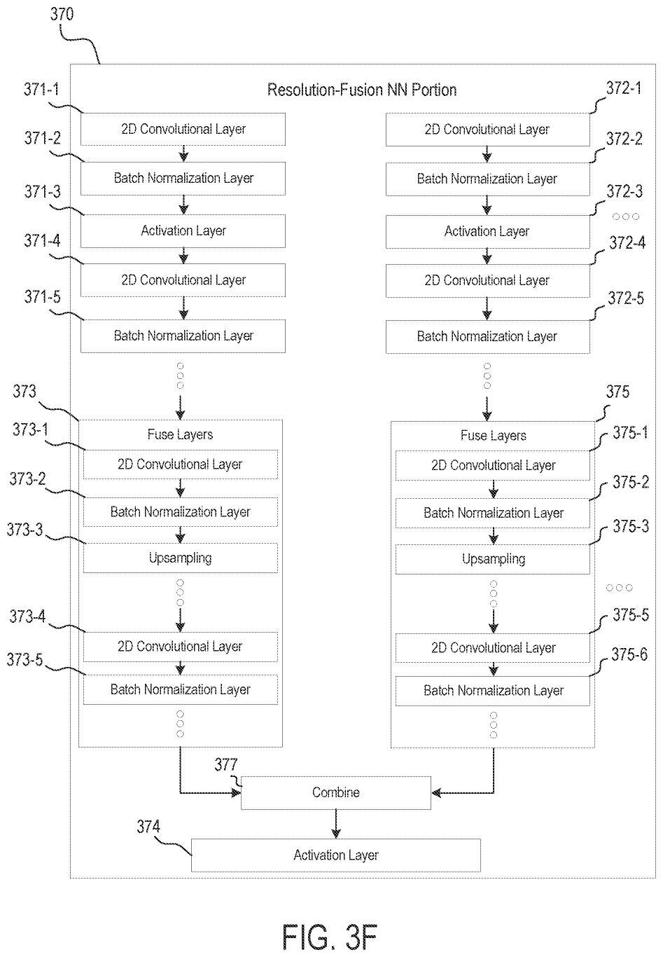

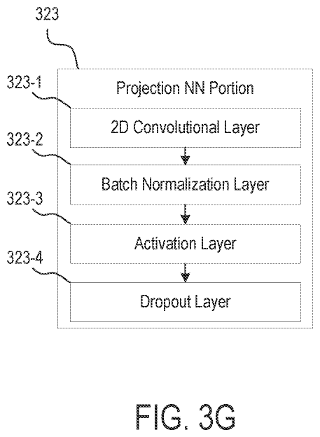

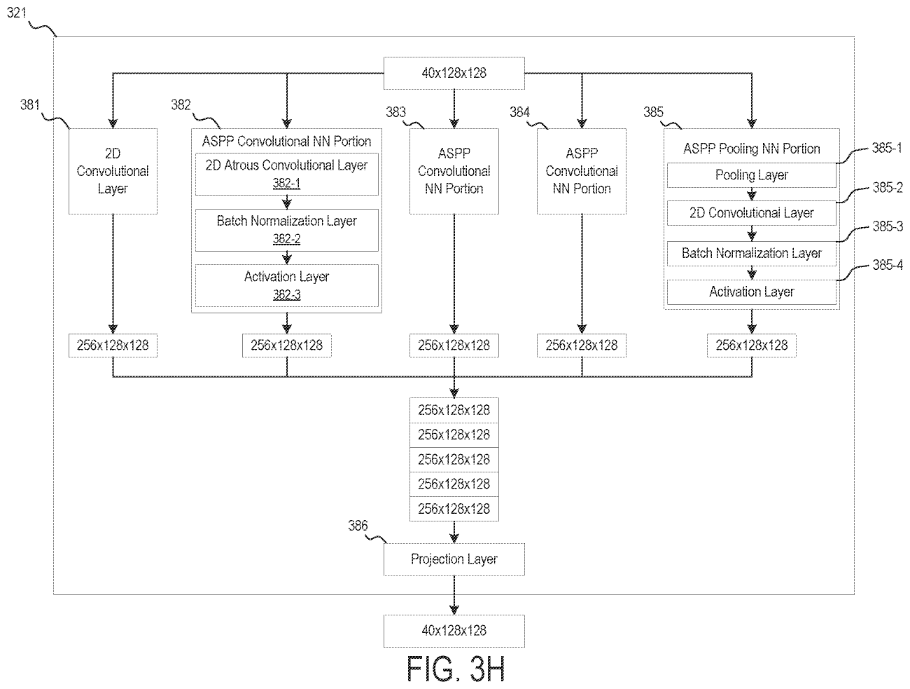

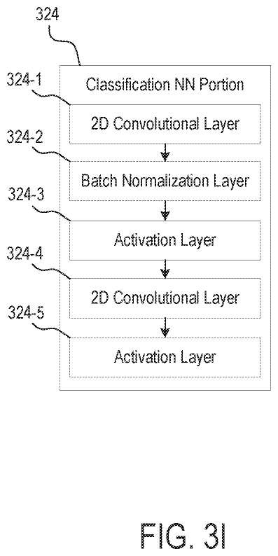

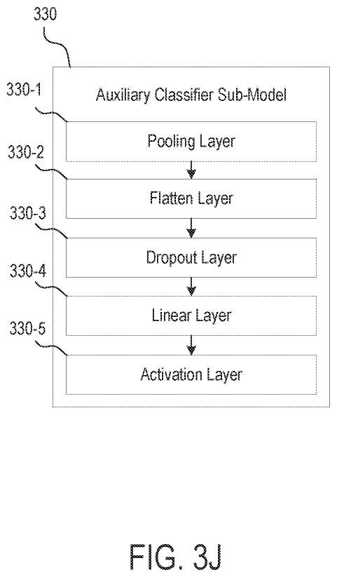

For example, one aspect of the techniques developed by the inventors that contributes to improvements over existing TLS identification techniques includes the architecture of the encoder sub-model of the neural network model developed by the inventors. In some embodiments, as described herein, including at least with respect to FIGS. 3A-3C, the architecture of the encoder sub-model may be configured to maintain high-resolution representations (e.g., feature maps) of an input image throughout the processing of the input image with the neural network model. For example, as described herein, this may be achieved by connecting high-to-low resolution convolution streams in parallel, as opposed to connecting the high-to-low resolution convolutions in series, as may be done in other deep learning approaches to semantic segmentation such as, for example, in a U-Net convolutional architecture. By maintaining high-resolution representations of the input image, contextual information from that image is retained. Contextual information (e.g., information about regions of the image surrounding a TLS) is important for accurately identifying TLSs. Accordingly, embodiments of the encoder sub-model described herein serve to improve the accuracy of TLS identification by the trained neural network model because such embodiments are configured to retain and utilize contextual information.

Another aspect of the techniques developed by the inventors that contributes to the improvements over existing TLS identification techniques includes the architecture of the decoder sub-model of the neural network developed by the inventors. In some embodiments, as described herein including at least with respect to FIGS. 3A and 3H, the decoder sub-model may use atrous spatial pyramid pooling (ASPP). In some embodiments, ASPP uses atrous spatial convolutions, which may be used to adjust the field-of-view of the convolution, without impacting computational complexity or the number of parameters. Accordingly, ASPP accounts for more contextual information by increasing the field-of-view, without increasing computational complexity. As described herein, accounting for contextual information helps to improve the accuracy of TLS identification by the trained neural network model. Accordingly, embodiments of the decoder sub-model described herein serve to improve the accuracy of TLS identification by the trained neural network model because such embodiments are configured to retain and utilize contextual information using ASPP.

Another aspect of the techniques developed by the inventors that contributes to the improvements over existing TLS identification techniques includes the use of an auxiliary classifier sub-model during the training process of the neural network model. For example, an auxiliary classifier is described herein including at least with respect to FIGS. 3A and 3J. In some embodiments, the auxiliary classifier is configured to predict the probability that a sub-image includes at least one TLS. The results of the predictions contribute to the loss function. Accordingly, in some embodiments, the use of such as an auxiliary classifier may improve the robustness of the training process, especially since the image data used to train the neural network is noisy and complex. Using a more robust training process to train the neural network model improves the accuracy and reliability of the outputs of said model.

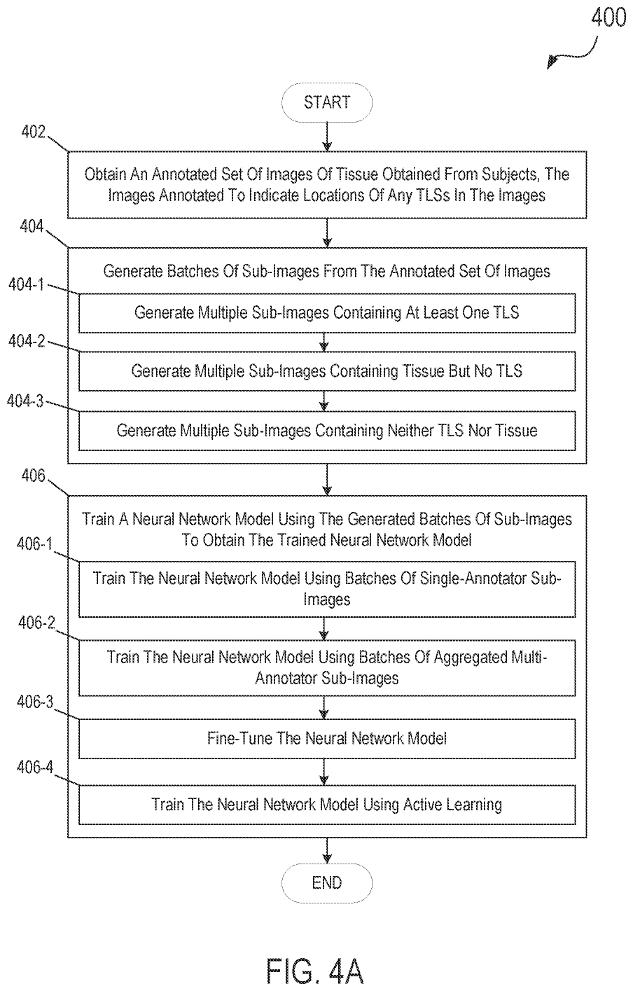

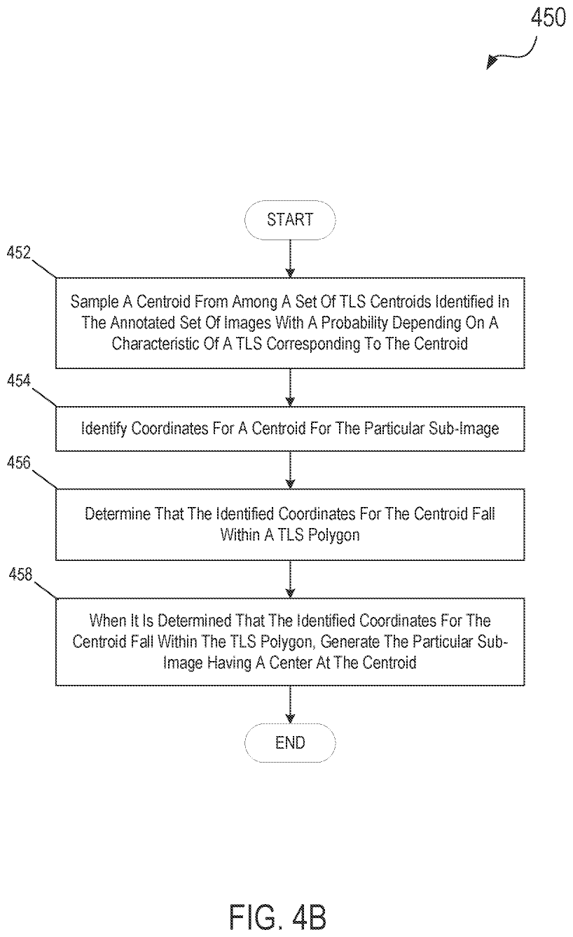

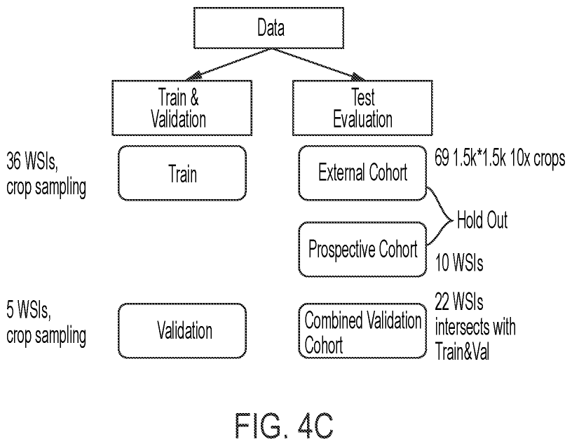

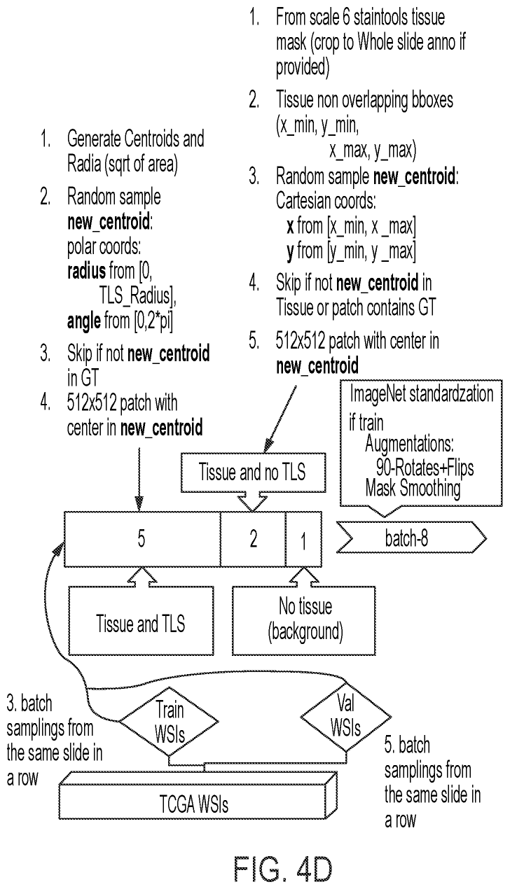

Another aspect of the techniques developed by the inventors that contributes to the improvements over existing TLS identification techniques includes the techniques for sampling training data. Example techniques for sampling training data are described herein including at least with respect to FIGS. 4A-4B. For example, in some embodiments, training data may be sampled such that each batch of training data used to train the neural network model includes particular types of sub-images. For example, a particular batch of training data may include (1) sub-images containing at least one TLS region; (2) sub-images containing tissue but no TLS region; and (3) sub-images containing neither any TLS region nor tissue. In some embodiments, the ratio of the different types of sub-images may be selected to avoid unbalanced datasets caused by the overinclusion of sub-images that do not contain TLS. Training the neural network using balanced datasets results in improved performance. In addition, the batch generation techniques developed by the inventors allow for training the neural networks described herein with less training data, which reduces the computational burden of learning the neural network parameters and the expense of employing expert annotators to generate additional annotated WSI images for training.

One or more of the above-described aspects of the techniques developed by the inventors may be included in any of the embodiments of the technology described herein.

Following below are descriptions of various concepts related to, and embodiments of, machine learning techniques for identifying TLS structures in images of tissue obtained from a subject having, at risk of having or suspected of having cancer. It should be appreciated that various aspects described herein may be implemented in any of numerous ways. Examples of specific implementations are provided herein for illustrative purposes only. In addition, the various aspects described in the embodiments below may be used alone or in any combination and are not limited to the combinations explicitly described herein.

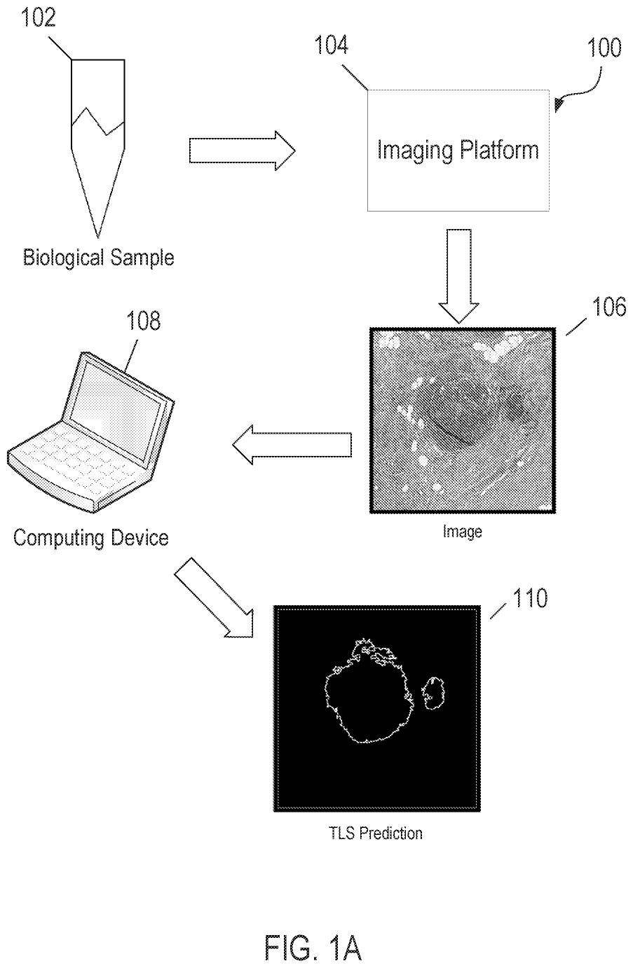

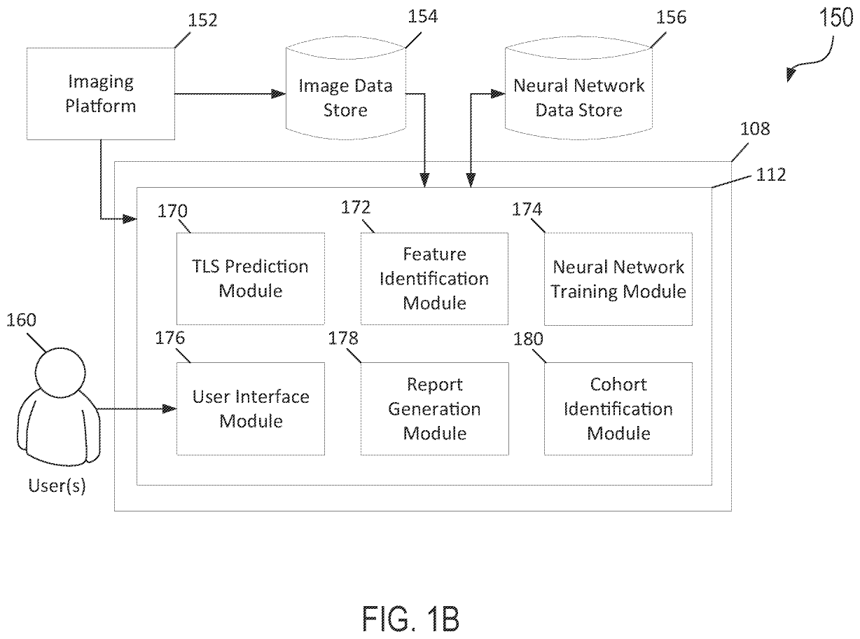

FIG. 1A is a diagram depicting an illustrative technique 100 for using a trained neural network model to identify at least one tertiary lymphoid structure (TLS) in an image of tissue, according to some embodiments of the technology described herein. Technique 100 includes obtaining a TLS prediction 110 for at least a portion of an image 106 using computing device 108. In some embodiments, the image 106 is obtained, or may have been previously-obtained, by imaging a biological sample 102 (e.g., tissue) using imaging platform 104. For example, the image 106 may include an image of tissue (e.g., tissue that has been formal-fixed paraffin embedded, cut, placed on a slide, stained with a hematoxylin and eosin (H&E) stain) obtained the biological sample 102. In some embodiments, the computing device 108 may be part of imaging platform 104. In other embodiments, the computing device 108 may be separate from the imaging platform 104 and may receive image 106, directly or indirectly, from the imaging platform 104.

In some embodiments, the illustrated technique 100 may be implemented in a clinical or laboratory setting. For example, the illustrated technique 100 may be implemented on a computing device 108 that is located within the clinical or laboratory setting. In some embodiments, the computing device 108 may directly obtain image 106 from an imaging platform 104 within the clinical or laboratory setting. For example, a computing device 108 included within the imaging platform 104 may directly obtain image 106 from the imaging platform 104. In some embodiments, the computing device 108 may indirectly obtain image 106 from an imaging platform 104 that is located within or external to the clinical or laboratory setting. For example, a computing device 108 may obtain image 106 via at least one communication network, such as the Internet or any other suitable communication network(s), as aspects of the technology described herein are not limited in this respect.

In some embodiments, the illustrated technique 100 may be implemented in a setting that is remote from a clinical or laboratory setting. For example, the illustrated technique 100 may be implemented on a computing device 108 that is located externally from a clinical or laboratory setting. In this case, the computing device 108 may indirectly obtain image 106 that is generated using an imaging platform 104 located within or external to a clinical or laboratory setting. For example, the image 106 may be provided to computing device 108 via at least one communication network, such as the Internet or any other suitable communication network(s), as aspects of the technology described herein are not limited in this respect.

As shown in FIG. 1A, the technique 100 involves imaging a biological sample 102 using an imaging platform 104, which generates image 106. The biological sample 102 may be obtained from a subject having, suspected of having, or at risk of having cancer and/or any immune-related disease. The biological sample 102 may be obtained by performing a biopsy or by obtaining a blood sample, a salivary sample, or any other suitable biological sample from the subject. The biological sample 102 may include diseased tissue (e.g., cancerous), and/or healthy tissue. In some embodiments, prior to imaging, the biological sample 102may be stained using a histological stain. For example, the biological sample 102 may be stained using a hematoxylin and eosin (H&E) stain, Masson triple or trichrome stain, an elastic fiber stain, a silver stain, a period acid Schiff (PAS) stain or any other suitable type of stain. In some embodiments, the origin or preparation methods of the biological sample may include any of the embodiments described herein including with respect to the “Biological Samples” section.

The imaging platform 104 may include any instrument, device, and/or system suitable for imaging a biological sample (e.g., tissue in a slide), as aspects of the technology are not limited in this respect. For example, the imaging platform 104 may include a whole slide imaging (WSI) scanner, a digital microscope, or any other suitable instrument, device, and/or system for pathology imaging of tissue. In some embodiments, the biological sample 102 may be prepared according to the manufacturer's protocol associated with the imaging platform 104.

In some embodiments, the imaging platform 104 may be configured to store an image at multiple resolutions to facilitate retrieval of image data at any suitable resolution. For example, the imaging platform 104 may be configured to store image data at the highest resolution as captured by the imaging platform 104 and at one or more resolutions lower than the highest resolution. For example, image 106 may include image data at the highest resolution captured by imaging platform 104, or it may include image data at a lower resolution (e.g., a 4× downscale of the highest resolution).

The image 106 may be a single-channel image or a multi-channel image (e.g., a 3-channel RGB image). Though it should be appreciated that the image 106 may comprise pixel values for any suitable number of channels depending on how imaging is performed, and the imaging platform used for same.

In some embodiments, the image 106 may include a whole slide image (WSI). The image 106 may have any suitable dimensions, as aspects of the technology are not limited in this respect. For example, the image 106 may have at least 100,000×100,000 pixel values per channel, 75,000×75,000 pixel values per channel, 50,000×50,000 pixel values per channel, 25,000×25,000 pixel values per channel, 10,000×10,000 pixel values per channel, 5,000×5,000 pixel values per channel or any other suitable number of pixels per channel. The dimensions of image 106 may be within any suitable range such as, for example, 50,000-500,000×50,000-500,000 pixel values per channel, 25,000-1 million×25,000-1 million pixel values per channel, 5,000-2 million×5,000-2 million pixel values per channel, or any other suitable range within these ranges.

In some embodiments, computing device 108 is used to process image 106. The computing device 108 may be operated by a user such as a doctor, clinician, researcher, patient, and/or any other suitable individual or entity. For example, the user may provide the image 106 as input to the computing device 108 (e.g., by uploading a file), and/or may provide user input specifying processing or other methods to be performed using the image 106.

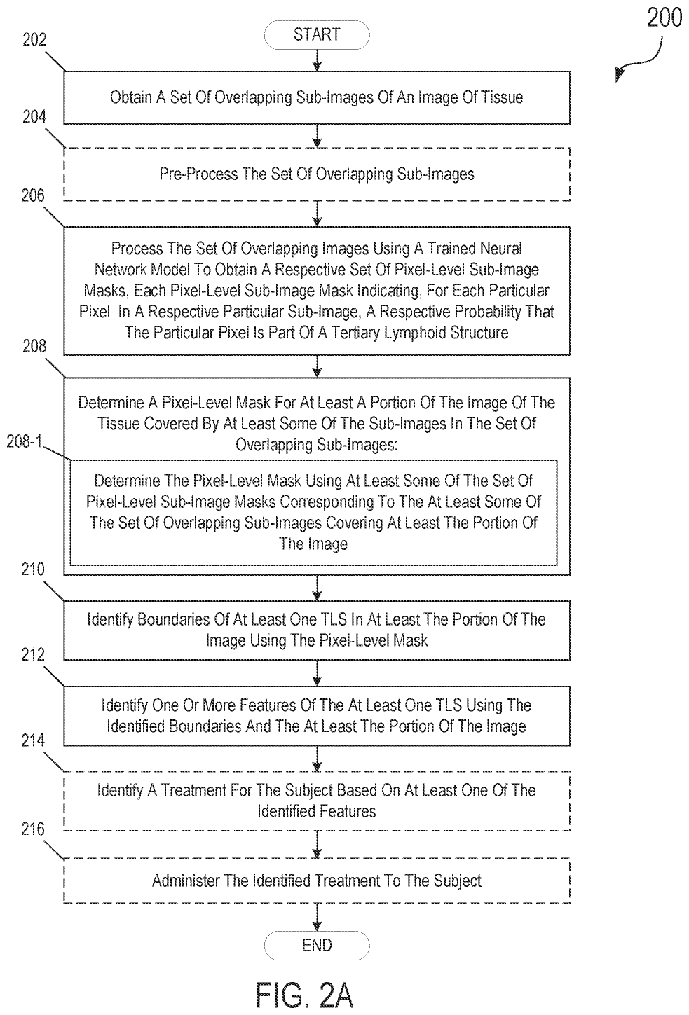

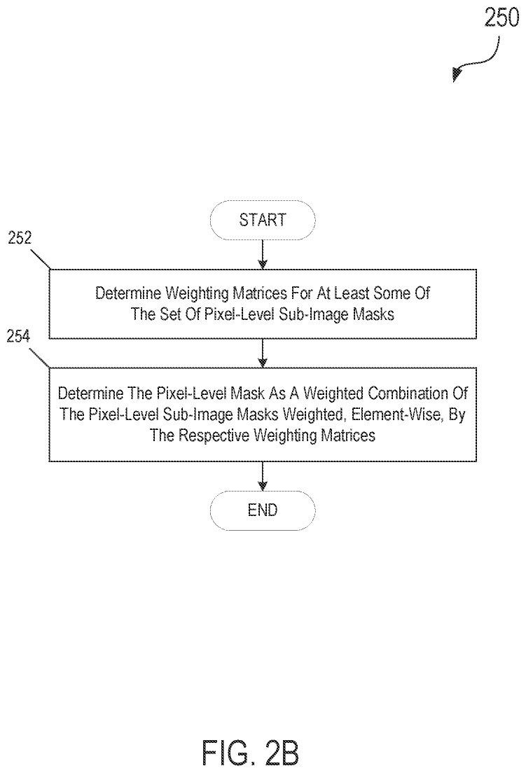

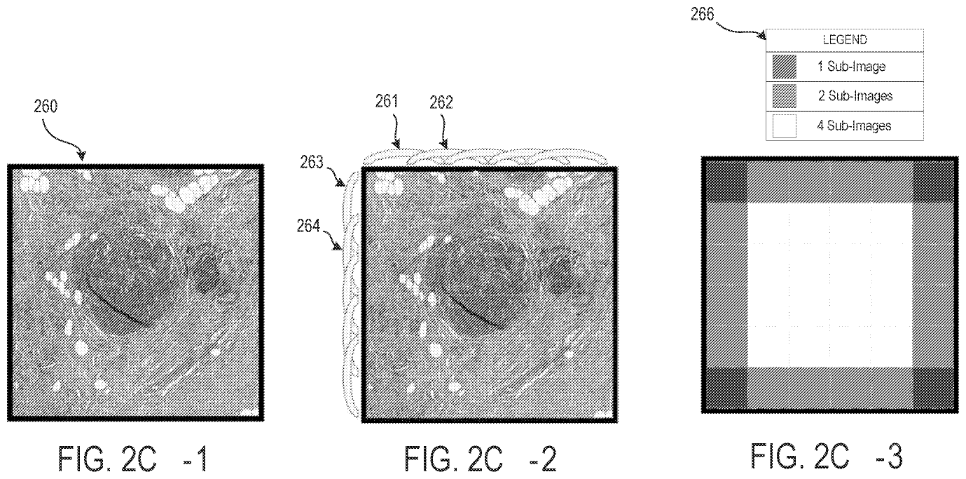

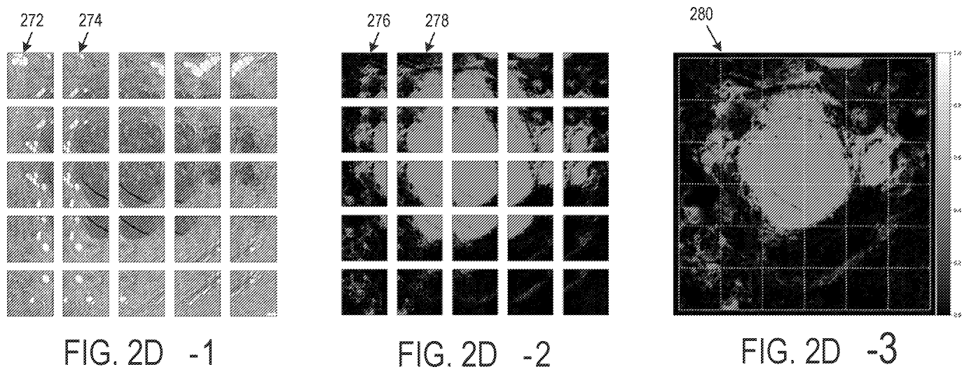

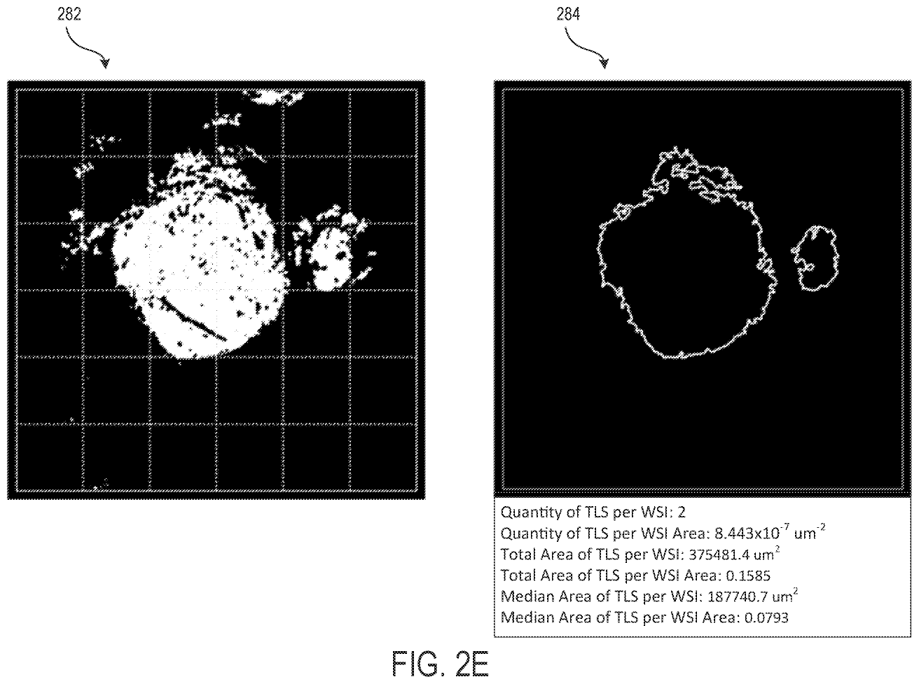

In some embodiments, computing device 108 includes software configured to perform various functions with respect to the image 106. An example of computing device 108 including such software is described herein including at least with respect to FIG. 1B. In some embodiments, software on computing device 108 may be configured to process at least a portion of the image 106 (e.g., the whole image or less than the whole image) to identify at least one TLS in the portion of the image 106. In some embodiments, this may include: (a) generating, from the image 106, a set of multiple overlapping sub-images, (b) processing the set of sub-images using a trained neural network to obtain a respective set of pixel-level sub-image masks, and (c) determining a pixel-level mask for the portion of image 106 based on the pixel-level sub-image masks. In some embodiments, a pixel-level sub-image mask may indicate, for each of multiple pixels in a respective sub-image, the probability that the particular pixel is a part of a TLS. Since the sub-images overlap one another, the neural network may be configured to process data associated with a particular pixel more than one time (e.g., for pixels included in the overlapping area). Therefore, the neural network model may predict, for a single pixel, multiple probabilities that the particular pixel is part of a TLS. Accordingly, in some embodiments, determining the pixel-level mask for the portion of the image includes combining the probabilities predicted for a single pixel to determine a single probability that the particular pixel is part of a TLS. Example techniques for using a trained neural network model to identify at least one TLS in an image of tissue are described herein including at least with respect to FIGS. 2A-2B.

In some embodiments, software on the computing device 108 is further configured to identify boundaries of at least one TLS in the image 106. For example, the boundaries may be used to distinguish between regions of the image 106 that include one or more TLSs and regions of the image that do not include any TLS. Such boundaries may be used to distinguish between different TLSs in the image 106.

In some embodiments, software on the computing device 108 may use the identified boundaries to identify one or more features of the TLS(s) identified in the image 106. A feature may include any suitable feature of TLS(s), as aspects of the technology are not limited in this respect. As non-limiting examples, the features may include a number of TLSs in at least the portion of the image, the number of TLSs in at least a portion of the image normalized by area of the portion of the image, a total area of TLSs in at least a portion of the image, the total area of TLSs in at least a portion of the image normalized by the area of at the portion of the image, median area of TLSs in at least a portion of the image, and the median area of TLSs in at least a portion of the image normalized by the area of the portion of the image.

In some embodiments, software on the computing device 108 may use the identified TLS features to generate a recommendation for treating a subject from which biological sample 102 was obtained. For example, one or more of the identified TLS features may be used as prognostic or predictive biomarkers for diagnosing the subject, predicting overall survival for the subject, and/or predicting how the subject will respond to a particular therapy. Accordingly, in some embodiments, the software on the computing device 108 may generate a recommendation for diagnosing the subject and/or for administering a particular therapy to the subject. In some embodiments, the software may be configured to predict, based on the identified TLS features, how a subject will respond to a particular therapy, and may recommend administration of the particular therapy when the subject is predicted to respond positively to the particular therapy. For example, when the number of TLSs in at least a portion of an image normalized by the area of the portion of the image is greater than a threshold, the software may be configured to recommend an immunotherapy (e.g., a checkpoint inhibitor immunotherapy) for the subject.

In some embodiments, technique 100 includes generating output 110. Output 110 may be indicative of one or more TLSs identified by computing device 108. For example, output 110 may include a pixel-level mask generated by processing image 106 using computing device 108 and/or a version of at least a portion of image 106 indicating the boundaries of at least one TLS. Additionally, or alternatively, output 110 may indicate the probability that the image 106 includes or does not include at least one TLS. Additionally, or alternatively, output 110 may include a recommendation for administering a particular therapy (e.g., an immunotherapy such as a checkpoint inhibitor therapy) to and/or diagnosing the subject from which biological sample 102 was obtained.

In some embodiments, output 110 is stored (e.g., in memory), displayed via a user interface, transmitted to one or more other devices, or otherwise processed using any suitable techniques, as aspects of the technology are not limited in this respect. For example, the output 110 may be displayed using a graphical user interface (GUI) of a computing device (e.g., computing device 108).

FIG. 1B is a block diagram of a system 150 for using a trained neural network model to identify at least one TLS in an image of tissue, according to some embodiments of the technology described herein. System 150 includes computing device 108 that is configured to have software 112 execute thereon to perform various functions in connection with identifying TLSs in an image of tissue and using features of the identified TLSs as biomarkers for recommending administration of a therapy and/or for diagnosing a subject.

The computing device 108 can be one or multiple computing devices of any suitable type. For example, the computing device 108 may be a portable computing device (e.g., laptop, a smartphone) or a fixed computing device (e.g., a desktop computer, a server). When computing device 108 includes multiple computing devices, the device(s) may be physically co-located (e.g., in a single room) or distributed across multiple physical locations. In some embodiments, the computing device 108 may be part of a cloud computing infrastructure.

In some embodiments, the computing device 108 may be operated by one or more user(s) 160 such as one or more researchers and/or other individual(s). For example, the user(s) 160 may provide image data as input to the computing device 108 (e.g., by uploading one or more files), and/or may provide user input specifying processing or other methods to be performed on the image data.

As shown in FIG. 1B, software 112 includes a plurality of modules. Each module may include processor-executable instructions that, when executed by at least one computer hardware processor, cause the at least one computer hardware processor to perform the function(s) of that module. Such modules are sometimes referred to herein as “software modules.” The software modules shown in FIG. 1B, include processor-executable instructions that, when executed by a computing device, cause the computing device to perform one or more processes, such as the processes described herein including at least with respect to FIGS. 2A-2B, and 4A-4B. It should be appreciated that the modules shown in FIG. 1B are illustrative and that, in other embodiments, software 112 may be implemented using one or more other software modules, in addition to or instead of, the modules shown in FIG. 1B. In other words, the software 112 may be organized internally differently from how illustrated in FIG. 1B.

As shown in FIG. 1B, software 112 includes multiple software modules for processing at least a portion of an image of tissue, such as TLS prediction module 170, feature identification module 172, cohort identification module 180, and report generation module 178. In the embodiment of FIG. 1B, the software 110 additionally includes a user interface module 176 through which a user may interact with software 112 (e.g., to provide input and/or review output).

In some embodiments, the TLS prediction module 170 obtains image(s) (e.g., image 106 in FIG. 1A) from imaging platform 152 (e.g., imaging platform 104 in FIG. 1A), image data store 154, and/or user(s) 160 (e.g., by the user uploading the image(s)).

In some embodiments, the TLS prediction module 170 is configured to determine a probability that at least a portion of an image includes a TLS. For example, the TLS prediction module 170 may be configured to process one or more sub-images of the portion of the image using a neural network model to obtain a respective set of pixel-level sub-image masks. As described herein, a pixel level sub-mask may indicate for each of multiple pixels in a sub-image, the probability that the particular pixel is part of a TLS. In some embodiments, the TLS prediction module 170 is further configured to determine a pixel-level mask for the portion of the image based on the pixel-level sub-masks. For example, the TLS prediction module 170 may be configured to combine the pixel-level sub-masks to obtain the pixel-level mask for the portion of the image. Example techniques for determining a probability that an image includes a TLS are described herein including at least with respect to acts 206-208 of process 200 in FIG. 2A.

In some embodiments, the feature identification module 172 is configured to identify one or more TLS features based on the output of TLS prediction module 170. For example, the feature identification module 172 may be configured to identify boundaries of one or more TLSs based on a pixel-level mask output by TLS prediction module 170. As described herein, this may be achieved, in some embodiments, by generating a binary version of the pixel-level mask output by the TLS prediction module 170 (e.g., by binarizing the mask with respect to a threshold) and identifying contours of at least one TLS by applying a border-following algorithm to the binary version of the pixel-level mask.

In some embodiments, the feature identification module 172 may be configured to identify the one or more features based on the identified TLS boundaries. For example, the feature identification module 172 may use the boundaries to determine a number of TLSs in the portion of the image, an area of each TLS, and/or an area of the portion of the image that does not include any TLSs. These values may serve as features and/or may be used to determine additional TLS features. For example, the feature identification module 172 may determine the number of TLSs in at least a portion of the image normalized by area of the portion of the image, a total area of TLSs in at least a portion of the image, the total area of TLSs in at least a portion of the image normalized by the area of at the portion of the image, median area of TLSs in at least a portion of the image, and/or the median area of TLSs in at least a portion of the image normalized by the area of the portion of the image.

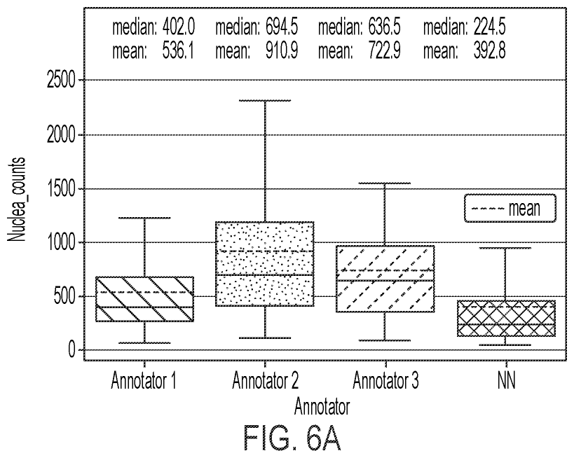

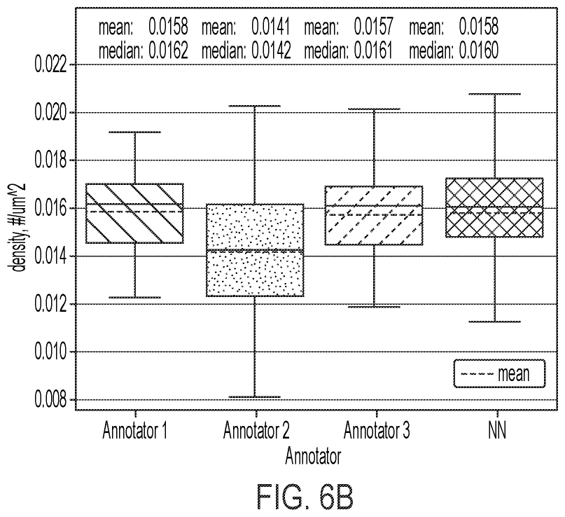

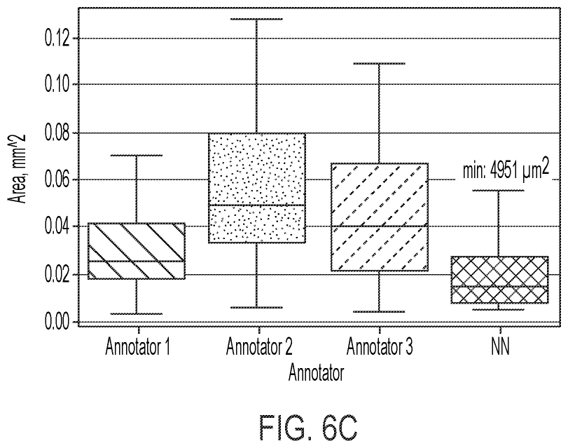

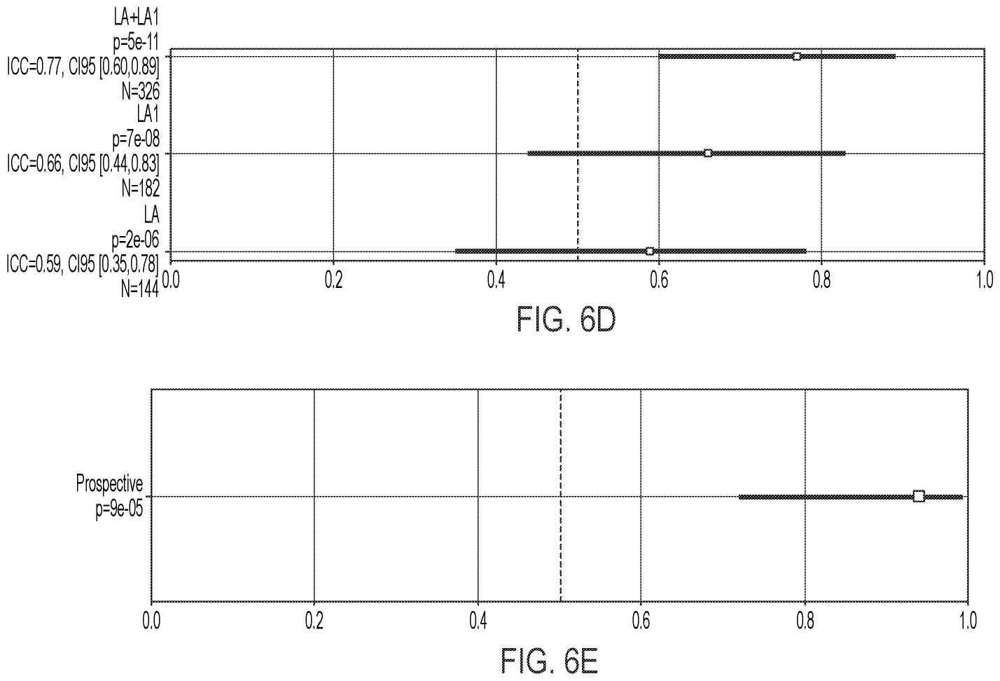

In some embodiments, the cohort identification module 180 uses the features identified by the feature identification module 172 to identify a cohort for the subject. In some embodiments, a cohort corresponds to a particular therapeutic response, with a particular overall survival, and/or a particular diagnosis. In some embodiments, identifying a cohort for a subject includes comparing a value of one or more TLS features to criteria associated with the cohort, and identifying the cohort for the subject when the criteria is satisfied. As a nonlimiting example, as shown in FIG. 6C, breast cancer patients having a TLS density of greater than 2 TLS/mm² have been shown to increased overall survival percentage over 120 months compared to breast cancer patients having a TLS density of less than 2%. The cohort identification module 180 may be configured to compare the determined TLS density to a threshold of 2 TLS/mm² and, upon determining that the TLS density exceeds the threshold, identify a cohort for the subject that is associated with increased overall survival percentage. Example techniques for identifying a cohort for the subject are described herein including at least in the “Applications” section.

In some embodiments, report generation module 178 is configured to generate a report based on the outputs of the TLS prediction module 170, the feature identification module 172, and/or the cohort identification module 180. For example, the report generation module 178 may generate a report that includes a pixel-level mask output by TLS prediction module, an indication of the boundaries of one or more TLSs in an image of tissue, an indication of one or more features, an indication of one or more cohorts identified for the subjects, and/or any other suitable information, as aspects of the technology are not limited in this respect.

As shown in FIG. 1B, system 150 also includes image data store 154 and neural network model data store 156. In some embodiments, software 112 obtains data from image data store 154, neural network data store 156, imaging platform 152, and/or user(s) 160 (e.g., by uploading data). In some embodiments, software 112 further includes neural network training module 174 for training one or more neural network models (e.g., stored in neural network data store 156).

In some embodiments, one or more images are obtained from image data store 154. The image data store 154 may be of any suitable type (e.g., database system, multi-file, flat file, etc.) and may store image data in any suitable way and in any suitable format, as aspects of the technology described herein are not limited in this respect. The image data store 154 may be part of or external to computing device 108.

In some embodiments, image data store 154 stores one or more images of tissue from a biological sample, as described herein including at least with respect to FIG. 1A. In some embodiments, the stored image data may have been previously uploaded by a user (e.g., user 160) and/or from one or more public data stores and/or studies. In some embodiments, one or more images stored in the image data store 154 may be processed by the TLS prediction module 170 to identify one or more TLSs in at least a portion of each of the one or more images. In some embodiments, one or more images stored in the image data store 154 may be used to train one or more neural network models (e.g., with the neural network training module).

In some embodiments, the TLS prediction module 170 obtains (either pulls or is provided) the trained neural network model from the neural network data store 156. The neural network models may be provided via a communication network (not shown), such as Internet or any other suitable network, as aspects of the technology described herein are not limited to any particular communication network.

In some embodiments, the neural network model data store 156 stores one or more neural network models used to identify at least one TLS in an image of tissue. In some embodiments, the neural network data store 156 includes any suitable data store, such as a flat file, a data store, a multi-file, or data storage of any suitable type, as aspects of the technology described herein are not limited to any particular type of data store. The neural network data store 156 may be part of software 112 (not shown) or excluded from software 112, as shown in FIG. 1B. In some embodiments, the neural network model data store 156 may store parameter values for a trained neural network model. When the stored trained NN model is loaded and used, for example by the TLS prediction module 170, the parameter values of the trained NN model are loaded and stored/manipulated in memory using at least one data structure.

In some embodiments, the neural network training module 174 may be configured to train the one or more neural network models to identify at least one TLS in an image of tissue. In some embodiments, the neural network training module 174 trains a neural network model using a training set of image data. For example, the neural network training module 174 may obtain training data from the image data store 154, imaging platform 152, and/or user(s) 160 (e.g., by uploading). In some embodiments, the neural network training module 174 may provide the trained neural network model(s) to the neural network data store 156 for storage therein. Techniques for training a neural network model are described herein including at least with respect to FIGS. 4A-4D.

As shown in FIG. 1B, in some embodiments, software 112 further includes a user interface module 176. User interface module 176 may be configured to generate a graphical user interface (GUI), a text-based user interface, and/or any other suitable type of interface through which a user may provide input and view information generated by software 112. For example, in some embodiments, the user interface module 176 may be a webpage or web application accessible through an Internet browser. In some embodiments, the user interface module 176 may generate a graphical user interface (GUI) of an app executing on the user's mobile device. In some embodiments, the user interface module 176 may generate a number of selectable elements through which a user may interact. For example, the user interface module 176 may generate dropdown lists, checkboxes, text fields, or any other suitable element.

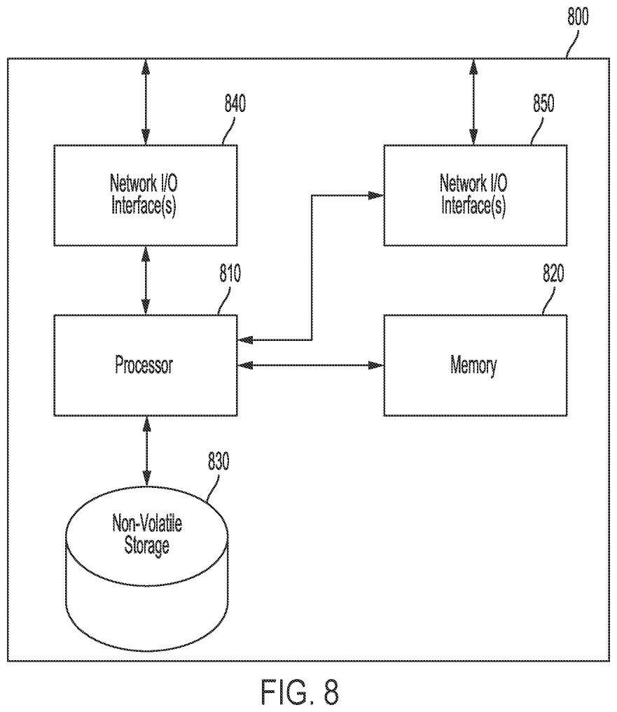

FIG. 2A is a flowchart of an illustrative process 200 for using a trained neural network model to identify at least one TLS in an image of tissue, according to some embodiments of the technology described herein. Process 200 may be performed by software (e.g., software 112) executing on a laptop computer, a desktop computer, one or more servers, in a cloud computing environment, computing device 108 as described herein with respect to FIGS. 1A-1B, computing device 800 as described herein with respect to FIG. 8, or any other suitable computing device.

At act 202, the software obtains a set of overlapping sub-images of an image of tissue. In some embodiments, the image of tissue includes an image obtained or previously-obtained using an imaging platform such as, for example, imaging platform 104 used to obtain image 106 in FIG. 1A. The image may be a single channel image or a multi-channel image (e.g., a 3-channel RGB image). For example, the image may include a whole slide image (WSI). The image may have any suitable dimensions, as aspects of the technology are not limited in this respect. For example, the image may have at least 100,000×100,000 pixel values per channel, 75,000×75,000 pixel values per channel, 50,000×50,000 pixel values per channel, 25,000×25,000 pixel values per channel, 10,000×10,000 pixel values per channel, 5,000×5,000 pixel values per channel or any other suitable number of pixels per channel. The dimensions of image may be within any suitable range such as, for example, 50,000-500,000×50,000-500,000 pixel values per channel, 25,000-1 million×25,000-1 million pixel values per channel, 5,000-2 million×5,000-2 million pixel values per channel, or any other suitable range within these ranges.

In some embodiments, each sub-image in the set of overlapping sub-images may be obtained, from the image of tissue, in any suitable manner, as aspects of the technology described herein are not limited in this respect. For example, a sub-image may be cropped out of the image of tissue. The dimensions of the sub-image may depend on the dimensions of the image from which the sub-image is obtained. For example, dimensions of the sub-image may be smaller than the corresponding dimensions of the image from which the sub-image is obtained. For example, the sub-image may have at least 128×128 pixels per channel, 256×256 pixels per channel, 512 pixels×512 pixels per channel, 1024×1024 pixels per channel, 2048×2048 pixels per channel, 40964×4096 pixels per channel, 8192×8192 pixels per channel or any other suitable number of pixels per channel. The dimensions of the sub-image image may be within any suitable range such as, for example, 10-100,000×10-100,000 pixel values per channel, 100-50,000×100-50,000 pixel values per channel, 1,000-10,000×1,000-10,000 pixel values per channel, or any other suitable range within these ranges.

In some embodiments, sub-images in the set of sub-images overlap one another. For example, a pair of sub-images that overlap one another may each include the same subset of pixels corresponding to the image from which the sub-images were obtained. The sub-images may overlap one another in any suitable direction, as aspects of the technology are not limited in this respect. For example, sub-images in the set of overlapping sub-images may overlap one another along a horizontal and/or along a vertical axis. In some embodiments, sub-images in the set of overlapping sub-images overlap one another by any suitable degree of overlap, as aspects of the technology are not limited in this respect. For example, in a particular direction, the sub-images may overlap one another by at least 90%, at least 80%, at least 75%, at least 60%, at least 50%, at least 40%, at least 35%, at least 25%, at least 20%, at least 10%, between 10% and 90%, or between 40% and 60%. For example, sub-images having dimensions of 512 pixels per channel×512 pixels per channel may overlap one another by 256 pixels in both the horizontal and vertical direction.

In some embodiments, the set of overlapping sub-images includes any suitable number of sub-images, as aspects of the technology are not limited in this respect. For example, the set of overlapping sub-images may include at least 10, at least 50, at least 75, at least 100, at least 150, at least 250, at least 300, at least 500, at least 750, at least 1000, at least 2,500, at least 5,000, at least 7,500, at least 10,000, at least 25,000, between 10 and 25,000, between 100 and 10,000 sub-images, or any other suitable number of sub-images. In some embodiments, each sub-image in the set of overlapping sub-images overlaps at least one another sub-image in the set of overlapping sub-images.

In some embodiments, the set of overlapping sub-images cover at least a portion of the image of tissue. For example, when the image of tissue is a WSI, the set of overlapping sub-images may cover at least a portion of the WSI. The portion of the image covered by the set of overlapping sub-images may include any suitable portion such as, for example, at least 5% of the image, at least 10%, at least 25%, at least 50%, at least 60%, at least 75%, at least 80%, at least 90%, at least 95%, at least 98%, 100%, between 5% and 100%, between 25% and 80%, or any other suitable portion, as aspects of the technology are not limited in this respect.

At (optional) act 204, the software performing process 200 may pre-process sub-images in the set of overlapping sub-images using any suitable pre-processing technique(s). In some embodiments, pre-processing a sub-image includes normalizing the values of pixels in the sub-image. In some embodiments, the normalization is performed elementwise for each channel of the sub-image. In some embodiments, normalizing the values of pixels in a sub-image includes dividing the pixel values by the maximum pixel value in the sub-image such that all pixel values fall within a particular interval (e.g., 0 to 1). For example, for a pixel value that is an unsigned 8-byte integer type (e.g., having a value between 0 to 255), the pixel value may be normalized by dividing the pixel value by 255. Additionally, or alternatively, in some embodiments, normalizing the values of pixels in the sub-image includes performing a Z-score normalization. For example, this may include determining a pre-processed pixel value (P) for each pixel of each channel of the sub-image using Equation 1:

$$P = \frac{\frac{{P}_{input}}{{P}_{max}} - {μ}_{c}}{{σ}_{c}} \qquad ( Equation 1 )$$

Where Pᵢₙₚᵤₜ is the input pixel value, Pₘₐₓ is the maximum pixel value (e.g., 255 for an unsigned 8-byte integer type), μ_{c} is the mean pixel value of a set of reference images for a particular channel, and σ_{c} is the standard deviation of the pixel values of the set of reference images for a particular channel. For example, the mean and standard deviation may include a mean and standard deviation of pixel values in the ImageNet dataset described by Deng, J., et. al. (“ImageNet: A large-scale hierarchical image database.” In 2009 IEEE conference on computer vision and pattern recognition (pp. 248-255)), which is incorporated by reference herein in its entirety. Table 1 lists an example mean and standard deviation per channel for an RGB image:

TABLE 1
Example mean and standard deviation.

| Channel | μ_{c} | σ_{c} |
|---|---|---|
| Red | 0.485 | 0.229 |
| Green | 0.456 | 0.224 |
| Blue | 0.406 | 0.225 |

At act 206, the software performing process 200 may process the set of overlapping images using a trained neural network model to obtain a respective set of pixel-level sub-image masks. For example, this may include processing a first sub-image using the trained neural network model to obtain a respective first pixel-level sub-image mask, processing a second sub-image using the same trained neural network model to obtain a respective second pixel-level sub-image mask, processing a third sub-image using the same trained neural network model to obtain a third respective pixel-level sub-image mask, and so on. In some embodiments, processing the set of overlapping images includes processing some or all of the sub-images in the set of overlapping sub-images using the trained neural network model. In some embodiments, the trained neural network may be any suitable semantic segmentation deep neural network. A semantic segmentation deep neural network may be any neural network that identifies labels for individual pixels (e.g., some or all pixels in an image). In some embodiments, the neural network may have any of the example architectures described herein including at least with respect to the “Neural Network Model” section. In some embodiments, the neural network is trained using and of the neural network training techniques described herein including at least with respect to FIGS. 4A-4D.

In some embodiments, a pixel-level sub-mask indicates, for each of multiple pixels in the pixel-level sub-mask, a respective probability that the particular pixel is part of a TLS. For example, a first pixel-level sub-mask for a first sub-image may indicate a probability that a first pixel in a first sub-image is part of a TLS.

As described herein, in some embodiments, sub-images in the set of overlapping sub-images overlap one another. Sub-images that overlap one another may share pixels that are in an overlapping region of the sub-images. Accordingly, in some embodiments, the pixel-level sub-masks obtained for overlapping sub-images may each, for the same pixel, indicate a probability that the pixel is part of a TLS. Because different sub-images include different information (e.g., values of pixels that are not included in the overlapping region) that is processed using the trained neural network model, the multiple probabilities predicted for the pixel using the neural network model may differ from one another. Accordingly, in some embodiments, process 200 includes techniques for accounting for the multiple different predicted probabilities. For example, in some embodiments, act 208 of process 200 may be implemented to account for the multiple predictions.

At act 208, the software performing process 200 determines a pixel-level mask for at least a portion of the image of the tissue covered by at least some of the sub-images in the set of overlapping sub-images. In some embodiments, this includes, at act 208-1, using at least some of the set of pixel-level sub-masks corresponding to the at least some of the set of overlapping sub-images covering at least the portion of the image. For example, the pixel-level sub-masks may be used to determine for each of multiple pixels in a region of overlap between two or more overlapping sub-images, an average probability that the pixel is part of TLS. In some embodiments, determining the average includes determining a weighted average. For example, weighting may be performed such that values in the pixel-level sub-mask that are positioned closer to the center of the sub-mask are made to contribute more to the average than the values in the pixel-level sub-mask that are positioned closer to the borders of the sub-mask. This helps to reduce artifacts/errors at image edges and leads to overall improved performance in accurately identifying TLS structures. An example implementation of act 208 for determining the pixel-level mask for determining at least the portion of the image is described herein including at least with respect to process 250 of FIG. 2B.

At act 210, the software performing process 200 identifies boundaries of at least one TLS in the portion of the image using the pixel-level mask. In some embodiments, to assist in identifying the boundaries, the pixel-level mask is first processed to generate a binary version of the pixel-level mask. Generating the binary version of the pixel-level mask may include comparing each of at least some of the values of the pixel-level mask to a threshold value (e.g., a threshold value that is determined in advance of performance of process 200 or dynamically determined as part of process 200) and setting each pixel value to 0 or 1 depending on the result of the comparison. For example, when the value of the pixel-level mask exceeds the threshold value, then the value may be set to 1 and when the value of the pixel-level mask does not exceed the threshold value, then the value may be adjusted to 0, or vice versa. The threshold value may be any suitable threshold value such as aspects of the technology described herein are not limited in this respect. For example, the threshold may be at least 25%, 40%, 50%, 60%, or 75% of the maximum value in the pixel-level mask. For example, when the pixel-level mask includes values between 0 and 1, the threshold may be at least 0.25, at least 0.40, at least 0.50, at least 0.60, at least 0.75, or any other suitable threshold value.

In some embodiments, the binary version of the pixel-level sub-mask is used to identify the boundaries of the at least one TLS. In some embodiments, identifying the boundaries includes using a border-following algorithm. As a nonlimiting example, the processor may identify borders using the border-following algorithm described by S. Suzuki, et. al. (“Topological structural analysis of digitized binary images by border following”. Computer Vision, Graphics, and Image Processing, 30(1):32-46, 1985), which is incorporated by reference herein in its entirety. In some embodiments, one or more parameters of the border-following algorithm may be set to identify the boundaries of the at least one TLS. For example, the parameters may include a parameter to select a contour approximation method (e.g., method=CHAIN_APPROX_SIMPLE). As another example, the parameters may include a parameter for identifying outer contours from among nested contours (e.g., hierarchy=RETR_EXTERNAL).

In some embodiments, the identified boundaries form one or more regions. A region may include an area of the image that is enclosed by boundaries. In some embodiments, after obtaining the boundaries, the processor optionally filters out regions that have an area that does not meet particular criteria. For example, the processor may compare the area of a region to a threshold area and exclude the region from further analysis if the area does not exceed the threshold area, or vice versa. Example techniques for determining the area of a region are described herein including at least with respect to act 212 of process 200.

At act 212, the software performing process 200 identifies one or more features of the at least one TLS using the identified boundaries and the portion of the image. The features may include any suitable feature that may be obtained using one or more of the boundaries identified at act 210. As a nonlimiting example, the features may include the number of TLSs in at least a portion of the image. This may be determined by counting the number of bounded regions (e.g., regions enclosed by the identified boundaries) in the portion of the image.

Additionally, or alternatively, the features may include the number of TLSs in at least a portion of an image normalized by the area of the portion of the image (which may be termed “TLS density”). In some embodiments, this feature may be determined by dividing the number of TLSs in the portion of the image by the total area of that portion of the image. The area of the portion of the image may include both the area(s) of the portion of the image that include TLSs (e.g., bounded regions) and the area(s) of the portion of the image that do not include TLSs (e.g., non-bounded regions). In some embodiments, the area Aᵢ of a portion i of an image may be determined using Equation 2:

$${A}_{i} = Pixel Size * Pixel Area \qquad ( Equation 2 )$$

$$where :$$

$$\begin{matrix}Pixel Size = Pixel Height * Pixel Width & ( Equation 3 ) \\ Pixel Area = {i}_{height} * {i}_{width} & ( Equation 4 )\end{matrix}$$

where i_{height} is the height of the portion i of the image as measured in number of pixels and i_{width} is the width of the portion i of the image as measured in number of pixels. In some embodiments, pixel height and pixel width may be measured in millimeter per pixel. Pixel height and pixel width may be obtained from annotation information associated with the image. For example, when the image is a WSI, the pixel height and width may be obtained from the WSI file. In some embodiments, if the pixel height and width information is not available, then default values for pixel height and pixel width may be used. For example, the default value for pixel height and width may include a value of at least 0.4 μm per pixel, 0.5 μm per pixel, 0.6 μm per pixel, 0.7 μm per pixel, 0.8 μm per pixel, between 0.1 μm per pixel and 2 μm per pixel, between 0.2 μm per pixel and 1 μm per pixel, or any other suitable value.

Additionally, or alternatively, the features identified at act 212 may include the total area of TLSs in at least a portion of the image. In some embodiments, determining the total area of TLSs includes determining the area of each region of the portion of the image that is enclosed by the boundaries identified at act 210. In some embodiments, the area of a bounded region may be determined using any suitable technique(s), as aspects of the technology described herein are not limited in this respect. For example, the area of a bounded region may be determined by the shoelace algorithm described in Braden, B. (“The Surveyor's Area Formula.” In The College Mathematics Journal, (1996), Volume 17, Number 4, pp. 326-337). As another example, the Shapely Python package (Gillies, S., et. al. “Shapely: manipulation and analysis of geometric objects.” 2007. Available from: https://github.com/Toblerity/Shapely.) may be used to determine the area of the bounded region. In particular, the area method of “shapely. geometry.Polygon” class and/or the area method of “shapely.geometry.MultiPolygon” class may be used to determine the area of the bounded region.

Additionally, or alternatively, the features identified at act 212 may include the total area of TLSs in at least a portion of the image normalized by the area of the portion of the image. This may be determined, in some embodiments, by dividing the total area of TLSs by the area of the portion of the image. Techniques for determining the total area of the TLSs and for determining the area of a portion of an image are described herein.

Additionally, or alternatively, the features identified at act 212 may include the median area of TLSs in at least a portion of the image. In some embodiments, the median TLS area is determined by determining the area of each bounded region (e.g., enclosed by the boundaries identified at act 212) in the portion of the image. For example, the area of each bounded region may be determined using the techniques described above for determining the area of a bounded region. In some embodiments, the median of the determined areas is identified as the median TLS area in the portion of the image.

Additionally, or alternatively, the features identified at act 212 may include the median area of TLSs in at least a portion of the image normalized by the area of the portion of the image. The area of the portion of the image may include both the areas of the portion of the image that include TLSs (e.g., bounded regions) and the areas of the portion of the image that do not include TLSs (e.g., non-bounded regions). In some embodiments, the median area of TLSs and the area of the portion of the image are determined using the techniques described herein.

As described herein, one or more of TLS features may be used as prognostic or predictive biomarkers for diagnosing the subject, predicting overall survival for the subject, and/or predicting how the subject will respond to a particular therapy. At (optional) act 214, the software performing process 200 identifies a treatment for the subject based on at least one of the features identified at act 212. In some embodiments, this may include determining whether the feature satisfies at least one criterion and identifying a treatment for the subject based on an evaluation of whether the features satisfy the at least one criterion. For example, this may include determining whether the at least one feature exceeds a particular threshold and identifying a treatment for the subject based on the result of comparing the at least one feature to the threshold.

As a nonlimiting example, the number of TLSs in at least a portion of an image normalized by the area of the portion of the image (“TLS density”) may be used to determine whether to recommend administering an immunotherapy to the subject. The TLS density may be compared to a threshold density, and when the TLS density exceeds the threshold density, then an immunotherapy may be recommended for administering to the subject. The immunotherapy may include any suitable immunotherapy including, for example, at least one of the immunotherapies described in the “Methods of Treatment” section. In some embodiments, the threshold density includes any suitable threshold such as, for example, at least 0.25 TLS/mm², at least 0.5 TLS/mm², at least 0.75 TLS/mm², at least 0.8 TLS/mm², at least 0.9 TLS/mm², at least 0.95 TLS/mm², at least 1.0 TLS/mm², at least 1.25 TLS/mm², at least 1.5 TLS/mm², at least 1.75 TLS/mm², at least 1.8 TLS/mm², at least 1.9 TLS/mm², at least 2.0 TLS/mm², at least 2.1 TLS/mm², at least 2.25 TLS/mm², at least 2.5 TLS/mm², at least 2.75 TLS/mm², at least 3.0 TLS/mm², within the range of 0-15 TLS/mm², 0-10 TLS/mm², 1-5 TLS/mm², or any other suitable threshold, as aspects of the technology are not limited in this respect. Consider, for example, a subject with basal-like breast cancer. In some embodiments, the techniques described herein may be used to determine a TLS density for the subject. If the TLS density exceeds a threshold density such as, for example, a threshold TLS density of 2 TLS/mm², then an immunotherapy may be identified for the subject. Consider, as another example, a subject with lung adenocarcinoma. In some embodiments, the techniques described herein may be used to determine the TLS density for the subject. If the TLS density exceeds a threshold density such as, for example, a threshold TLS density of 1.22 TLS/mm², then an immunotherapy may be identified for the subject.

In some embodiments, the software performing process 200 generates an output. In some embodiments, the output may be stored (e.g., in a non-transitory memory), displayed via a user interface, transmitted to one or more other devices, or otherwise processed using any suitable techniques, as aspects of the technology are not limited in this respect. For example, the output may be displayed using a graphical user interface (GUI) of a computing device. As another example, the output may be included as part of an electronically-generated report. In some embodiments, the output may include any suitable output such as, for example, at least a portion of the image of tissue, the determined pixel-level mask, one or more of the pixel-level sub-masks, any identified TLS boundaries, any identified TLS features, and/or any treatment(s) recommended for the subject.

At (optional) act 216, the treatment identified at act 214 is administered to the subject. Techniques for administering the treatment are described herein including at least in the “Methods of Treatment” section.

In some embodiments, implementing process 200 may include additional or alternative acts that are not shown in FIG. 2A, as aspects of the technology described herein are not limited to those acts shown in FIG. 2A. For example, process 200 may include an act for outputting one or more outputs. Additionally, or alternatively, process 200 may include a subset of the acts shown in FIG. 2A. For example, process 200 may include all of the acts 202-216 or only some of the acts including acts 202-214; 202-212; 202 and 206-212; 202 and 206-216; 202 and 206-214.

FIG. 2B is a flowchart of an illustrative process 250 for determining a weighted combination of pixel-level sub-image masks, according to some embodiments of the technology described herein. Process 250 is an example implementation of act 206-1 of process 200 in FIG. 2A.

At act 252, the processor determines weighting matrices for at least some of the set of pixel-level sub-masks. In some embodiments, a weighting matrix may be used to weight different values in a pixel-level sub-mask based on their position within the pixel-level sub-mask. For example, a weighting matrix may be used to apply a greater weight to values that are closer to the center of a pixel-level sub-mask and to apply a lesser weight to values that are closer to the borders of a pixel-level sub-mask. In some embodiments, a weighting matrix (Wyx) may be determined according to Equation 5:

$${WM}_{yx} = ∝ * \frac{{DE}_{yx}}{{DC}_{yx} + {DE}_{yx}} \qquad ( Equation 5 )$$

$$where :$$

$$\begin{matrix}∝ = H * W * {( {Σ}_{yx} \frac{{DE}_{yx}}{{DC}_{yx} + {DE}_{yx}} )}^{- 1} , & ( Equation 6 ) \\ {DE}_{yx} = \sqrt{\begin{matrix}min \{ {( {W}_{yx} + 0.5 )}^{2} , {( {W}_{yx} - W + 0.5 )}^{2} , \\ {( {H}_{yx} + 0.5 )}^{2} , {( {H}_{yx} - H + 0.5 )}^{2}\end{matrix}} , & ( Equation 7 ) \\ {DC}_{yx} = \sqrt{{( {W}_{yx} - {x}_{centroid} + 0.5 )}^{2} + {( {H}_{yx} - {y}_{centroid} + 0.5 )}^{2}} , & ( Equation 8 ) \\ {W}_{yx} = [ \begin{matrix}0 & 1 & ⋯ & W - 1 \\ 0 & 1 & ⋯ & W - 1 \\ ⋯ & ⋯ & ⋯ & ⋯ \\ 0 & 1 & ⋯ & W - 1\end{matrix} ] , & ( Equation 9 ) \\ {H}_{yx} = [ \begin{matrix}0 & 1 & ⋯ & H - 1 \\ 0 & 1 & ⋯ & H - 1 \\ ⋯ & ⋯ & ⋯ & ⋯ \\ 0 & 1 & ⋯ & H - 1\end{matrix} ] , & ( Equation 10 ) \\ {X}_{centroid} = \frac{W}{2} , & ( Equation 11 ) \\ {Y}_{centroid} = \frac{H}{2} , & ( Equation 12 )\end{matrix}$$

and where H and W are the height and width of the sub-mask, respectively.

At act 254, the processor determines the pixel-level mask as a weighted combination of the pixel-level sub-image masks weighted, element-wise, by the respective weighting matrices. For example, the weighted combination of a set {t} of sub-masks may be determined using Equation 13:

$${o}_{yx} = \frac{{Σ}_{\{ t \}} {T}_{ij}^{t} * {W}_{ij}^{t}}{{Σ}_{\{ t \}} {W}_{ij}^{t}} \qquad ( Equation 13 )$$

where Tᵢⱼ^{t} is a predicted probability included in a sub-mask, t, for a pixel at a position, (i, j) in the sub-mask, and Wt is the corresponding weight applied to Tᵢⱼ^{t}.

FIGS. 2C-1, 2C-2, 2C-3, 2D-1, 2D-2, 2D-3, and 2E show an example of using a trained neural network model to identify at least one TLS in an image of tissue, according to some embodiments of the technology described herein.

FIG. 2C-1 shows an example image 260 of tissue obtained from a subject. In some embodiments, image 260 is obtained using any suitable techniques such as, for example, the techniques described herein including at least with respect to FIGS. 1 and 2A.

FIG. 2C-2 shows an example of obtaining sub-images from the image 260. In the example, the dimensions of a first sub-image are indicated by the bracket 261 and bracket 263. The dimensions of a second sub-image are indicated by the bracket 262 and bracket 263. The dimensions of a third sub-image are indicated by the bracket 264 and bracket 261.

In some embodiments, the sub-images are obtained using the techniques described herein, including at least with respect to act 202 of FIG. 2A. For example, the sub-images may be obtained by obtaining crops from the image 260. While the example shows that sub-images are obtained for the entire image 260, it should be appreciated that sub-images may be obtained for only a portion of the image 260.

In the example shown in FIG. 2C-2, each of the sub-images overlaps at least one other sub-image. For example, the first sub-image overlaps the second sub-image in the horizontal direction, as indicated by the overlapping brackets 261 and 262. The first sub-image also overlaps the third sub-image in the vertical direction, as indicated by the brackets 263 and 264. The second sub-image also overlaps the third sub-image (e.g., the lower left quadrant of the second sub-image is the same as the top right quadrant of the third sub-image).

FIG. 2C-3 is an example showing an indication of the degree of overlap between the sub-images. As indicated by legend 266, different portions of the image are covered by a different number of sub-images. Accordingly, as described herein, including at least with respect to FIG. 2A, a different number of sub-masks may be generated for the different portions of the image. For example, a single sub-mask may be generated for portions of the image that are covered by a single sub-image, two sub-masks may be generated for portions of the image that are covered by two sub-images, and four sub-masks may be generated for portions of the image that are covered by four sub-masks.

FIG. 2D-1 shows example sub-images obtained from the image 260 in FIG. 2C-1. Sub-image 272 corresponds to the sub-image indicated by brackets 261 and 263 in FIG. 2C-2. Sub-image 274 corresponds to the sub-image indicated by brackets 262 and 263 in FIG. 2C-2. Because sub-images 272 and 274 correspond to overlapping regions of image 260, sub-images 272 and 274 each share at least some of the same pixels.

FIG. 2D-2 shows example sub-masks obtained for the sub-images shown in FIG. 2D-1. For example, the sub-masks shown in FIG. 2D-2 may be obtained using the machine learning techniques described herein including at least with respect to act 206 of process 200 shown in FIG. 2A.

Because, in this example, the sub-images correspond to overlapping regions of image 260 in FIG. 2C-1, the determined sub-masks may include multiple sub-masks for a same region of pixels. For example, the sub-masks 276 and 278 generated for sub-images 272 and 274 each include a sub-mask for the shared region of pixels of the sub-images 272 and 274.

Accordingly, in some embodiments, the example sub-masks shown in FIG. 2D-2 may be used to determine the single pixel-level mask for the image 260. For example, the mask may be determined using the techniques described herein including at least with respect to act 208 of FIG. 2A and process 250 of FIG. 2B.

FIG. 2E shows an example of processing the determined mask to identify one or more features for at least one TLS in the image 260. Mask 282 is an example of a binarized version of mask 280 in FIG. 2D-3. For example, as described herein, binarizing the mask may include comparing the probability determined to a particular pixel to a threshold probability and binarizing the mask based on the result of the comparison.

As shown in the example, the mask may be used to identify boundaries 284 of at least one TLS, and the identified boundaries may be used to determine one or more features. Examples of identifying boundaries are described herein including at least with respect to act 210 of process 200. Examples of determining features are described herein including at least with respect to act 212 of process 200. The features determined for the example of FIG. 2E include quantity of TLS per whole slide image (WSI), quantity of TLS per WSI area, total area of TLS per WSI, total area of TLS per WSI area, median area of TLS per WSI, and median area of TLS per WSI area.

### Neural Network Model

In some embodiments, a neural network used to identify at least one TLS in an image of tissue may be any suitable semantic segmentation deep neural network. A semantic segmentation deep neural network may be any neural network that identifies labels for individual pixels (e.g., some or all pixels in an image). For example, a neural network used to identify at least one TLS in an image of tissue may have (or be based on) the DeepLabv3+ architecture (or its other versions) described by Chen, L. et al. “DeepLab: Semantic Image Segmentation with Convolutional Nets, Atrous Convolution, and Fully Connected CRFs.” IEEE Transactions on Pattern Analysis and Machine Intelligence, vol. 40, no. 4, pp. 834-848 (2017) and Chen, L., et. al. (“Encoder-decoder with atrous separable convolution for semantic image segmentation.” In Proceedings of the European conference on computer vision (ECCV). 2018. pp. 801-818.), each of which is incorporated by reference herein in its entirety.

As another example, the neural network used to identify at least one TLS in an image of tissue may be a convolutional neural network having one or more fully connected layers, a U-Net convolutional neural network having (or being based on) the architecture described by Olaf Ronneberger, Philipp Fischer, Thomas Brox in “U-Net: Convolutional Networks for Biomedical Image Segmentation”, Medical Image Computing and Computer-Assisted Intervention (MICCAI), Springer, LNCS, Vol. 9351: 234-241, 2015, which is incorporated by reference here in its entirety, ResNet, MobileNet, Xception or any other suitable deep learning architecture. Aspects of ResNet are described in He, K. et al. “Deep Residual Learning for Image Recognition.” CVPR (2016), which is incorporated by reference herein its entirety.

Another example of a semantic segmentation neural network that may be used to identify at least one TLS in an image of tissue is described next with respect to FIGS. 3A-3J.

FIG. 3A illustrates an example architecture of a neural network model 300 which may be used to identify at least one TLS in an image of tissue, according to some embodiments of the technology described herein. As shown in FIG. 3A, the neural network model 300 includes an encoder sub-model 310, a decoder sub-model 320, and an auxiliary classifier sub-model 330.

The neural network 300 may receive an input image 301 and process the input image using the neural network layers describes in FIGS. 3A-3J and their parameter values to obtain an output pixel-level mask indicating a probability for each of one or more (e.g., some or all) pixels in input image 301, a respective probability that the particular pixel is part of a tertiary lymphoid structure. In some embodiments, the neural network 300 may include at least 1 million parameters, at least 5 million parameters, at least 10 million parameters, at least 15 million parameters, at least 20 million parameters, at least 25 million parameters, at least 30 million parameters, at least 50 million parameters, at least 75 million parameters, at least 100 million parameters, at least 150 million parameters, between 5 and 100 million parameters, between 25 and 75 million parameters, between 30 and 50 million parameters or any other range within these ranges. Accordingly, the pixel values of the input image are processed using the millions of parameter values of the neural network 300 to generate the pixel-level mask from the input image.

As shown in FIG. 3A, the encoder sub-model 310 is configured to receive an input image 301. The input image 301 may be a sub-image of a whole slide image (WSI) of tissue or an entire WSI image. The input image 301 may be a single channel image or a multi-channel image (e.g., a 3-channel RGB image). When the image 301 is a sub-image of a WSI image, that sub-image may be obtained in any suitable from the WSI as described herein. For example, the multiple at least partially overlapping sub-images may be cropped out of the WSI and the sub-image may be one of such multiple at least partially overlapping sub-images.

The input image 301 may have any suitable dimensions, as aspects of the technology are not limited in this respect. For example, the input image 301 may have 128×128 pixels per channel, 256×256 pixels per channel, 512 pixels×512 pixels per channel, 1024×1024 pixels per channel, 2048×2048 pixels per channel, 40964×4096 pixels per channel, 8192×8192 pixels per channel or any other suitable number of pixels per channel.

In some embodiments, prior to being provided as input to the encoder, the input image 301 is processed according to any suitable processing techniques such as, for example, the image processing techniques described herein including at least with respect to FIG. 2A.

In some embodiments, the encoder sub-model 310 includes: an adapter neural network portion 302 configured to receive input image 301, a bottleneck neural network portion 303, resolution-separation neural network portions 304, 306, 308, and resolution-fusion neural network portions 305, 307, 309. The encoder sub-model 310 may be configured to gradually add high-to-low resolution convolution streams and to connect multi-resolution streams in parallel. In some embodiments, the encoder sub-model 310 may be implemented using the architecture described herein with reference to FIGS. 3B-3F. In some embodiments, the encoder sub-model 310 may be implemented using the encoder architecture of Higher High-Resolution Network (HigherHRNet) described by Cheng, B., et. al. (“HigherHRNet: Scale-Aware Representation Learning for Bottom-Up Human Pose Estimation.” In Proceedings of the IEEE/CVF conference on computer vision and pattern recognition (pp. 5386-5395)), which is incorporated by reference herein in its entirety.

As shown in FIG. 3A, the input to the decoder sub-model 320 is coupled to the output of the encoder sub-model 310. The decoder sub-model 320 includes an atrous spatial pyramid pooling (ASPP) neural network portion 321, the input of which is coupled to the output of resolution-fusion neural network portion 309. In the embodiment of FIG. 3A, the decoder sub-model 320 also includes a projection neural network portion 323, the input of which is coupled to the output of bottleneck neural network portion 303. The decoder sub-model 320 also includes upsampling layer 322 and classification neural network portion 324.

In some embodiments, the output of the ASPP neural network portion 321 is coupled to the input of upsampling layer 322. For example, the output of the ASPP neural network portion 321 may include a feature map of a particular resolution. In some embodiments, the upsampling layer 322 is configured to upscale the feature map. For example, the upsampling layer 322 may use bilinear interpolation to upscale the feature map. The upsampling layer 322 may be configured to upscale the feature map to achieve the resolution to match that of the feature map output by projection neural network portion 323.

In some embodiments, the decoder sub-model 320 is configured to concatenate the output of the upsampling layer 322 and the output of the projection neural network portion 323. For example, the upsampling layer 322 and the projection neural network portion 323 may each output a feature map, and the decoder sub-model 320 may be configured to concatenate said feature maps. In some embodiments, the concatenated outputs of the upsampling layer 322 and the projection neural network portion 323 are coupled with the input of the classification neural network portion 324.

In some embodiments, the classification network portion 324 is configured to output pixel-level mask 325. As described herein, in some embodiments, the pixel-level mask 325 indicates, for each of multiple pixels of the input image 301, (e.g., an estimate of) the probability that the pixel is part of a TLS. In some embodiments, prior to being provided as output, the pixel-level mask 325 may be upscaled to match the resolution of input image 301. For example, the pixel-level mask 325 may be upscaled using bilinear interpolation or any other suitable interpolation technique, as aspects of the technology described herein are not limited in this respect.

The auxiliary classifier sub-model 330 is configured to receive, as input, the output of resolution-fusion neural network portion 307 and to output label 331. As described herein, the auxiliary classifier sub-model 330 may be used for training the neural network model 300. For example, label 331 may indicate (e.g., an estimate of) the probability that a particular input image 301 includes a TLS, which may be used in determining loss for evaluating the performance of the neural network model during training and/or validation.

FIG. 3B illustrates an example architecture of the adapter neural network portion 302 of FIG. 3A, according to some embodiments of the technology described herein. The adapter neural network portion 302 includes: 2D convolutional layers 302-1, 302-3, batch normalization layers 302-2, 302-4, and activation layer 302-5. In some embodiments, the 2D convolutional layers 302-1, 302-3 may be configured to directly downscale the input to the particular 2D convolutional layer by using a strided convolution. Additionally, or alternatively, the 2D convolutional layers may be exploited as part of downscaling (e.g., by using one or more pooling layers, such as maximum or averaging pooling layers). The activation layer 302-5 may use any suitable activation function (e.g., ReLU, leaky ReLU, sigmoid, hyperbolic, softmax, etc.), as aspects of the technology are not limited in this respect.

Table 2, included below, illustrates an example configuration for the respective layers in an example implementation of adapter neural network portion 302.

TABLE 2
Example configuration of Adapter NN Portion
302 specified using PyTorch notation

| | |
|---|---|
| 0 | Conv2d(3, 64, kernel_size=(3, 3), stride=(2, 2), padding=(1, 1), |
| | bias=False) |
| 1 | BatchNorm2d(64, eps=1e−05, momentum=0.1, affine=True, |
| | track_running_stats=True) |
| 2 | Conv2d(64, 64, kernel_size=(3, 3), stride=(2, 2), padding=(1, 1), |
| | bias=False) |
| 3 | BatchNorm2d(64, eps=1e−05, momentum=0.1, affine=True, |
| | track_running_stats=True) |
| 4 | ReLU(inplace=True) |

FIG. 3C illustrates an example architecture of a portion 350 of the encoder 310 of FIG. 3A. The portion 350 includes bottleneck neural network portion 303, resolution-separation neural network portions 304, 306, 308, and resolution-fusion neural network portions 305, 307, 309. In some embodiments, the architecture of the portion 350 of the encoder 310 is configured to maintain high-resolution representations (e.g., feature maps) of an input image throughout the processing of the input image with the neural network model 300. This stands in contrast to other deep learning approaches to semantic segmentation such as, for example, in a U-Net convolutional architecture, whereby higher-resolution representations are gradually replaced by lower-resolution representations. In the architecture of FIG. 3C, higher-resolution feature maps are maintained and supplemented with lower-resolution feature maps (the higher-resolution feature maps are not replaced with lower-resolution feature maps).

In some embodiments, the bottleneck neural network portion 303 is included to obtain more relevant features by passing information through a bottleneck (layers having a wide-to narrow-to wide configuration). An example architecture of the bottleneck neural network portion 303 is described herein including at least with respect to FIG. 3D.

Following the bottleneck neural network portion 303, are alternating resolution-separation neural network portions and resolution-fusion neural network portions. In some embodiments, the alternating resolution-separation and -fusion neural network portions are configured to split an input feature map into different resolutions, perform a convolution over the different feature maps in parallel, then fuse information across the multi-resolution feature maps.

For example, as shown in FIG. 3C, the resolution-separation neural network portion 304 may be configured to generate 1× resolution feature map 333 and ½× resolution feature map 334 from 1× resolution feature map 332. To generate the ½× resolution feature map, the resolution-separation neural network portion 304 may be configured to downscale the 1× resolution feature map 332 using a strided convolution. To generate the 1× resolution feature map, the resolution-separation neural network portion 304 may be configured to perform a convolution without downscaling. An example architecture of a resolution-separation neural network portion 304 is described herein including at least with respect to FIG. 3E.

In some embodiments, the 1× resolution feature map 333 and ½× resolution feature map 334 are coupled as input to resolution-fusion neural network portion 305. The resolution-fusion neural network portion 305 may be configured to perform a convolution over the 1× resolution feature map 333 and ½× resolution feature map 334 in parallel, then fuse information across the two different resolution feature maps. For example, as described herein, including at least with respect to FIG. 3F, the resolution-fusion neural network portion 305 may include one or more layers configured to fuse information across the 1× and ½× resolution feature maps. The output of resolution-fusion neural network portion includes 1× resolution feature map 335 and ½× resolution feature map 336. In some embodiments, the resolution-fusion neural network portion 305 may be used more than one time (e.g., twice, thrice, four times, etc.) during processing of input image 301.

In some embodiments, the ½× resolution feature map 336 is coupled as input to the resolution-separation neural network portion 306. The resolution-separation neural network portion 306 may be configured to generate ¼× resolution feature map 337. For example, to generate the ¼× resolution feature map, the resolution-separation neural network portion 306 may be configured to downscale the ½× resolution feature map 336 using a strided convolution.

In some embodiments, the 1× resolution feature map 335, the ½× resolution feature map 336, and the ¼× resolution feature map 337 are each coupled as input to resolution-fusion neural network portion 307. The resolution-fusion neural network portion 307 may be configured to perform a convolution over the feature maps 335, 336, 337 in parallel, then fuse information across the three different resolution feature maps.

In some embodiments the resolution-fusion neural network portion 307 is used more than one time during processing of input image 301. For example, the resolution-fusion neural network portion 307 may be configured to process 1× resolution feature map 335, ½× resolution feature map 336, and ¼× resolution feature map 337 to generate intermediate output feature maps, which may be coupled as input to resolution-fusion neural network portion 307. In one example, the resolution-fusion neural network portion 307 may be used four times during processing of the input image 301. However, it should be appreciated that the fusion neural network portion 307 may be used any suitable number of times during processing. In some embodiments, the final output of the resolution-fusion neural network portion 307 includes 1× resolution feature map 338, ½× resolution feature map 339, and ¼× resolution feature map 340.

In some embodiments, the ¼× resolution feature map 340 is coupled as input to the resolution-separation neural network portion 308. The resolution-separation neural network portion 308 may be configured to generate ⅛× resolution feature map 341. For example, to generate the ⅛× resolution feature map, the resolution-separation neural network portion 308 may be configured to downscale the ¼× resolution feature map 340 using a strided convolution.

In some embodiments, the 1× resolution feature map 338, the ½× resolution feature map 339, the ¼× resolution feature map 340, and the ⅛× resolution feature map 341 are each coupled as input to resolution-fusion neural network portion 309. The resolution-fusion neural network portion 309 may be configured to perform a convolution over each of the feature maps 338, 339, 340, 341 in parallel, then fuse information across the different resolution feature maps. For example, the resolution-fusion neural network portion 309 may include one or more layers configured to fuse information across the different resolution feature maps.

In some embodiments the resolution-fusion neural network portion 309 is used more than one time during processing of input image 301. In one example, the resolution-fusion neural network portion 309 may be used three times during processing of input image 301. However, it should be appreciated that the fusion neural network portion 309 may be used any suitable number of times during processing of input image 301. In some embodiments, the final output of the resolution-fusion neural network portion 309 includes 1× resolution feature map 342, ½× resolution feature map 343, ¼× resolution feature map 344, and ⅛× resolution feature map 345.

In some embodiments, the portion 350 of the encoder sub-model 310 is further configured to (a) upscale the feature maps 342, 343, 344, and 345, and (b) concatenate the feature maps 342, 343, 344, and 345. For example, the feature maps may be upscaled by bilinear interpolation to a threshold shape. The concatenated feature maps 342, 343, 344, and 345 may be included as outputs of the encoder sub-model 310.

FIG. 3D illustrates an example architecture ofthe bottleneck neural network portion 303 of FIG. 3A, according to some embodiments ofthe technology described herein. The bottleneck neural network portion 303 includes bottleneck layers 351, 352. In some embodiments, the bottleneck neural network portion 303 includes one or more additional bottleneck layers, as aspects ofthe technology described herein are not limited in this respect. For example, the bottleneck neural network portion 303 may include at least four bottleneck layers. In some embodiments, the bottleneck layers may be implemented using the bottleneck layers described by He, K., et. al. (“Deep residual learning for image recognition.” In Proceeding of the IEEE conference on computer vision and pattern recognition. 2016. Pp. 770-778), which is incorporated by reference herein in its entirety.

In some embodiments, a bottleneck layer (e.g., bottleneck layer 351) includes 2D convolutional layers 351-1, 351-3, 351-5, batch normalization layers 351-2, 351-4, 351-6, and an activation layer 351-7. The activation layer 351-7 may use any suitable activation function (e.g., ReLU, leaky ReLU, sigmoid, hyperbolic, softmax, etc.).

Table 3, included below, illustrates an example configuration for the respective layers in an example implementation of bottleneck neural network portion 303.

TABLE 3
Example configuration of Bottleneck NN Portion
303 specified using PyTorch notation

| | |
|---|---|
| 0 | Bottleneck( |
| 1 | Conv2d(64, 64, kernel_size=(1, 1), stride=(1, 1), bias=False) |
| 2 | BatchNorm2d(64, eps=1e−05, momentum=0.1, affine=True, |
| | track_running_stats=True) |
| 3 | Conv2d(64, 64, kernel_size=(3, 3), stride=(1, 1), padding=(1, 1), |
| | bias=False) |
| 4 | BatchNorm2d(64, eps=1e−05, momentum=0.1, affine=True, |
| | track_running_stats=True) |
| 5 | Conv2d(64, 256, kernel_size=(1, 1), stride=(1, 1), bias=False) |
| 6 | BatchNorm2d(256, eps=1e−05, momentum=0.1, affine=True, |
| | track_running_stats=True) |
| 7 | ReLU(inplace=True) |
| 8 | Sequential( |
| 9 | Conv2d(64, 256, kernel_size=(1, 1), stride=(1, 1), bias=False) |
| 10 | BatchNorm2d(256, eps=1e−05, momentum=0.1, affine=True, |
| | track_running_stats=True) |
| 11 | ) |
| 12 | ) |
| 13 | Bottleneck( |
| 14 | Conv2d(256, 64, kernel_size=(1, 1), stride=(1, 1), bias=False) |
| 15 | BatchNorm2d(64, eps=1e−05, momentum=0.1, affine=True, |
| | track_running_stats=True) |
| 16 | Conv2d(64, 64, kernel_size=(3, 3), stride=(1, 1), padding=(1, 1), |
| | bias=False) |
| 17 | BatchNorm2d(64, eps=1e−05, momentum=0.1, affine=True, |
| | track_running_stats=True) |
| 18 | Conv2d(64, 256, kernel_size=(1, 1), stride=(1, 1), bias=False) |
| 19 | BatchNorm2d(256, eps=1e−05, momentum=0.1, affine=True, |
| | track_running_stats=True) |
| 20 | ReLU(inplace=True) |
| 21 | ) |
| 22 | Bottleneck( |
| 23 | Conv2d(256, 64, kernel_size=(1, 1), stride=(1, 1), bias=False) |
| 24 | BatchNorm2d(64, eps=1e−05, momentum=0.1, affine=True, |
| | track_running_stats=True) |
| 25 | Conv2d(64, 64, kernel_size=(3, 3), stride=(1, 1), padding=(1, 1), |
| | bias=False) |
| 26 | BatchNorm2d(64, eps=1e−05, momentum=0.1, affine=True, |
| | track_running_stats=True) |
| 27 | Conv2d(64, 256, kernel_size=(1, 1), stride=(1, 1), bias=False) |
| 28 | BatchNorm2d(256, eps=1e−05, momentum=0.1, affine=True, |
| | track_running_stats=True) |
| 29 | ReLU(inplace=True) |
| 30 | ) |
| 31 | Bottleneck( |
| 32 | Conv2d(256, 64, kernel_size=(1, 1), stride=(1, 1), bias=False) |
| 33 | BatchNorm2d(64, eps=1e−05, momentum=0.1, affine=True, |
| | track_running_stats=True) |
| 34 | Conv2d(64, 64, kernel_size=(3, 3), stride=(1, 1), padding=(1, 1), |
| | bias=False) |
| 35 | BatchNorm2d(64, eps=1e−05, momentum=0.1, affine=True, |
| | track_running_stats=True) |
| 36 | Conv2d(64, 256, kernel_size=(1, 1), stride=(1, 1), bias=False) |
| 37 | BatchNorm2d(256, eps=1e−05, momentum=0.1, affine=True, |
| | track_running_stats=True) |
| 38 | ReLU(inplace=True) |
| 39 | ) |

FIG. 3E illustrates an example architecture of a resolution-separation neural network portion 360, according to some embodiments of the technology described herein. The architecture of the resolution-separation neural network portion 360 may be used to implement one or more of resolution-separation neural network portions 304, 306, and 308 in FIGS. 3A and 3C.

In some embodiments, the resolution-separation neural network portion 360 includes one or more branches, each of which is configured to generate a feature map of a particular resolution. For example, resolution-separation neural network portion 304 of FIG. 3C may include two branches. The branches may be configured to generate 1× resolution feature map 333 and ½× resolution feature map 334, respectively. As another example, resolution-separation neural network portion 306 and resolution-separation neural network portion 308 of FIG. 3C may each include one branch configured to generate ¼× resolution feature map 337 and ⅛× resolution feature map 341, respectively.

In some embodiments, a branch of the resolution-separation neural network portion 360 includes 2D convolutional layer 360-1, batch normalization layer 360-2, and activation layer 360-3. The activation layer 360-3 may use any suitable activation function (e.g., ReLU, leaky ReLU, sigmoid, hyperbolic, softmax, etc.).

In some embodiments, a particular branch of the resolution-separation neural network portion 360 is configured to perform downscaling. Downscaling may be implemented using the 2D convolutional layer 360-1. For example, downscaling may be performed using strided convolution, instead of regular convolution.

Table 4, included below, illustrates an example configuration for the respective layers in an example implementation of resolution-separation neural network portion 360. Among other portions, the example configuration includes two branches for generating a 1× resolution feature map and a ½× resolution feature map.

TABLE 4
Example configuration of Resolution-Separation Neural
Network Portion 360 specified using PyTorch notation

| | |
|---|---|
| 0 | left branch |
| 1 | Conv2d(256, 32, kernel_size=(3, 3), stride=(1, 1), padding=(1, 1), |
| | bias=False) |
| 2 | BatchNorm2d(32, eps=1e−05, momentum=0.1, affine=True, |
| | track_running_stats=True) |
| 3 | ReLU(inplace=True) |
| 4 | ) |
| 5 | right branch |
| 6 | Sequential( |
| 7 | Conv2d(256, 64, kernel_size=(3, 3), stride=(2, 2), padding=(1, 1), |
| | bias=False) |
| 8 | BatchNorm2d(64, eps=1e−05, momentum=0.1, affine=True, |
| | track_running_stats=True) |
| 9 | ReLU(inplace=True) |
| 10 | ) |
| 11 | ) |

FIG. 3F illustrates an example architecture of a resolution-fusion neural network portion 370, according to some embodiments of the technology described herein. The architecture of the resolution-fusion neural network portion 370 may be used to implement one or more of resolution-separation neural network portions 305, 307, and 309 in FIGS. 3A and 3C.

In some embodiments, the resolution-fusion neural network portion 370 includes one or more branches, each of which includes convolutional layers for processing a respective feature mask. Accordingly, in some embodiments, the number of branches may depend on the number of feature maps output by preceding layers of the encoder sub-model 310. For example, the resolution-fusion neural network portion 305 of FIGS. 3A and 3C may be configured to receive 1× resolution map 333 and ½× resolution feature map 334. Thus, the resolution-fusion neural network portion 305 may include two branches.

In some embodiments, a first branch of the resolution-fusion neural network portion 370 includes 2D convolutional layers 371-2, 371-4, batch normalization layers 371-2, 371-5, and activation layer 371-3. A second branch may include 2D convolutional layers 372-1, 372-4, batch normalization layers 372-2, 372-5, and activation layer 372-3. The activation layers 371-3, 372-3 may use any suitable activation function (e.g., ReLU, leaky ReLU, sigmoid, hyperbolic, softmax, etc.). In some embodiments, a particular branch may include one or more additional or alternative layers. For example, following batch normalization layer 371-5, the first branch may include additional 2D convolutional layers, batch normalization layers, and/or activation layers.

Resolution-fusion neural network portion 370 further includes fuse layers 373, 375 for each of the multiple different branches. In some embodiments, fuse layers 373 and 375 are configured to fuse the feature maps having different resolutions. In some embodiments, fusing feature maps includes scaling the input feature maps and determining a sum of the scaled feature maps. The scaling may depend on the input resolution and the target output resolution. If the resolution of a particular input feature map is equal to the target output resolution, then that feature map is not scaled. If the input resolution is less than the target resolution, then the feature map may be upscaled, using nearest neighbor interpolation, to achieve the target resolution. For example, the fuse layers 373 include 2D convolutional layer 373-1 and batch normalization layer 373-2, followed by upsampling 373-3. Layers 373-1-373-3 may be configured to upscale an input feature map to achieve a target resolution. If the resolution of a particular input feature map is greater than the target resolution, then the feature map may be downscaled. For example, the fuse layers 373 may include a strided 2D convolutional layer 373-4 and batch normalization layer 373-5. Layers 373-4-373-5 may be configured to downscale an input feature map to achieve a target resolution. Fuse layers 375 may also include one or more layers configured to upscale or downscale a respective feature map to achieve a target resolution. For example, fuse layers 375 may include layers 375-1, 375-2, 375-3, 375-4, 375-5, and 375-6 configured for upscaling or downscaling a respective feature map.

In some embodiments, the resolution-fusion neural network portion 370 includes a set of fuse layers for each of multiple feature maps. For example, fuse layers 373 may be used to process a first feature map of a first resolution, fuse layers 375 may be used to process a second feature map of a second resolution, and one or more additional fuse layers may be used to process, in parallel, one or more additional feature maps.

In some embodiments, the resolution of each input feature map may serve as a target output resolution to which the resolutions of the other input feature maps are to be scaled. Consider, for example, input feature maps including a 1× resolution feature map, a ½× resolution feature map, and a ¼× resolution feature map. If each input resolution serves as a target output resolution, then the 1× resolution feature map may be downscaled 2× (e.g., to a ½× resolution) using a first subset of first fusion layers and downscaled 4× (e.g., to a ¼× resolution) using a second subset of the first fusion layers. Additionally, the ½× resolution feature map may be upscaled 2× (e.g., to a 1× resolution) using a first subset of second fusion layers and downscaled 2× (e.g., to ¼× resolution) using a second subset of the second fusion layers. Additionally, the ¼× resolution feature may be upscaled 2× using a first subset of third fusion layers, and upscaled 4× using a second subset of the third fusion layers.

In some embodiments, the outputs of fusions layers 373, 375 are combined 377. For example, after being output by the fusion layers, scaled feature maps having the same resolutions may be summed. Continuing with the above example of the three input feature maps (e.g., having resolutions of 1×, ½×, and ¼×) the resolution-fusion neural network portion 370 may be configured to sum the three scaled 1× resolution feature maps, sum the three scaled ½× resolution feature maps, and sum the three scaled ¼× feature maps, thereby generating three fused feature maps output by the fused layers.

Resolution-fusion neural network portion 370 further includes activation layer 374 configured to receive the combined output. The activation layer 374 may use any suitable activation function (e.g., ReLU, leaky ReLU, sigmoid, hyperbolic, softmax, etc.).

Table 5, included below, illustrates an example configuration for the respective layers in an example implementation of resolution-fusion neural network portion 370. Among other portions, the example configuration includes one subset of fuse layers configured to upscale an input feature map and one subset of fuse layers configured to downscale an input feature map.

TABLE 5
Example configuration of Resolution-Fusion Neural Network
Portion 370 specified using PyTorch notation

| | |
|---|---|
| 0 | StageModule( |
| 1 | ModuleList( |
| 2 | Sequential( |
| 3 | BasicBlock( |
| 4 | Conv2d(32, 32, kernel_size=(3, 3), stride=(1, 1), padding=(1, 1), |
| | bias=False) |
| 5 | BatchNorm2d(32, eps=1e−05, momentum=0.1, affine=True, |
| | track_running_stats=True) |
| 6 | ReLU(inplace=True) |
| 7 | Conv2d(32, 32, kernel_size=(3, 3), stride=(1, 1), padding=(1, 1), |
| | bias=False) |
| 8 | BatchNorm2d(32, eps=1e−05, momentum=0.1, affine=True, |
| | track_running_stats=True) |
| 9 | ) |
| 10 | BasicBlock( |
| 11 | Conv2d(32, 32, kernel_size=(3, 3), stride=(1, 1), padding=(1, 1), |
| | bias=False) |
| 12 | BatchNorm2d(32, eps=1e−05, momentum=0.1, affine=True, |
| | track_running_stats=True) |
| 13 | ReLU(inplace=True) |
| 14 | Conv2d(32, 32, kernel_size=(3, 3), stride=(1, 1), padding=(1, 1), |
| | bias=False) |
| 15 | BatchNorm2d(32, eps=1e−05, momentum=0.1, affine=True, |
| | track_running_stats=True) |
| 16 | ) |
| 17 | BasicBlock( |
| 18 | Conv2d(32, 32, kernel_size=(3, 3), stride=(1, 1), padding=(1, 1), |
| | bias=False) |
| 19 | BatchNorm2d(32, eps=1e−05, momentum=0.1, affine=True, |
| | track_running_stats=True) |
| 20 | ReLU(inplace=True) |
| 21 | Conv2d(32, 32, kernel_size=(3, 3), stride=(1, 1), padding=(1, 1), |
| | bias=False) |
| 22 | BatchNorm2d(32, eps=1e−05, momentum=0.1, affine=True, |
| | track_running_stats=True) |
| 23 | ) |
| 24 | BasicBlock( |
| 25 | Conv2d(32, 32, kernel_size=(3, 3), stride=(1, 1), padding=(1, 1), |
| | bias=False) |
| 26 | BatchNorm2d(32, eps=1e−05, momentum=0.1, affine=True, |
| | track_running_stats=True) |
| 27 | ReLU(inplace=True) |
| 28 | Conv2d(32, 32, kernel_size=(3, 3), stride=(1, 1), padding=(1, 1), |
| | bias=False) |
| 29 | BatchNorm2d(32, eps=1e−05, momentum=0.1, affine=True, |
| | track_running_stats=True) |
| 30 | ) |
| 31 | ) |
| 32 | Sequential( |
| 33 | BasicBlock( |
| 34 | Conv2d(64, 64, kernel_size=(3, 3), stride=(1, 1), padding=(1, 1), |
| | bias=False) |
| 35 | BatchNorm2d(64, eps=1e−05, momentum=0.1, affine=True, |
| | track_running_stats=True) |
| 36 | ReLU(inplace=True) |
| 37 | Conv2d(64, 64, kernel_size=(3, 3), stride=(1, 1), padding=(1, 1), |
| | bias=False) |
| 38 | BatchNorm2d(64, eps=1e−05, momentum=0.1, affine=True, |
| | track_running_stats=True) |
| 39 | ) |
| 40 | BasicBlock( |
| 41 | Conv2d(64, 64, kernel_size=(3, 3), stride=(1, 1), padding=(1, 1), |
| | bias=False) |
| 42 | BatchNorm2d(64, eps=1e−05, momentum=0.1, affine=True, |
| | track_running_stats=True) |
| 43 | ReLU(inplace=True) |
| 44 | Conv2d(64, 64, kernel_size=(3, 3), stride=(1, 1), padding=(1, 1), |
| | bias=False) |
| 45 | BatchNorm2d(64, eps=1e−05, momentum=0.1, affine=True, |
| | track_running_stats=True) |
| 46 | ) |
| 47 | BasicBlock( |
| 48 | Conv2d(64, 64, kernel_size=(3, 3), stride=(1, 1), padding=(1, 1), |
| | bias=False) |
| 49 | BatchNorm2d(64, eps=1e−05, momentum=0.1, affine=True, |
| | track_running_stats=True) |
| 50 | ReLU(inplace=True) |
| 51 | Conv2d(64, 64, kernel_size=(3, 3), stride=(1, 1), padding=(1, 1), |
| | bias=False) |
| 52 | BatchNorm2d(64, eps=1e−05, momentum=0.1, affine=True, |
| | track_running_stats=True) |
| 53 | ) |
| 54 | BasicBlock( |
| 55 | Conv2d(64, 64, kernel_size=(3, 3), stride=(1, 1), padding=(1, 1), |
| | bias=False) |
| 56 | BatchNorm2d(64, eps=1e−05, momentum=0.1, affine=True, |
| | track_running_stats=True) |
| 57 | ReLU(inplace=True) |
| 58 | Conv2d(64, 64, kernel_size=(3, 3), stride=(1, 1), padding=(1, 1), |
| | bias=False) |
| 59 | BatchNorm2d(64, eps=1e−05, momentum=0.1, affine=True, |
| | track_running_stats=True) |
| 60 | ) |
| 61 | ) |
| 62 | ) |
| 63 | ModuleList( |
| 64 | ModuleList( |
| 65 | Sequential( ) |
| 66 | Sequential( |
| 67 | Conv2d(64, 32, kernel_size=(1, 1), stride=(1, 1), bias=False) |
| 68 | BatchNorm2d(32, eps=1e−05, momentum=0.1, affine=True, |
| | track_running_stats=True) |
| 69 | Upsample(scale_factor=2.0, mode=nearest) |
| 70 | ) |
| 71 | ) |
| 72 | ModuleList( |
| 73 | Sequential( |
| 74 | Sequential( |
| 75 | Conv2d(32, 64, kernel_size=(3, 3), stride=(2, 2), padding=(1, 1), |
| | bias=False) |
| 76 | BatchNorm2d(64, eps=1e−05, momentum=0.1, affine=True, |
| | track_running_stats=True) |
| 77 | ) |
| 78 | ) |
| 79 | Sequential( ) |
| 80 | ) |
| 81 | ) |
| 82 | ReLU(inplace=True) |
| 83 | ) |

FIG. 3G illustrates an example architecture of the projection neural network portion 323 of FIG. 3A, according to some embodiments of the technology described herein. In some embodiments, the input of projection neural network portion 323 is coupled to the output of an encoder. For example, as shown in FIG. 3A, the input to the projection neural network portion 323 is coupled to output of bottleneck neural network portion 303.

The projection neural network portion 323 includes 2D convolutional layer 323-1, batch normalization layer 323-2, activation layer 323-3 and dropout layer 323-4. The activation layer 323-3 may use any suitable activation function (e.g., ReLU, leaky ReLU, sigmoid, hyperbolic, softmax, etc.).

Table 6, included below, illustrates an example configuration for the respective layers in an example implementation of projection neural network portion 323.

TABLE 6
Example configuration of Projection NN Portion
323 specified using PyTorch notation

| | |
|---|---|
| 0 | Conv2d(256, 48, kernel_size=(1, 1), stride=(1, 1), bias=False) |
| 1 | BatchNorm2d(48, eps=1e−05, momentum=0.1, affine=True, |
| | track_running_stats=True) |
| 2 | ReLU(inplace=True) |
| 3 | Dropout(p=0.5, inplace=False) |

FIG. 3H illustrates an example architecture of the atrous spatial pyramid pooling (ASPP) neural network portion 321 of FIG. 3A, according to some embodiments of the technology described herein. In some embodiments, the input of the ASPP neural network portion 321 is coupled to the output of the encoder sub-model 310. For example, as shown in FIG. 3A, the input of the ASPP neural network portion 321 is coupled to the output of the resolution-fusion neural network portion. The input of the ASPP neural network portion 321 may include one or more feature maps. For example, the input may include the concatenated feature maps 342, 343, 344, and 345 output by encoder sub-model 310, as shown in FIG. 3C.

The ASPP neural network portion 321 includes a two-dimensional convolutional layer 381, one or more ASPP convolutional neural network portions 382, 383, 384, an ASPP pooling neural network portion 385, and a projection layer 386. The ASPP convolutional neural network portion 382 includes a 2D atrous convolutional layer 382-1, batch normalization layer 382-2, and activation layer 382-3. The activation layer 382-3 may use any suitable activation function (e.g., ReLU, leaky ReLU, sigmoid, hyperbolic, softmax, etc.). Though not shown, ASPP convolutional neural network portions 383, 384 may include one or more of the layers included in the ASPP convolutional neural network portion 382.

The ASPP pooling neural network portion 385 includes pooling layer 385-1, 2D convolutional layer 285-2, batch normalization layer 385-4, and activation layer 385-4. The pooling layer 385-1 may use adaptive average pooling. The activation layer 385-4 may use any suitable activation function (e.g., ReLU, leaky ReLU, sigmoid, hyperbolic, softmax, etc.).

In some embodiments, the ASPP neural network portion 321 may be implemented using the ASPP architecture of DeepLab described by Chen, L., et. al. (“Deeplab: Semantic image segmentation with deep convolutional nets, atrous convolution, and fully connected crfs.” IEEE transactions on pattern analysis and machine intelligence, 40(4), 834-848), which is incorporated by reference herein in its entirety.

Table 7, included below, illustrates an example configuration for the respective layers in an example implementation of ASPP neural network portion 321.

TABLE 7
Example configuration of ASPP NN Portion
321 specified using PyTorch notation

| | |
|---|---|
| 0 | ASPP( |
| 1 | ModuleList( |
| 2 | Sequential( |
| 3 | Conv2d(480, 256, kernel_size=(1, 1), stride=(1, 1), bias=False) |
| 4 | BatchNorm2d(256, eps=1e−05, momentum=0.1, affine=True, |
| | track_running_stats=True) |
| 5 | ReLU( ) |
| 6 | ) |
| 7 | ASPPConv( |
| 8 | Conv2d(480, 256, kernel_size=(3, 3), stride=(1, 1), |
| | padding=(12, 12), dilation=(12, 12), |
| | bias=False) |
| 9 | BatchNorm2d(256, eps=1e−05, momentum=0.1, affine=True, |
| | track_running_stats=True) |
| 10 | ReLU( ) |
| 11 | ) |
| 12 | ASPPConv( |
| 13 | Conv2d(480, 256, kernel_size=(3, 3), stride=(1, 1), |
| | padding=(24, 24), dilation=(24, 24), |
| | bias=False) |
| 14 | BatchNorm2d(256, eps=1e−05, momentum=0.1, affine=True, |
| | track_running_stats=True) |
| 15 | ReLU( ) |
| 16 | ) |
| 17 | ASPPConv( |
| 18 | Conv2d(480, 256, kernel_size=(3, 3), stride=(1, 1), |
| | padding=(36, 36), dilation=(36, 36), |
| | bias=False) |
| 19 | BatchNorm2d(256, eps=1e−05, momentum=0.1, affine=True, |
| | track_running_stats=True) |
| 20 | ReLU( ) |
| 21 | ) |
| 22 | ASPPPooling( |
| 23 | AdaptiveAvgPool2d(output_size=1) |
| 24 | Conv2d(480, 256, kernel_size=(1, 1), stride=(1, 1), bias=False) |
| 25 | BatchNorm2d(256, eps=1e−05, momentum=0.1, affine=True, |
| | track_running_stats=True) |
| 26 | ReLU( ) |
| 27 | ) |
| 28 | ) |

FIG. 3I illustrates an example architecture of the classification neural network portion 324 of FIG. 3A, according to some embodiments of the technology described herein. As described herein, including at least with respect to FIG. 3A, the input of classification neural network portion 324 may be coupled to the output of an upsampling layer and a projection neural network portion, such as upsampling layer 322 and projection neural network portion 323. For example, the outputs of the upsampling layer and projection neural network portion may be concatenated and provided as input to the classification neural network portion 324.

The classification neural network portion 324 includes 2D convolutional layers 324-1, 324-4, batch normalization layer 324-2, and activation layers 324-3, 324-5. The activation layers 324-4, 324-5 may use any suitable activation function (e.g., ReLU, leaky ReLU, sigmoid, hyperbolic, softmax, etc.). The activation layers 324-4, 324-5 may use the same activation function or different activation functions.

In some embodiments, the classification neural network portion 324 is configured to output a mask, such as mask 325 in FIG. 3A. As described herein, in some embodiments, the mask indicates, for each of multiple pixels of an image provided as input, the probability that the pixel represents a TLS.

Table 8, included below, illustrates an example configuration for the respective layers in an example implementation of classification neural network portion 324.

TABLE 8
Example configuration of Classification NN Portion
324 specified using PyTorch notation

| | |
|---|---|
| 0 | Conv2d(304, 256, kernel_size=(3, 3), stride=(1, 1), padding=(1, 1), |
| | bias=False) |
| 1 | BatchNorm2d(256, eps=1e−05, momentum=0.1, affine=True, |
| | track_running_stats=True) |
| 2 | ReLU(inplace=True) |
| 3 | Conv2d(256, 1, kernel_size=(1, 1), stride=(1, 1)) |
| 4 | Activation( |
| 5 | Sigmoid( ) |
| 6 | ) |

FIG. 3J illustrates an example architecture of the auxiliary sub-model 330 of FIG. 3A, according to some embodiments of the technology described herein. As described herein, including at least with respect to FIG. 3A, the input of auxiliary classifier sub-model 330 may be coupled to the output of an encoder sub-model, such as the encoder sub-model 310 in FIG. 3A. For example, as shown in FIG. 3A, the input of the auxiliary classifier sub-model 330 may be coupled to the output of resolution-fusion neural network portion 307.

The auxiliary classifier sub-model 330 includes pooling layer 330-1, flatten layer 330-2, dropout layer 330-3, linear layer 330-4, and activation layer 330-5. In some embodiments, the pooling layer 330-1 uses two-dimensional average pooling. The activation layer 330-5 may use any suitable activation function (e.g., ReLU, leaky ReLU, sigmoid, hyperbolic, softmax, identity function, etc.).

Table 9, included below, illustrates an example configuration for the respective layers in an example implementation of classification neural network portion 324.

TABLE 9
Example configuration of Auxiliary Classifier
Sub-Model 330 specified using PyTorch notation

| | |
|---|---|
| 0 | ClassificationHead( |
| 1 | AdaptiveAvgPool2d(output_size=1) |
| 2 | Flatten(start_dim=1, end_dim=−1) |
| 3 | Dropout(p=0.2, inplace=True) |
| 4 | Linear(in_features=256, out_features=2, bias=True) |
| 5 | Activation( |
| 6 | Identity( ) |
| 7 | ) |
| 8 | ) |

### Training

FIG. 4A is a flowchart of an illustrative process 400 for training a neural network model to identify at least one TLS in an image of tissue, according to some embodiments of the technology described herein. Process 400 may be performed by software (e.g., software 112) executing on a laptop computer, a desktop computer, one or more servers, in a cloud computing environment, computing device 108 as described herein with respect to FIGS. 1A-1B, computing device 800 as described herein with respect to FIG. 8, or any other suitable computing device.

At act 402, the software performing process 400 obtains an annotated set of images from subjects. In some embodiments, each of at least some (e.g., all) of the images in the set of annotated images includes an image of tissue from subjects having cancer. For example, the annotated set of images may include images of tissue from subjects having cancers where TLS is of interest. Examples of cancers for which TLS is of interest are described herein including at least in the “Applications” and “Methods of Treatment” sections. In some embodiments, all of the images in the annotated set of images are images of tissue from subjects having the same type of cancer. In some embodiments, different subsets of images in the annotated set of images are images of tissue from subjects having different types of cancer.

In some embodiments, some or all of the images in the annotated set of images may be obtained or may have been previously-obtained using an imaging platform such as, for example, imaging platform 104 described with reference to FIG. 1A. Each of the annotated images may be a single-channel image or multi-channel image (e.g., a 3-channel RGB image). For example, an annotated image may be an annotated whole slide image (WSI). The annotated image may have any suitable dimensions, as aspects of the technology are not limited in this respect. For example, an annotated image may have at least 100,000×100,000 pixel values per channel, 75,000×75,000 pixel values per channel, 50,000×50,000 pixel values per channel, 25,000×25,000 pixel values per channel, 10,000×10,000 pixel values per channel, 5,000×5,000 pixel values per channel or any other suitable number of pixels per channel. The dimensions of the image may be within any suitable range such as, for example, 50,000-500,000×50,000-500,000 pixel values per channel, 25,000-1 million×25,000-1 million pixel values per channel, 5,000-2 million×5,000-2 million pixel values per channel, or any other suitable range within these ranges.

In some embodiments, the set of annotated images include any suitable number of annotated images, as aspects of the technology are not limited in this respect. For example, the set of annotated images may include at least 50 images, at least 75 images, at least 90 images, at least 100 images, at least 110 images, at least 125 images, at least 150 images, at least 175 images, at least 200 images, at least 250 images, at least 300 images, at least 350 images, at least 400 images, at least 500 images, at least 750 images, at least 1,000 images, between 25 and 5,000 images, between 50 and 1,000 images, between 75 and 500 images, or any other suitable number of images.

Notably, the inventors have recognized that the neural network models described herein (e.g., the neural network model with the architecture shown in FIGS. 3A-3J and having anywhere from 25-50M parameters) may be trained to effectively identify TLS structures with only a small number of annotated high-resolution (e.g., 100K×100K) WSI images (e.g., between 100 and 500 such images), which is unexpected given the high number of parameters (e.g., 25-50M) that have to be learned during training. This is an important characteristic of the neural network models described herein in that being able to train a neural network to be effective on the task it is designed for by using a smaller amount of training data not only reduces the computational burden of the training procedure (i.e., less processor and memory resources need to be consumed to train the neural network), but also reduces the expense of obtaining annotated imagery which requires expensive and limited time from expert human labelers.

In some embodiments, the obtained images may be augmented using any suitable augmentation techniques. As a nonlimiting example, in some embodiments, one or more of the obtained images may be augmented using random rotations (e.g., by a random number of degrees including 90 degrees and multiples thereof). In some embodiments, a horizontal and/or a vertical blur may be applied to one or more of the obtained images. In some embodiments, noise (e.g., Gaussian noise) may be applied to one or more of the obtained images. In some embodiments, data augmentation may be performed using “mixup” described by Cisse, M. et. al., (“mixup: Beyond empirical risk minimization.” arXiv preprint arXiv:1710.09412), which is incorporated by reference herein in its entirety. In some embodiments, data augmentation is performed using “copy-paste” augmentation described by Ghiasi, G., et. al. (“Simple copy-paste is a strong data augmentation method for instance segmentation. In Proceedings of the IEEE/CVF conference on computer vision and pattern recognition (pp. 2918-2928)), which is incorporated by reference herein in its entirety.

In some embodiments, the images are annotated to indicate locations of TLSs in the images. The images may be annotated in any manner suitable for indicating locations of TLSs, as aspects of the technology are not limited in this respect. For example, pixel-level labeling may be used to indicate, for each particular pixel of multiple pixels, whether the particular pixel is part of a TLS. For example, in some embodiments, the image may be annotated with a pixel-level mask the indicates whether pixels covered by the pixel-level mask are part of at least one TLS in the image (e.g., with a “1” indicating that a pixel is part of a TLS and a “0” indicating that the pixel is not part of any TLS).

In some embodiments, the images may be annotated to indicate at least one TLS region. In some embodiments, a TLS region includes boundaries enclosing a region of the image that includes one or more pixels that are annotated to be part of a TLS. In some embodiments, a TLS region has one or more characteristics. As non-limiting examples, the characteristics of a TLS region include the centroid of the TLS region, the area of the TLS region, and the radius of the TLS region. In some embodiments, the radius on the TLS region may be considered to be the square root of the area of the TLS region. In some embodiments, the characteristics of the TLS region may be included in the annotations of the obtained images. Additionally, or alternatively, the characteristics of the TLS region may be determined based on the pixel-level annotations and/or the identified boundaries of the TLS region.

In some embodiments, the images are annotated to indicate the location of tissue in the images. The images may be annotated in any manner suitable for indicating locations of tissue, as aspects of the technology are not limited in this respect. For example, pixel-level labeling may be used to indicate, for each of multiple pixels, whether the particular pixel is part of tissue. For example, in some embodiments, the image may be annotated with a pixel-level mask that indicates whether pixels covered by the pixel-level mask are part of tissue in the image. In some embodiments, the images may be annotated to include a bounding box around a region of tissue in the image. For example, the bounding box may be defined by four coordinates (xₘᵢₙ, xₘₐₓ, yₘᵢₙ, and yₘₐₓ) that represent the bounds of the bounding box relative to annotated image.

In some embodiments, different sub-sets of the images may have been annotated by different annotators and/or a different number of annotators. For example, in some embodiments, all of the images in the annotated set of images may have been annotated by a single annotator. In some embodiments, some of the images may have been annotated by a single annotator, while some of the images may have been annotated by multiple annotators. In some embodiments, all of the images in the annotated set of images may have been annotated by multiple annotators.

In some embodiments, when an image has been annotated by multiple annotators, the annotations for the image may be aggregated. In some embodiments, the annotations for an image are aggregated using any suitable techniques for estimating a ground truth segmentation based on a group of multiple expert segmentations. In some embodiments, the aggregation may be performed using the ground truth estimation techniques described by Warfield, S., et. al. (“Validation of image segmentation and expert quality with an expectation-maximization algorithm.” In Proceedings of Fifth International Conference on Medical Image Computing and Computer-Assisted Intervention (MICCAI), Part I. 2002), which is incorporated by reference herein in its entirety. For example, ground truth estimation techniques may be implemented using the SimpleITK interface described by R. Beare, et. al. (“Image Segmentation, Registration and Characterization in R with SimpleITK”, J Stat Software, 86(8), 2018), Z. Yaniv, et. al. (“SimpleITK Image-Analysis Notebooks: a Collaborative Environment for Education and Reproducible Research”, J Digit Imaging., 31(3): 290-303, 2018), and B. Lowekamp, et. al., (“The Design of SimpleITK”, Front. Neuroinform., 7:45. 2013), each of which is incorporated by reference in its entirety.

At act 404, the software performing process 400 generates batches of sub-images from the annotated set of images. These batches are to be used for training, as described herein. In some embodiments, a sub-image in a batch of sub-images may be obtained from one or more annotated images in the annotated set of images. For example, a sub-image may be cropped out of an annotated image. The dimensions of the sub-image may depend on the dimensions of the image from which the sub-image is obtained. For example, dimensions of the sub-image may be smaller than the corresponding dimensions of the image from which the sub-image is obtained. For example, the sub-image may have at least 128×128 pixels per channel, 256×256 pixels per channel, 512 pixels×512 pixels per channel, 1024×1024 pixels per channel, 2048×2048 pixels per channel, 40964×4096 pixels per channel, 8192×8192 pixels per channel or any other suitable number of pixels per channel. The dimensions of the sub-image image may be within any suitable range such as, for example, 10-100,000×10-100,000 pixel values per channel, 100-50,000×100-50,000 pixel values per channel, 1,000-10,000×1,000-10,000 pixel values per channel, or any other suitable range within these ranges.

In some embodiments, the batches generated as part of act 404 may be used for the training stages 406-1, 406-2, 406-3, and 406-4. In other embodiments, the batches may be generated separately for each of the training stages performed at acts 406-1, 406-2, 406-3, and 406-4.

In some embodiments, the generated batches include: (1) sub-images containing at least one TLS region (e.g., a region part of a TLS or a whole TLS); (2) sub-images containing tissue but no TLS region; and (3) sub-images containing neither any TLS region nor tissue. In some embodiments, the batches are generated to control the ratio of the types of sub-images in each batch. This may help to ensure that the datasets used to train and/or validate the neural network model are not unbalanced due to the inclusion of a relatively large number of sub-images that do not contain TLS. In some embodiments, the ratio of the different types of sub-image included in a particular batch may be any suitable ratio, as aspects of the technology described herein are not limited in this respect. As nonlimiting examples, for a particular batch, the ratio of (1) the number of sub-images containing at least one TLS region; to (2) the number of sub-images containing tissue but no TLS region; to (3) the number of sub-images containing neither any TLS region nor tissue may be 3:2:1, 4:2:1, 4:3:1, 5:2:1, 5:3:1, 6:2:1, 6:3:1, 6:4:1, 6:5:1, 7:2:1, 7:3:1, 7:4:1, 7:5:1, 7:6:1, or any other suitable target ratio.

In some embodiments, generating the batches of sub-images from the annotated set of images at act 404 includes generating at least some batches using images annotated by a single annotator and at least some batches using images annotated by multiple annotators.

In some embodiments, generating the batches of sub-images from the annotated set of images includes, at act 404-1, generating multiple sub-images containing at least one TLS region (e.g., a region part of a TLS or a whole TLS). Process 450 shown in FIG. 4B is an example implementation of act 404-1.

As described herein including at least with respect to act 402 of process 400, the annotated set of images may identify, or be used to identify, one or more TLS regions. In some embodiments, one or more geometric characteristic of the TLS region may be determined as part of act 402 including, for example, a radius, a centroid, an area, and/or a perimeter of the TLS region. Accordingly, in some embodiments, at act 452 of process 450, the software performing process 450 samples a centroid from among the set of centroids identified for the TLS regions in the annotated set of images. In some embodiments, the centroids may be sampled using any suitable sampling technique. For example, the centroids may be sampled using simple random sampling, systematic sampling, sampling with probability proportional to size, stratified sampling, cluster sampling, multi-stage sampling, multi-phase sampling, or any other suitable sampling technique. As a nonlimiting example, the centroids may be sampled with a probability that is proportional to a characteristic of the TLS region. For example, the centroids may be sampled with a probability that is proportional to their radii or with a probability proportional to their area.

At act 454, the software performing process 450 identifies coordinates for a centroid for the particular sub-images. In some embodiments, this includes, for each of multiple of the sampled centroids of the TLS regions, identifying coordinates for a centroid for a respective sub-image relative to the sampled centroid of the TLS region. In some embodiments, this includes sampling the coordinates from among a range of coordinates. As a nonlimiting example, where the sampled coordinates are polar coordinates, the radius may be sampled from among a range of radii and the angle may be sampled from among a range of angles. The range of radii may include any suitable range of radii such as, for example, a range of 0 to the radius of the TLS region, a range of 0 to 0.25× the radius of the TLS region, a range of 0 to 0.5× the radius of the TLS region, a range of 0 to 0.75× the radius of the TLS region, a range of 0 to 1.5× the radius of the TLS region, a range 0 to 1.75× the radius of the TLS region, a range of 0 to 2× the radius of the TLS region, or any other suitable range, as aspects of the technology are not limited in this respect. The range of angles may include any suitable range of angles such as, for example, a range of 0 to 2Π, 0 to 1.75Π, 0 to 1.5Π, 0 to 1.25 Π, 0 to H, 0 to 0.75Π, 0 to 0.5Π, 0 to 0.25 Π, or any other suitable range of angles, as aspects of the technology described herein are not limited in this respect. In some embodiments, after identifying polar coordinates for a centroid of a sub-image, the techniques include converting the polar coordinates to cartesian coordinates.

In some embodiments, because the shape of a TLS region may not be uniform, the sampled coordinates for the centroid of a sub-image may fall outside of the TLS region. Accordingly, in some embodiments, at act 456, the software performing process 450 determines that the identified coordinates fall within a TLS region.

When it is determined that the coordinates for the centroid of a particular sub-image fall within the TLS region, then the software performing process 450 generates the particular sub-image having a center at the centroid. In some embodiments, if the centroid of the sub-image is close to the edge of the annotated image, then the sub-image may extend beyond the dimensions of the image. Accordingly, the sub-image may be padded with zeroes.

Returning to FIG. 4A, process 400 proceeds to act 404-2 where the software performing process 400 generates multiple sub-images containing tissue, but no TLS. In some embodiments, this includes identifying coordinates for a centroid for the particular sub-images. In some embodiments, identifying coordinates for the centroids includes sampling coordinates for the centroids from among coordinates of the annotated image that include tissue. For example, the coordinates may be sampled using simple random sampling, systematic sampling, sampling with probability proportional to size, stratified sampling, cluster sampling, multi-stage sampling, multi-phase sampling, or any other suitable sampling technique. As a non-limiting example, the coordinates of a centroid of a sub-image may be randomly sampled within a range of coordinates enclosed within a bounded region of the image that includes tissue. For example, when the region of tissue is bounded by a bounding box, then coordinates may be randomly sampled from within the bounding box.

In some embodiments, after identifying the coordinates for the centroid of the particular sub-images, the software performing process 400 determines that the new centroid is labeled, in the annotated image, as tissue. In some embodiments, the software performing process 400 determines that the prospective sub-image does not intersect with any of the sub-images generated for the batch of sub-images containing at least one TLS region.

When it is determined that the centroid of a particular sub-image is labeled as tissue and that particular sub-image does not intersect with a sub-image generated for the batch of sub-images containing at least one TLS region, then the software performing process 450 generates the particular sub-image having a center at the centroid. In some embodiments, if the centroid of the sub-image is close to the edge of the annotated image, then the sub-image may extend beyond the dimensions of the image. Accordingly, the sub-image may be padded with zeroes.

At act 404-3, the software performing process 400 generates multiple sub-images containing neither TLS nor tissue (“background” sub-images). In some embodiments, this includes identifying coordinates for a centroid for the particular sub-images. In some embodiments, identifying coordinates includes identifying the coordinates that were determined to fall outside a TLS region at act 456 of process 450 and/or the coordinates of the centroids that were determined to not be labeled as tissue in the annotated image.

In some embodiments, after identifying the coordinates for the centroid of the particular sub-images, the software performing process 400 determines that the prospective sub-image does not intersect with any of the sub-images generated for the batch of sub-images containing at least one TLS region or any of the sub-images generated for the batch of sub-images containing tissue but not any TLS region.

When it is determined that the particular sub-image does not intersect with a sub-image generated for the batch of sub-images containing at least one TLS region or a sub-image generated for the batch of sub-images containing tissue but not TLS, then the software performing process 450 generates the particular sub-image having a center at the centroid. In some embodiments, if the centroid of the sub-image is close to the edge of the annotated image, then the sub-image may extend beyond the dimensions of the image. Accordingly, the sub-image may be padded with zeroes.

In some embodiments, during or after the generation of batches of sub-images at act 404 one or more of the sub-images and/or their respective sub-image annotations are processed using any suitable processing techniques. For example, in some embodiments, when a sub-image annotation includes a pixel-level mask, the software performing process 400 may process the mask using any suitable mask smoothing technique. For example, mask smoothing may be implemented to reduce the penalty, during neural network model training, for errors occurring at the boundaries of the mask when annotations are inaccurate or ambiguous. In some embodiments, implementing a mask smoothing technique may include, for each of multiple pixels in the sub-image that are part of the background (e.g., not part of tissue or TLS), normalizing the value (v.) of the pixel using a distance transform such as the Euclidean distance transform value (e.g., pixel=1 if there is no TLS/tissue at that pixel, pixel=0 otherwise). For example, a pixel value may be normalized using Equation 14:

$${v}_{n} = {( \frac{0.3}{edt} )}^{0.7} \qquad ( Equation 14 )$$

where edt is the Euclidean-distance-transform value of the pixel. It should be appreciated that the parameters 0.3 and 0.7 are example parameters and any other suitable parameters in the open interval (0, 1) may be used in other embodiments.

At act 406, the software performing process 400 trains a neural network model using the generated batches of sub-images to obtain the trained neural network model. As shown, in some embodiments, act 406 includes act 406-1 for training the neural network model using batches of single-annotator sub-images, act 406-2 for training the neural network model using batches of aggregated multi-annotator sub-images, act 406-3 for fine-tuning the neural network model, and act 406-4 for training the neural network model using active learning. It should be appreciated, however, that act 406 may include one or more additional or alternative acts for training the neural network as aspects of the technology described herein are not limited in this respect. For example, in some embodiments, act 406 may include all of acts 406-1 through 406-6. In some embodiments, act 406 includes a subset of acts 406-1 through 406-4. For example, act 406 may include only acts 406-1-406-3; only acts 406-1-406-2, only acts 406-1-406-2 and act 406-4; only acts 406-2-406-4; only acts 406-2-406-3, or any other suitable combination of acts.

In the illustrative embodiment of FIG. 4A, at act 406-1, the software performing process 400 trains and validates the neural network model using batches of single-annotator sub-images. In some embodiments, for each epoch, any suitable number of sub-images may be used to train the neural network model and any suitable number of sub-images may be used to validate the neural network model. For example, for each epoch, at least 20, at least 30, at least 40, at least 50, at least 100, at least 150, at least 200, at least 250, at least 300, at least 350, at least 400, at least 500, at least 600, at least 650, at least 700, at least 725, at least 750, at least 775, at least 800, at least 825, at least 850, at least 900, at least 925, at least 950, at least 975, at least 1,000, at least 1,050, at least 1,100, at least 1,200, at least 1,300, at least 1,400, between 20 and 3,000, between 100 and 2,500, or any other suitable number of sub-images may be used to train or validate the neural network model during act 406-1.

In some embodiments, the sub-images used to train or validate the neural network model are obtained from any suitable number of images (e.g., WSIs) per epoch. For example, for each epoch, the sub-images may be obtained from at least 2 images, at least 5 images, at least 10 images, at least 25 images, at least 30 images, at least 35 images, at least 40 images, at least 45 images, at least 50 images, at least 60 images, at least 70 images, between 1 and 100 images, between 5 and 50 images, or any other suitable number of images, as aspects of the technology are not limited in this respect.

In some embodiments, any suitable number of the sub-images used to train or validate the neural network model are obtained from a particular image (e.g., WSI). For example, at least 5 sub-images, at least 10 sub-images, at least 15 sub-images, at least 20 sub-images, at least 25 sub-images, at least 30 sub-images, at least 35 sub-images, at least 40 sub-images, at least 50 sub-images, between 5 and 75 sub-images, between 10 and 40 sub-images, or any other suitable number of sub-images are obtained from each image, as aspects of the technology are not limited in this respect.

In some embodiments, at least some of the sub-images obtained from a particular image (e.g., WSI) and used to train or validate the neural network model form a batch. In some embodiments, the batch may include any suitable number of the sub-images obtained from an image and used to train the neural network model. For example, a batch may include at least 6, at least 7, at least 8, at least 10, at least 12, at least 15, at least 20, between 5 and 100, between 5 and 25, or any other suitable number of sub-images as aspects of the technology described herein are not limited in this respect.

In some embodiments, at act 406-1, the neural network model is trained and validated with any suitable number of epochs, as aspects of the technology described herein are not limited in this respect. For example, the neural network model may be trained and validated with at least 20 epochs, at least 25 epochs, at least 30 epochs, at least 40 epochs, at least 50 epochs, at least 60 epochs, at least 75 epochs, at least 80 epochs, between 10 and 100 epochs, between 20 and 80 epochs, or any other suitable number of epochs.

In some embodiments, training the neural network model at act 406-1 includes training the neural network model using any suitable optimizer algorithm. For example, training the neural network model may include using the Adam optimizer algorithm described by Kingma, D. and Jimmy, B. (“Adam: A method for stochastic optimization.” arXiv preprint arXiv:1412.6980 (2014)), which is incorporated by reference herein in its entirety. However, it should be appreciated that any suitable optimization algorithm may be used in training the neural network model, as aspects of the technology described herein are not limited in this respect.

In some embodiments, one or more initial parameters are selected for training the neural network model. In some embodiments, initial parameters may be selected for an encoder sub-model (e.g., encoder sub-model 310 in FIG. 3A), a decoder sub-model (e.g., decoder sub-model 320 in FIG. 3A), and an auxiliary classifier sub-model (e.g., auxiliary classifier sub-model 330 in FIG. 3A). For example, an initial learning rate may be selected for each of the sub-models. As an example, the initial learning rate for the encoder sub-model, the decoder sub-model, and the auxiliary classifier may be set to 2×10⁻³. However, it should be appreciated that the initial learning rates may selected to be any suitable initial learning rates as aspects of the technology are not limited in this respect.

In some embodiments, the learning rate of a particular portion of the neural network is set after one or more epochs. For example, training the neural network model at act 406-1 may include freezing the encoder sub-model during one or more epochs, then setting the learning rate for the encoder sub-model to a different value. As an example, the encoder sub-model may be frozen during the first two epochs, then the learning rate of the encoder sub-model may be set to 1×10⁻⁴. In some embodiments, after the fourth epoch, the learning rate of the sub-model may then be set to 5×10⁻⁵.

In some embodiments, one or more other parameters may be selected for training the neural network such as, for example, the parameters β₁, β₂, ε, and α. In some embodiments, such parameters may be set to any suitable values including, for example, the default settings suggested by Kingma, D. and Jimmy, B. (“Adam: A method for stochastic optimization.” arXiv preprint arXiv:1412.6980 (2014)).

In some embodiments, training the neural network model at act 406-1 includes minimizing a loss function. In some embodiments, the loss function includes any suitable loss function. In some embodiments, when the neural network model includes a classifier configured to output a pixel-level mask and an auxiliary classifier sub-model, the loss function may account for both a loss associated with pixel-level mask and a loss associated with the output of the auxiliary classifier sub-model. In some embodiments, loss associated with the pixel-level mask (L_{seg}) may include cross-entropy (L_{DICE}^{seg}) and dice loss (L_{CE}^{seg}), and loss associated with the output of the auxiliary classifier (Lₐᵤₓ) sub-model may include cross-entropy loss (L_{CE}^{aux}). In some embodiments, loss is determined using Equation 15:

$$L = k * {L}_{DICE}^{seg} + ( 1 - k ) * {L}_{CE}^{seg} + λ * {L}_{CE}^{aux} \qquad ( Equation 15 )$$

where k is initially 0.5, then set to 0.1 after the fifth epoch, then set to 0.2 after the ninth epoch., and where λ is initially 1, then set to 0.5 after the second epoch, then set to 0.2 after the fourth epoch, then set to 0.1 after the eighth epoch.

At act 406-2, the software performing process 400 trains and validates the neural network model using batches of aggregated multi-annotator sub-images. In some embodiments, for each epoch, any suitable number of sub-images may be used to train the neural network model and any suitable number of sub-images may be used to validate the neural network model. For example, for each epoch, at least 20, at least 30, at least 40, at least 50, at least 100, at least 150, at least 200, at least 250, at least 300, at least 350, at least 400, at least 500, at least 600, at least 650, at least 700, at least 725, at least 750, at least 775, at least 800, at least 825, at least 850, at least 900, at least 925, at least 950, at least 975, at least 1,000, at least 1,050, at least 1,100, at least 1,200, at least 1,300, at least 1,400, between 20 and 3,000, between 100 and 2,500, or any other suitable number of sub-images may be used to train or validate the neural network model during act 406-2.

In some embodiments, the sub-images used to train or validate the neural network model are obtained from any suitable number of images (e.g., WSIs) per epoch. For example, for each epoch, the sub-images may be obtained from at least 2 images, at least 5 images, at least 10 images, at least 25 images, at least 30 images, at least 35 images, at least 40 images, at least 45 images, at least 50 images, at least 60 images, at least 70 images, between 1 and 100 images, between 5 and 50 images, or any other suitable number of images, as aspects of the technology are not limited in this respect.

In some embodiments, any suitable number of the sub-images used to train or validate the neural network model are obtained from a particular image (e.g., WSI). For example, at least 5 sub-images, at least 10 sub-images, at least 15 sub-images, at least 20 sub-images, at least 25 sub-images, at least 30 sub-images, at least 35 sub-images, at least 40 sub-images, at least 50 sub-images, between 5 and 75 sub-images, between 10 and 40 sub-images, or any other suitable number of sub-images are obtained from each image, as aspects of the technology are not limited in this respect.

In some embodiments, at least some of the sub-images obtained from a particular image (e.g., WSI) and used to train or validate the neural network model form a batch. In some embodiments, the batch may include any suitable number of the sub-images obtained from an image and used to train the neural network model. For example, a batch may include at least 6, at least 7, at least 8, at least 10, at least 12, at least 15, at least 20, between 5 and 100, between 5 and 25, or any other suitable number of sub-images as aspects of the technology described herein are not limited in this respect.

In some embodiments, at act 406-2, the neural network model is trained and validated with any suitable number of epochs, as aspects of the technology described herein are not limited in this respect. For example, the neural network model may be trained and validated with at least 20 epochs, at least 25 epochs, at least 30 epochs, at least 40 epochs, at least 50 epochs, at least 60 epochs, at least 75 epochs, at least 80 epochs, between 10 and 100 epochs, between 20 and 80 epochs, or any other suitable number of epochs.

In some embodiments, training the neural network model at act 406-2 includes training the neural network model using any suitable optimization algorithm, for example, by using the Adam optimizer.

In some embodiments, one or more initial parameters are selected for training the neural network model. In some embodiments, initial parameters may be selected for an encoder sub-model (e.g., encoder sub-model 310 in FIG. 3A), a decoder sub-model (e.g., decoder sub-model 320 in FIG. 3A), and an auxiliary classifier sub-model (e.g., auxiliary classifier sub-model 330 in FIG. 3A). For example, an initial learning rate may be selected for each of the sub-models. As an example, the initial learning rate for the encoder sub-model may be set to 2×10⁻⁴, and the initial learning rate for the decoder sub-model and the auxiliary classifier may be set to 2×10⁻³. However, it should be appreciated that the initial learning rates may selected to be any suitable initial learning rates as aspects of the technology are not limited in this respect.

In some embodiments, the learning rate of a particular portion of the neural network is set after one or more epochs. For example, training the neural network model at act 406-2 may include freezing at least a portion of the encoder sub-model during one or more epochs. For example, with reference to FIG. 3A, freezing the portion of the encoder sub-model may include freezing portions 303-308 of the encoder. As an example, the portion of the encoder sub-model may be frozen during the first three epochs. In some embodiments, after the fifth epoch, the learning rate of the encoder sub-model may be set to 5×10⁻⁵. In some embodiments, after the thirteenth epoch, the learning rates of encoder sub-model, the decoder sub-model, and the auxiliary classifier are each set to 1×10⁻⁷.

In some embodiments, one or more other parameters may be selected for training the neural network such as, for example, the parameters β₁, β₂, ε, and α. In some embodiments, such parameters may be set to any suitable values including, for example, the default settings suggested by Kingma, D. and Jimmy, B. (“Adam: A method for stochastic optimization.” arXiv preprint arXiv:1412.6980 (2014)).

In some embodiments, gradient clipping is applied during the training of the neural network at act 406-2. For example, gradient clipping may be applied. For example, gradient clipping-by-norm may be applied with any suitable maximum norm (e.g., by maximum norm of 4). In some embodiments, gradient clipping is applied after one or more epochs. For example, gradient clipping may be applied after the fourth epoch.

In some embodiments, training the neural network model at act 406-2 includes minimizing a loss function. In some embodiments, the loss function includes any suitable loss function. In some embodiments, when the neural network model includes a classifier configured to output a pixel-level mask and an auxiliary classifier sub-model, the loss function may account for both a loss associated with pixel-level mask and a loss associated with the output of the auxiliary classifier sub-model. In some embodiments, loss associated with the pixel-level mask (L_{seg}) may include cross-entropy (L_{DICE}^{seg}) and dice loss (L_{CE}^{seg}), and loss associated with the output of the auxiliary classifier (Lₐᵤₓ) sub-model may include cross-entropy loss (L_{CE}^{aux}). In some embodiments, stability learning is applied in determining loss. In some embodiments, loss is determined using Equation 16:

$$L = k * {L}_{DICE}^{seg} + ( 1 - k ) * {L}_{CE}^{seg} + λ * {L}_{CE}^{aux} + ψ * KL ( model ( x ) , model ( G ( x ) + ε ) \qquad ( Equation 16 )$$

where k is initially 0.5, then set to 0.1 after the fifth epoch, then set to 0.2 after the eleventh epoch., where λ is initially 1, then set to 0.5 after the second epoch, then set to 0.2 after the fourth epoch, then set to 0.1 after the eighth epoch, where F is a numerical stabilizer with a value of 1×10⁻⁵, ψ is 0.1, G is Gaussian noise, and KL is Kullback-Leiber divergence.

At act 406-3, the software performing process 400 fine-tunes the neural network model. In some embodiments, the sub-images used for training or validating the neural network model are obtained from images of tissue from subject having a same type or a different type of cancer than the images used train the neural network model at acts 406-1 and 406-2. For example, the sub-images used train the neural network model at acts 406-1 and 406-2 may have been obtained from images of tissue from subjects having lung adenocarcinoma, while sub-images used to fine the neural network model at act 406-3 may have been obtained from images of tissue from subjects having breast cancer.

In some embodiments, for each epoch, any suitable number of sub-images may be used to train the neural network model and any suitable number of sub-images may be used to validate the neural network model. For example, for each epoch, at least 20, at least 30, at least 40, at least 50, at least 100, at least 150, at least 200, at least 250, at least 300, at least 350, at least 400, at least 500, at least 600, at least 650, at least 700, at least 725, at least 750, at least 775, at least 800, at least 825, at least 850, at least 900, at least 925, at least 950, at least 975, at least 1,000, at least 1,050, at least 1,100, at least 1,200, at least 1,300, at least 1,400, between 20 and 3,000, between 100 and 2,500, or any other suitable number of sub-images may be used to train or validate the neural network model during act 406-3.

In some embodiments, the sub-images used to train or validate the neural network model are obtained from any suitable number of images (e.g., WSIs) per epoch. For example, for each epoch, the sub-images may be obtained from at least 2 images, at least 5 images, at least 10 images, at least 25 images, at least 30 images, at least 35 images, at least 40 images, at least 45 images, at least 50 images, at least 60 images, at least 70 images, between 1 and 100 images, between 5 and 50 images, or any other suitable number of images, as aspects of the technology are not limited in this respect.

In some embodiments, any suitable number of the sub-images used to train or validate the neural network model are obtained from a particular image (e.g., WSI). For example, at least 5 sub-images, at least 10 sub-images, at least 15 sub-images, at least 20 sub-images, at least 25 sub-images, at least 30 sub-images, at least 35 sub-images, at least 40 sub-images, at least 50 sub-images, between 5 and 75 sub-images, between 10 and 40 sub-images, or any other suitable number of sub-images are obtained from each image, as aspects of the technology are not limited in this respect.

In some embodiments, at least some of the sub-images obtained from a particular image (e.g., WSI) and used to train or validate the neural network model form a batch. In some embodiments, the batch may include any suitable number of the sub-images obtained from an image and used to train the neural network model. For example, a batch may include at least 6, at least 7, at least 8, at least 10, at least 12, at least 15, at least 20, between 5 and 100, between 5 and 25, or any other suitable number of sub-images as aspects of the technology described herein are not limited in this respect.

In some embodiments, at act 406-3, the neural network model is trained and validated with any suitable number of epochs, as aspects of the technology described herein are not limited in this respect. For example, the neural network model may be trained and validated with at least 20 epochs, at least 25 epochs, at least 30 epochs, at least 40 epochs, at least 50 epochs, at least 60 epochs, at least 75 epochs, at least 80 epochs, between 10 and 100 epochs, between 20 and 80 epochs, or any other suitable number of epochs.

In some embodiments, training the neural network model at act 406-3 includes training the neural network model using any suitable optimization algorithm, for example, by using the Adam optimizer.

In some embodiments, one or more initial parameters are selected for training the neural network model. In some embodiments, initial parameters may be selected for an encoder sub-model (e.g., encoder sub-model 310 in FIG. 3A), a decoder sub-model (e.g., decoder sub-model 320 in FIG. 3A), and an auxiliary classifier sub-model (e.g., auxiliary classifier sub-model 330 in FIG. 3A). For example, an initial learning rate may be selected for each of the sub-models. As an example, the initial learning rate for the encoder sub-model may be set to 2×10⁻⁴, and the initial learning rates for the decoder sub-model and the auxiliary classifier may each be set to 2×10⁻³. However, it should be appreciated that the initial learning rates may selected to be any suitable initial learning rates as aspects of the technology are not limited in this respect.

In some embodiments, the learning rate of a particular portion of the neural network is set after one or more epochs. For example, training the neural network model at act 406-3 may include freezing the encoder sub-model during one or more epochs, then setting the learning rate for the encoder sub-model to a different value. As an example, the encoder sub-model may be frozen during the first six epochs. After the sixth epoch, one or more layers of the encoder sub-model may be unfrozen. For example, with reference to encoder sub-model 310 in FIG. 3A, resolution fusion portion 309 may be unfrozen after the sixth epoch. In some embodiments, the other layers of the encoder sub-model may be unfrozen after a later epoch such as, for example, the eleventh epoch. In some embodiments, after the third epoch, the learning rate of the decoder sub-model is set of 1×10⁻⁴, and the learning rate of the auxiliary classifier sub-model is set to 5×10⁻⁵. In some embodiments, after the sixth epoch, the learning rate of the decoder sub-model is set of 5×10⁻⁵, and the learning rate of the auxiliary classifier sub-model is set to 1×10⁻⁵. In some embodiments, after the eleventh epoch, the learning rate of the decoder sub-model is set of 1×10⁻⁵, and the learning rate of the auxiliary classifier sub-model is set to 1×10⁻⁴, and the learning rate of the encoder sub-model is set to 5×10⁻⁵. In some embodiments, after the sixteenth epoch, the learning rates of the encoder sub-model, the decoder sub-model, and the auxiliary classifier sub-model are each set to 1×10⁻⁷.

In some embodiments, weight decay is another parameter that may be initially selected for training the neural network model. As nonlimiting example, the weight decay for the encoder sub-model may be set to 2×10⁻⁴, the weight decay for the decoder sub-model may be set to 1×10-5, and the weight decay for the auxiliary classifier sub-model may be set to be 2×10⁻⁴. However, any other suitable values for weight decay may be selected, as aspects of the technology described herein are not limited in this respect.

In some embodiments, one or more other parameters may be selected for training the neural network such as, for example, the parameters β₁, β₂, ε, and α. In some embodiments, such parameters may be set to any suitable values including, for example, the default settings suggested by Kingma, D. and Jimmy, B. (“Adam: A method for stochastic optimization.” arXiv preprint arXiv:1412.6980 (2014)).

In some embodiments, training the neural network model at act 406-3 includes minimizing a loss function. In some embodiments, the loss function includes any suitable loss function. For example, the loss function may include the loss function of Equation 15, where k is initially 0.5, then set to 0.1 after the sixth epoch, then set to 0.2 after the ninth epoch.

At act 406-4, the software performing process 400 trains the neural network model using active learning. In some embodiments, this involves training and validating the neural network model using new dynamically generated sub-images from the same underlying WSIs from which sub-images were generated for one or more other training acts (e.g., 406-1, 406-2, and 406-3).

In some embodiments, training the neural network using the sub-images may include processing a sub-image using the neural network to determine the probability that a particular sub-image includes a TLS. In some embodiments, if the probability satisfies a particular criterion (e.g., the probability exceeds a threshold probability), then the sub-image is identified as including a TLS. For example, if the probability exceeds a threshold of at least 0.3, at least 0.4, at least 0.5, at least 0.6, at least 0.7, at least 0.8, between 0.3 and 0.9, or any other suitable threshold, then the sub-image may be identified as including a TLS.

In some embodiments, features from the encoder sub-model are obtained for sub-images identified as including at least one TLS and for a subset of sub-images randomly sampled from among the sub-images that do not contain TLSs or tissue. For example, the subset of sub-images randomly sampled from among the sub-images that do not contain TLSs or tissues may include at least 10 sub-images, at least 15 sub-images, at least 20 sub-images, at least 25 sub-images, at least 30 sub-images, at least 35 sub-images, at least 40 sub-images, at least 50 sub-images, between 5 and 100 sub-images, between 20 and 60 sub-images, or any other suitable number of sub-images.

In some embodiments, segmentation uncertainty scores may also be obtained for the sub-images identified as including at least one TLS and for the subset of sub-images randomly sampled from among the sub-images that do not contain TLSs or tissue. For example, in some embodiments, a segmentation uncertainty score (e.g., an entropy score) may be obtained using the semantic segmentation scorer (lightly.active_learning.scorers.semantic_segmentation) using an open-source version of the Lightly Platform.

In some embodiments, the features obtained from the encoder are clustered using any suitable clustering techniques. As an example, the features may be clustered using k-means clustering, agglomerative clustering, spectral clustering, or any other suitable type of clustering algorithm, as aspects of the technology described herein are not limited in this respect. In some embodiments, the features are clustered into any suitable number of clusters. For example, the features may be clustered into at least 5 clusters, at least 7 clusters, at least 8 clusters, at least 9 clusters, at least 10 clusters, at least 11 clusters, at least 12 clusters, at least 14 clusters, at least 15 clusters, between 5 and 25 clusters, between 8 and 12 clusters, or any other suitable number of clusters as aspects of the technology described herein are not limited in this respect.

In some embodiments, one or more of the generated clusters of features may be excluded from further processing. In some embodiments, the clusters to be excluded are identified by comparing the number of data points in a cluster to a threshold. In some embodiments, if the number of features does not equal or exceed the threshold, then the cluster is excluded from further processing. For example, the threshold may include at least 20 data points, at least 40 data points, at least 50 data points, at least 60 data points, at least 70 data points, at least 80 data points, at least 90 data points, at least 100 data points, at least 110 data points, at least 120 data points, at least 150 data points, at least 200 data points, at least 250 data points, between 10 and 500 data points, between 25 and 200 data points, or any other suitable number of data points as aspects of the technology described herein are not limited in this respect.

In some embodiments, for each remaining cluster (e.g., each cluster that is not excluded), a set of sub-images is obtained. For example, at least between 5 and 80 sub-images may be obtained for each cluster. In some embodiments, at least some of the sub-images (e.g., 2, 5, 10, 20, etc.) are obtained by identifying coreset data points. For example, coreset datapoints may be identified using the query strategy described by Tang, Y.-P., et. al. (“ALiPy: Active learning in python.” Technical report, Nanjing University of Aeronautics and Astronautics. 2019), which is incorporated by reference herein in its entirety. In some embodiments, at least some of the sub-images (e.g., 2, 5, 10, 20, etc.) are obtained by identifying the sub-images associated with the most uncertain TLS predictions as determined based on the entropy scores. In some embodiments, at least some of the sub-images (e.g., 2, 5, 10, 20, etc.) are obtained by identifying the sub-images associated with the most uncertain background (e.g., not including tissue or TLS) prediction, as determined based on the entropy scores. In some embodiments, at least some of the sub-images (e.g., 2, 5, 10, 20, etc.) are obtained by randomly sampling the sub-images including TLS. In some embodiments, at least some of the sub-images (e.g., 2, 5, 10, 20, etc.) are obtained by randomly sampling the sub-images that do not include TLS nor tissue (e.g., background).

In some embodiments, the set of sub-images are then annotated by one or more annotators. For example, the annotation may be performed manually or semi-automatically by one or more annotators. In some embodiments, the annotators may annotate regions of the sub-images corresponding to TLSs, regions of the sub-images corresponding to background, and/or regions of the sub-images corresponding to tissue.

In some embodiments, the annotated sub-images are combined with the other sub-images used for training and validating the neural network model at act 406-4.

In some embodiments, training the neural network model at act 406-3 includes training the neural network model using any suitable optimization algorithm, for example, by using the Adam optimizer.

In some embodiments, one or more initial parameters are selected for training the neural network model. In some embodiments, initial parameters may be selected for an encoder sub-model (e.g., encoder sub-model 310 in FIG. 3A), a decoder sub-model (e.g., decoder sub-model 320 in FIG. 3A), and an auxiliary classifier sub-model (e.g., auxiliary classifier sub-model 330 in FIG. 3A). For example, an initial learning rate may be selected for each of the sub-models. As an example, the initial learning rate for the encoder sub-model may be set to 2×10⁻⁴, and the initial learning rates for the decoder sub-model and the auxiliary classifier may each be set to 2×10⁻³. However, it should be appreciated that the initial learning rates may selected to be any suitable initial learning rates as aspects of the technology are not limited in this respect.

In some embodiments, the learning rate of a particular portion of the neural network is set after one or more epochs. For example, training the neural network model at act 406-3 may include freezing the encoder sub-model during one or more epochs, then setting the learning rate for the encoder sub-model to a different value. As an example, the encoder sub-model may be frozen during the first six epochs. After the sixth epoch, one or more layers of the encoder sub-model may be unfrozen. For example, with reference to encoder sub-model 310 in FIG. 3A, resolution fusion portion 309 may be unfrozen after the sixth epoch. In some embodiments, the other layers of the encoder sub-model may be unfrozen after a later epoch such as, for example, the eleventh epoch. In some embodiments, after the third epoch, the learning rate of the decoder sub-model is set of 1×10⁻⁴, and the learning rate of the auxiliary classifier sub-model is set to 5×10⁻⁵. In some embodiments, after the sixth epoch, the learning rate of the decoder sub-model is set of 5×10⁻⁵, and the learning rate of the auxiliary classifier sub-model is set to 1×10⁻⁵. In some embodiments, after the eleventh epoch, the learning rate of the decoder sub-model is set of 1×10⁻⁵, and the learning rate of the auxiliary classifier sub-model is set to 1×10⁻⁴, and the learning rate of the encoder sub-model is set to 5×10⁻⁵. In some embodiments, after the sixteenth epoch, the learning rates of the encoder sub-model, the decoder sub-model, and the auxiliary classifier sub-model are each set to 1×10⁻⁵. In some embodiments, after the thirty-first epoch, the learning rates of the encoder sub-model, the decoder sub-model, and the auxiliary classifier sub-model are each set to 1×10⁻⁷.

In some embodiments, weight decay is another parameter that may be initially selected for training the neural network model. As nonlimiting example, the weight decay for the encoder sub-model may be set to 2×10⁻⁴, the weight decay for the decoder sub-model may be set to 1×10-5, and the weight decay for the auxiliary classifier sub-model may be set to be 2×10⁻⁴. However, any other suitable values for weight decay may be selected, as aspects of the technology described herein are not limited in this respect.

In some embodiments, one or more other parameters may be selected for training the neural network such as, for example, the parameters 1, 02, ε, and α. In some embodiments, such parameters may be set to any suitable values including, for example, the default settings suggested by Kingma, D. and Jimmy, B. (“Adam: A method for stochastic optimization.” arXiv preprint arXiv:1412.6980 (2014)).

In some embodiments, training the neural network model at act 406-4 includes minimizing a loss function. In some embodiments, the loss function includes any suitable loss function. For example, the loss function may include the same loss function as described herein with respect to act 406-3.

### Example

This example describes use of the machine learning techniques described herein as part of a digital image analysis (DIA) system to identify tertiary lymphoid structures (TLS) in samples obtained from lung adenocarcinoma (LUAD) patients. Aspects of this example are described below including in the sub-sections titled “Datasets”, “Datasets Preprocessing and Sampling” and “Test Dataset Prediction and Evaluation”.

TLS were assessed by three pathologists on whole slide images (WSI) in a validation cohort of 22 LUAD samples using current TLS characterization criteria of dense lymphoid structures, the presence/absence of a germinal center, and high endothelial venules (HEVs). The intraclass correlation coefficient (ICC) was used to measure reproducibility between pathologists. A neural network model for automated TLS detection was trained using the techniques described herein, including, for example, the techniques described with reference to FIGS. 4A-4D. Quantitative measurements of area, lymphocyte number, and density of each TLS were obtained. A prospective cohort of eight samples was used to compare pathologist and DIA identification of TLS. Normalized numbers of TLS in the tumor area were used for cohort stratification for overall survival (OS) analysis using the Kaplan-Meier method in an independent clinical cohort of 104 TCGA-LUAD patients.

A panel of three pathologists identified 326 unique TLS from 22 samples. Between-pathologist detection of TLS, independent of germinal center or HEV criteria, resulted in good reproducibility with an ICC of 0.77.

Representative data for prospective cohort nuclear counts per TLS, nuclear density per TLS, and TLS area are shown in FIGS. 6A-6C, respectively. The DIA system exhibited excellent reproducibility with an ICC of 0.94 when compared to validated prospective cohort annotation (FIGS. 6D-6E). In total, 155 and 189 TLS were identified by pathologists and the machine-learning DIA system, respectively. The DIA system demonstrated markedly improved sensitivity of 0.91 for TLS identification. Furthermore, OS analysis revealed that a TLS density greater than 0.94 TLS per mm² of tumor assessed by DIA is a statistically significant independent biomarker of better OS in the LUAD cohort from TCGA.

These results indicate the machine-learning DIA system detects TLS in LUAD, with improved reproducibility and sensitivity relative conventional methods. Additionally, the DIA system showed that a TLS density greater than 0.94 TLS per mm² of tumor is a positive prognostic marker for OS in LUAD.

### Datasets

FIG. 4C is a schematic showing an example separation of data for training and testing the neural network model, according to some embodiments of the technology described herein.

The dataset used in this Example consists of 2 parts: a Training & Validation Dataset, and a Testing Dataset (comprising a Prospective Cohort, External Cohort, and Combined Validation Cohort). The data is hematoxylin and eosin (H&E) whole slide images (WSIs) from TCGA-LUAD, a lung adenocarcinoma dataset. Scale 2 (zoom×10; 1 um/px mpp) was used for all of the stages. The Training Dataset consisted of 36 WSIs. TLS annotations from a single annotator were used as ground truth (GT) because of the higher quality metrics on holdout test datasets compared to heterogeneous annotations (annotations by several pathologists). The Validation Dataset consisted of 5 WSIs from single annotator (the same annotator as in Training Dataset).

For the Testing/Evaluation Dataset, the Prospective Cohort Data consisted of 10 WSIs with collegial decision-making annotations of two pathologists (one of which was the same annotator as for the Training Dataset). For the External Cohort Dataset, there were 69 images with an average resolution of 1500×1500 px, jpg encoded (some artifacts did occur) of 10× zoom TLS-reach areas. For the Combined Validation Cohort, there were 22WSIs, partially overlapping with the Training Cohort; three pathologists' annotations were combined in a Boolean—or manner to obtain the ground truth mask.

### Data Preprocessing and Sampling

FIG. 4D is a schematic depicting an example data pre-processing and sampling strategy for training a neural network model, according to some embodiments of the technology described herein. The input format was a 512×512 RGB (or BGR for several slides) image with [−1,1] bound pixel-values.

In this example, to address the issue of unbalanced datasets (e.g., negative class inflated data) a custom sampling technique was performed during training and validation (e.g., for choosing the best model from different epochs of one experiment). Each batch was formed of three different groups: TLS present in the patch; TLS absent but there is tissue; and background. The ratio of group sizes is 5:2:1 respectively. Each batch was generated by several crops of the same WSI under constraints discussed below. From one WSI, three batches in training and five batches in validation formed a row. An Epoch ended with the last non-visited WSI handed to the sampler. Sampling from the same WSI in a row was performed in order to reduce gradient vector noise due to batch-effects between WSIs staining, tissue pattern, and annotations.

Each patch for a batch was obtained by random sampling from WSI. First, a tissue mask was generated by staintools, then the tissue mask was reduced to the intersection with Whole slide annotation if the latter was provided (e.g., when there are two or more tissue pieces in the sample only one of them is annotated). After that, for each GT, polygon centroid and radius were collected. Radii were calculated as sqrt of polygon area. Then, sampling began as described in the numbered list of FIG. 4D.

There was stall-prevention and because of it, epoch-wise proportion between different groups in batches may insignificantly vary. Preprocessing on all stages consisted of padding with zeros if needed and subsequent standardization by ImageNet statistics (MEAN=(0.485, 0.456, 0.406), STD=(0.229, 0.224, 0.225)).

### Test Dataset Prediction and Evaluation

In the above described example, the value for predicted mask thresholding was chosen by PR-curve F-score maximizing and slightly changed after visual analysis on several slides from the validation dataset.

Prediction was performed in a sliding window fashion with 200px steps. Predictions for pixels in Intersected regions were averaged. The final result of the prediction is a binary mask, thresholded by the estimated value.

For evaluation predicted segments in the binary mask were converted to individual TLS contours and predictions with area lesser than 5e3 px were filtered out.

F1 score pixel-wise, IoU pixel-wise, mAP[0.5:0.95], object-wise (Precision. Recall, F1) were collected during evaluation on test dataset on whole slide image (or image in case of External Cohort). Best model between experiments was chosen with regard to these metrics.

Pixelwise smoothed F1 and IoU were calculated during training and validation on batches, described above. Best models within the same experiment were selected basing on them (primarily IoU)

After evaluation nuclear quantity per TLS, TLS area, nuclear density in TLS were calculated.

### Performance

The machine learning TLS identification techniques described herein showed improved performance over those described by Barmpoutis, P., et al., (“Tertiary Lymphoid Structures (TLS) Identification and Density Assessment on H&E-Stained Digital Slides of Lung Cancer.” PloS One 16, no. 9 (2021): e0256907), which is incorporated by reference herein in its entirety.

The data used to evaluate the model described by Barmpoutis, P., et. al. was also used to evaluate a neural network model trained according to the techniques described herein. Segmentation was assessed using AUROC. With an AUROC of 0.975, the neural network having the architecture described in FIGS. 3A-3J and trained according to the techniques described herein, including with reference to FIGS. 4A-4B, showed improved performance over the machine learning techniques described by Barmpoutis, P., et. al., which reported an AUROC of 0.959.

AUROC reflects the ability to correctly rank objects' probability of belonging to the target class. Aspects of the neural network model training techniques described herein such as, for example, the sampling techniques, label smoothing, and use of the auxiliary classifier sub-model, result in a neural network that is more stable, accurate, and generalizable.

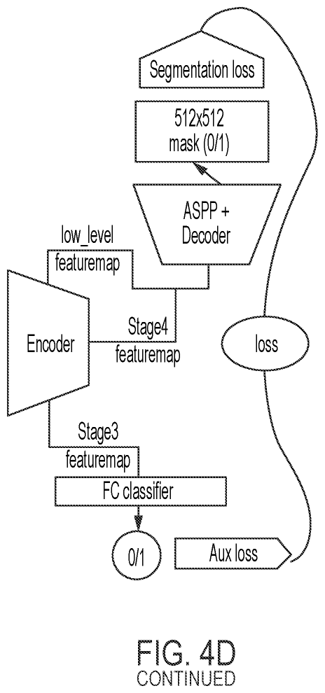

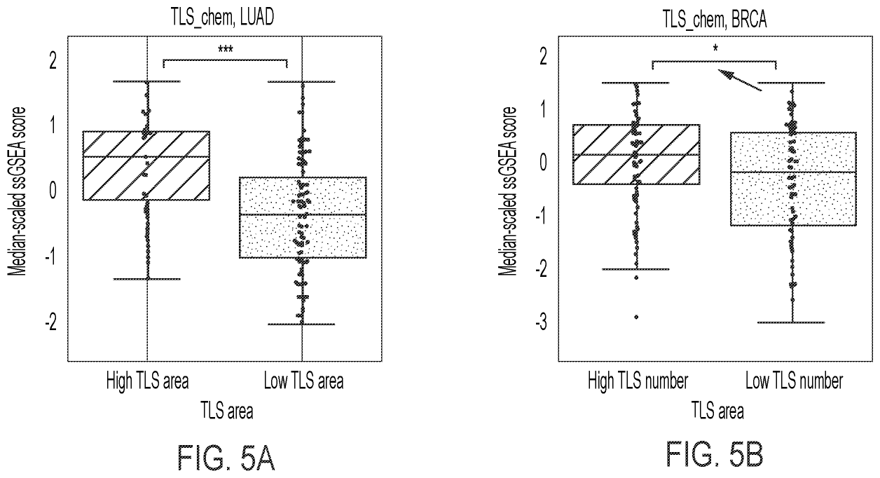

FIGS. 5A-5B show that the TLS prediction results obtained using embodiments of the machine learning techniques described herein correlate with TLS-defining gene signatures.

TLS Chem Signature—A 12-chemokine signature (CCL2, −3, −4, −5, −8, −18, −19, −21, CXCL9, −10, −11, −13) was reported as a predictor of TLS expression by Coppola, D., et. al. (“Unique ectopic lymph node-like structures present in human primary colorectal carcinoma are identified by immune gene array profiling.” Am J Pathol 2011; 179:37-45), Messina, J., et. al. (“12-chemokine gene signature identifies lymph node-like structures in melanoma: potential for patient selection for immunotherapy?” Sci Rep 2012; 2:765), and Finkin, S., et. al. (“Ectopic lymphoid structures function as microniches for tumor progenitor cells in hepatocellular carcinoma.” Nat Immunol 2015; 16:1235-44), each of which is incorporated by reference in its entirety.

All signature scores were obtained with single-sample Gene Set Enrichment Analysis (ssGSEA). After the score is calculated, it is median-scaled (median-centered). Aspects of single sample GSEA (ssGSEA) are described in Barbie et al. Nature. 2009 Nov. 5; 462(7269): 108-112, the entire contents of which are incorporated by reference herein.

TLS areas (i.e., sums of determined areas occupied by TLSs on slides) were divided by tumor areas (i.e. determined areas occupied by tumor tissue on slides) and by tissue areas (i.e. determined areas occupied by tissue on slides) to obtain normalized ratios of TLSs per tumor and TLSs per tissue. TLS high and TLS low zones were identified by 0.75 quantile. High TLS areas showed significant enrichment of TLS gene sets according to ssGSEA score.

The correlation between the TLS features and the ssGSEA score confirms that the neural network techniques described herein can be used to accurately and reproducibly identify TLSs in an image.

### Applications

In some embodiments, the neural network techniques may be used to identify features of at least one TLS in an image of tissue obtained from a subject having, suspected of having, or at risk of having cancer. In some embodiments, the identified features may serve as a biomarker for predicting therapeutic response, estimating patient survival, and/or informing a diagnosis.

For example, TLS density (e.g., number of TLS in a portion of an image normalized by the area of a portion of the image) may serve as a biomarker for predicting a subject's response to immunotherapy. In particular, a relatively high TLS density is associated with a greater likelihood of response to immunotherapy in breast of lung cancer patients. For example, the immunotherapy may include immune checkpoint inhibitors (anti-PD-(L)1 agent) such as Pembrolizumab, Nivolumab, Atezolizumab, Durvalumab, or any other suitable immune checkpoint inhibitor.

For example, patients with >0.01 TLS/mm² were reported to have a significantly higher objective response rate (32% vs 22%, p=0.03) for first or subsequent line of anti-PD-(L)1 single agent, a significantly longer median progression-free survival (PFS, 4.8 vs 2.7 months, HR: 0.73, 95% CI: 0.59-0.90, p=0.004), and a significantly improved median overall survival (OS, 16.5 vs 12.5 months, HR: 0.72, 95% CI: 0.57-0.92, p=0.008), as reported by Rakaee, M., et. al. (“Artificial intelligence in digital pathology approach identifies the predictive impact of tertiary lymphoid structures with immune-checkpoints therapy in NSCLC.” (2022): 9065-9065), which is incorporated by reference herein in its entirety.

As another example, patients with >2 TLS/mm² were reported to have a better response and overall survival on immunotherapy, as reported by Petitprez, F., et. al. (B cells are associated with survival and immunotherapy response in sarcoma. Nature, 577(7791), 556-560), which is incorporated by reference herein in its entirety.

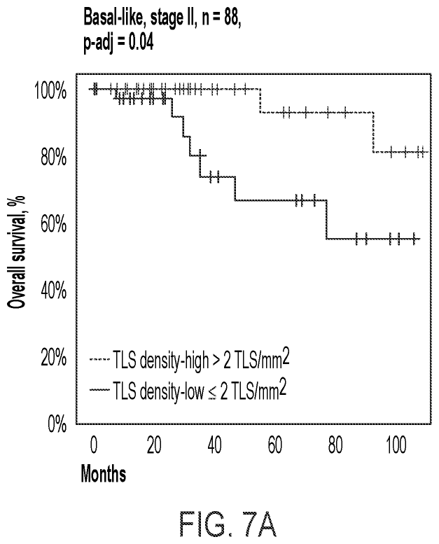

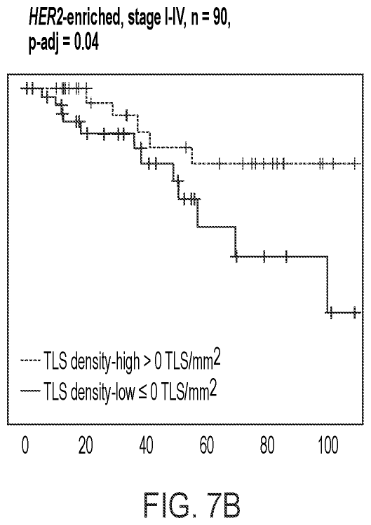

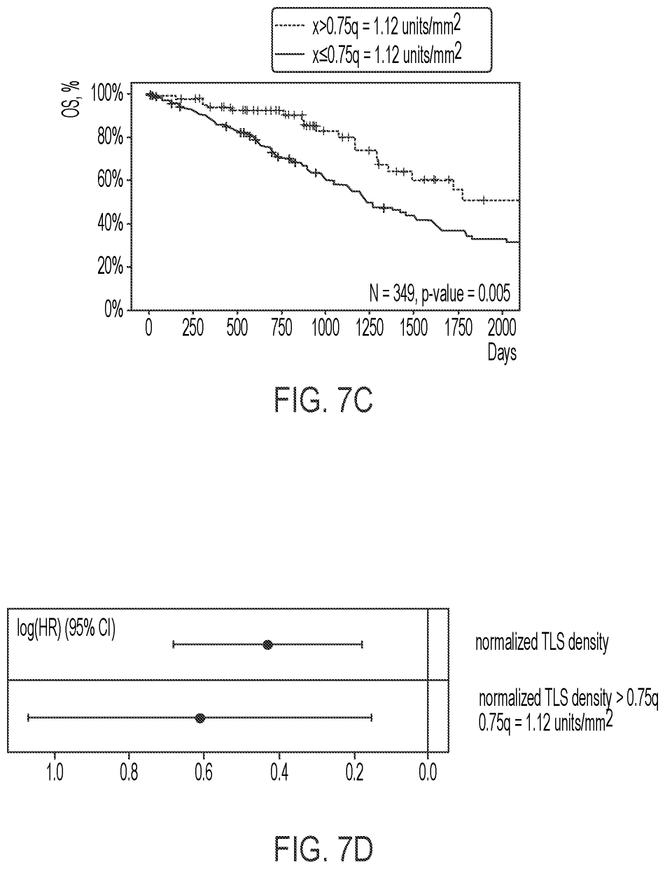

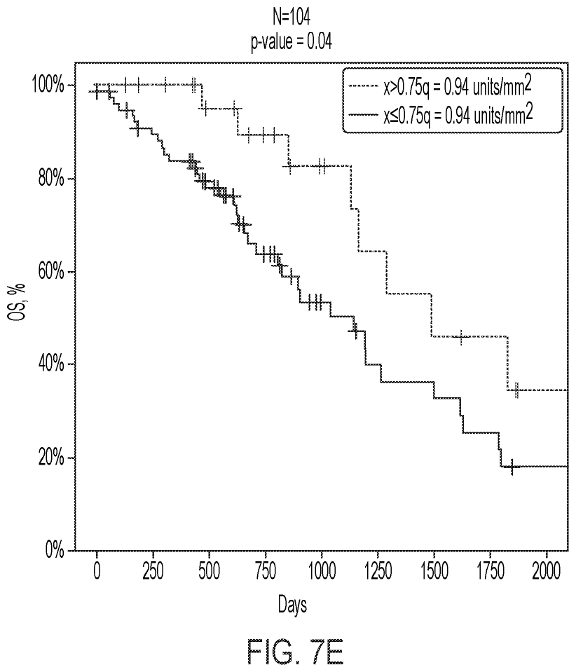

FIGS. 7A-7E shows representative data for overall survival (OS) analysis.

FIG. 7A shows that patients having basal-like breast cancer have improved overall survival when their TLS density exceeds 2 TLS/mm².

FIG. 7B shows that patients having HER2-enriched breast cancer have improved overall survival when their TLS density exceeds 0 TLS/mm².

FIGS. 7C-7D show that a TLS density greater than 1.22 TLS per mm² of tissue is a statistically significant independent biomarker of better overall survival for patients with lung adenocarcinoma.

FIG. 7E shows that patients with lung adenocarcinoma have improved overall survival when their TLS density exceeds 0.94 TLS/mm².

Accordingly, in some embodiments, the techniques described herein may be used to identify a feature of at least one TLS in an image of tissue such as for example, the TLS density. The determined feature may be used to predict therapeutic response, estimate overall survival, inform a diagnosis, and/or form the basis for a treatment recommendation (e.g., for an immunotherapy).

### Computer Implementation

An illustrative implementation of a computer system 800 that may be used in connection with any of the embodiments of the technology described herein (e.g., such as the method of FIGS. 2A-2B and 4A-4B) is shown in FIG. 8. The computer system 800 includes one or more processors 810 and one or more articles of manufacture that comprise non-transitory computer-readable storage media (e.g., memory 820 and one or more non-volatile storage media 830). The processor 810 may control writing data to and reading data from the memory 820 and the non-volatile storage device 830 in any suitable manner, as the aspects of the technology described herein are not limited to any particular techniques for writing or reading data. To perform any of the functionality described herein, the processor 810 may execute one or more processor-executable instructions stored in one or more non-transitory computer-readable storage media (e.g., the memory 820), which may serve as non-transitory computer-readable storage media storing processor-executable instructions for execution by the processor 810.

Computing device 800 may also include a network input/output (I/O) interface 840 via which the computing device may communicate with other computing devices (e.g., over a network), and may also include one or more user I/O interfaces 850, via which the computing device may provide output to and receive input from a user. The user I/O interfaces may include devices such as a keyboard, a mouse, a microphone, a display device (e.g., a monitor or touch screen), speakers, a camera, and/or various other types of I/O devices.

The above-described embodiments can be implemented in any of numerous ways. For example, the embodiments may be implemented using hardware, software, or a combination thereof. When implemented in software, the software code can be executed on any suitable processor (e.g., a microprocessor) or collection of processors, whether provided in a single computing device or distributed among multiple computing devices. It should be appreciated that any component or collection of components that perform the functions described above can be generically considered as one or more controllers that control the above-described functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of the embodiments described herein comprises at least one computer-readable storage medium (e.g., RAM, ROM, EEPROM, flash memory or other memory technology, CD-ROM, digital versatile disks (DVD) or other optical disk storage, magnetic cassettes, magnetic tape, magnetic disk storage or other magnetic storage devices, or other tangible, non-transitory computer-readable storage medium) encoded with a computer program (i.e., a plurality of executable instructions) that, when executed on one or more processors, performs the above-described functions of one or more embodiments. The computer-readable medium may be transportable such that the program stored thereon can be loaded onto any computing device to implement aspects of the techniques described herein. In addition, it should be appreciated that the reference to a computer program which, when executed, performs any of the above-described functions, is not limited to an application program running on a host computer. Rather, the terms computer program and software are used herein in a generic sense to reference any type of computer code (e.g., application software, firmware, microcode, or any other form of computer instruction) that can be employed to program one or more processors to implement aspects of the techniques described herein.

The foregoing description of implementations provides illustration and description but is not intended to be exhaustive or to limit the implementations to the precise form disclosed. Modifications and variations are possible in light of the above teachings or may be acquired from practice of the implementations. In other implementations the methods depicted in these figures may include fewer operations, different operations, differently ordered operations, and/or additional operations. Further, non-dependent blocks may be performed in parallel.

It will be apparent that example aspects, as described above, may be implemented in many different forms of software, firmware, and hardware in the implementations illustrated in the figures. Further, certain portions of the implementations may be implemented as a “module” that performs one or more functions. This module may include hardware, such as a processor, an application-specific integrated circuit (ASIC), or a field-programmable gate array (FPGA), or a combination of hardware and software.

### Biological Samples

Any of the methods, systems, or other claimed elements may use or be used to analyze a biological sample from a subject. In some embodiments, a biological sample is obtained from a subject having, suspected of having cancer, or at risk of having cancer. In some embodiments, the biological sample is a sample of a tumor from a subject. In some embodiments, the biological sample is a sample of tissue from a subject.

A sample of a tumor, in some embodiments, refers to a sample comprising cells from a tumor. In some embodiments, the sample of the tumor comprises cells from a benign tumor, e.g., non-cancerous cells. In some embodiments, the sample of the tumor comprises cells from a premalignant tumor, e.g., precancerous cells. In some embodiments, the sample of the tumor comprises cells from a malignant tumor, e.g., cancerous cells. Examples of tumors include, but are not limited to, adenomas, fibromas, hemangiomas, lipomas, cervical dysplasia, metaplasia of the lung, leukoplakia, carcinoma, sarcoma, germ cell tumors, and blastoma.

A sample of a tissue, in some embodiments, refers to a sample comprising cells from a tissue. In some embodiments, the sample of the tumor comprises non-cancerous cells from a tissue. In some embodiments, the sample of the tumor comprises precancerous cells from a tissue.

Methods of the present disclosure encompass a variety of tissue including organ tissue or non-organ tissue, including but not limited to, muscle tissue, brain tissue, lung tissue, liver tissue, epithelial tissue, connective tissue, and nervous tissue. In some embodiments, the tissue may be normal tissue, or it may be diseased tissue, or it may be tissue suspected of being diseased. In some embodiments, the tissue may be sectioned tissue or whole intact tissue. In some embodiments, the tissue may be animal tissue or human tissue. Animal tissue includes, but is not limited to, tissues obtained from rodents (e.g., rats or mice), primates (e.g., monkeys), dogs, cats, and farm animals.

The biological sample may be from any source in the subject's body including, but not limited to, skin (including portions of the epidermis, dermis, and/or hypodermis), oropharynx, laryngopharynx, esophagus, stomach, bronchus, salivary gland, tongue, oral cavity, nasal cavity, vaginal cavity, anal cavity, bone, bone marrow, brain, thymus, spleen, small intestine, appendix, colon, rectum, anus, liver, lung, lung, biliary tract, pancreas, kidney, ureter, bladder, urethra, uterus, vagina, vulva, ovary, cervix, scrotum, penis, prostate, testicle, seminal vesicles, and/or any type of tissue (e.g., muscle tissue, adipose tissue, epithelial tissue, connective tissue, or nervous tissue).

Any of the biological samples described herein may be obtained from the subject using any known technique. See, for example, the following publications on collecting, processing, and storing biological samples, each of which are incorporated by reference herein in its entirety: Biospecimens and biorepositories: from afterthought to science by Vaught et al. (Cancer Epidemiol Biomarkers Prev. 2012 February; 21(2):253-5), and Biological sample collection, processing, storage and information management by Vaught and Henderson (IARC Sci Publ. 2011; (163):23-42).

In some embodiments, the biological sample may be obtained from a surgical procedure (e.g., laparoscopic surgery, microscopically controlled surgery, or endoscopy), bone marrow biopsy, punch biopsy, endoscopic biopsy, or needle biopsy (e.g., a fine-needle aspiration, core needle biopsy, vacuum-assisted biopsy, or image-guided biopsy).

In some embodiments, one or more than one cell (i.e., a cell biological sample) may be obtained from a subject using a scrape or brush method. The cell biological sample may be obtained from any area in or from the body of a subject including, for example, from one or more of the following areas: the cervix, esophagus, stomach, bronchus, or oral cavity. In some embodiments, one or more than one piece of tissue (e.g., a tissue biopsy) from a subject may be used. In certain embodiments, the tissue biopsy may comprise one or more than one (e.g., 2, 3, 4, 5, 6, 7, 8, 9, 10, or more than 10) biological samples from one or more tumors or tissues known or suspected of having cancerous cells.

Any of the biological samples from a subject described herein may be stored using any method that preserves stability of the biological sample. In some embodiments, preserving the stability of the biological sample means inhibiting components (e.g., DNA, RNA, protein, or tissue structure or morphology) of the biological sample from degrading until they are measured so that when measured, the measurements represent the state of the sample at the time of obtaining it from the subject. In some embodiments, a biological sample is stored in a composition that is able to penetrate the same and protect components (e.g., DNA, RNA, protein, or tissue structure or morphology) of the biological sample from degrading. As used herein, degradation is the transformation of a component from one from to another such that the first form is no longer detected at the same level as before degradation.

In some embodiments, a biological sample (e.g., tissue sample) is fixed. As used herein, a “fixed” sample relates to a sample that has been treated with one or more agents or processes in order to prevent or reduce decay or degradation, such as autolysis or putrefaction, of the sample. Examples of fixative processes include but are not limited to heat fixation, immersion fixation, and perfusion. In some embodiments a fixed sample is treated with one or more fixative agents. Examples of fixative agents include but are not limited to cross-linking agents (e.g., aldehydes, such as formaldehyde, formalin, glutaraldehyde, etc.), precipitating agents (e.g., alcohols, such as ethanol, methanol, acetone, xylene, etc.), mercurials (e.g., B-5, Zenker's fixative, etc.), picrates, and Hepes-glutamic acid buffer-mediated organic solvent protection effect (HOPE) fixatuve. In some embodiments, a biological sample (e.g., tissue sample) is treated with a cross-linking agent. In some embodiments, the cross-linking agent comprises formalin. In some embodiments, a formalin-fixed biological sample is embedded in a solid substrate, for example paraffin wax. In some embodiments, the biological sample is a formalin-fixed paraffin-embedded (FFPE) sample. Methods of preparing FFPE samples are known, for example as described by Li et al. JCO Precis Oncol. 2018; 2: PO.17.00091.

Non-limiting examples of preservants include formalin solutions, formaldehyde solutions, RNALater or other equivalent solutions, TriZol or other equivalent solutions, DNA/RNA Shield or equivalent solutions, EDTA (e.g., Buffer AE (10 mM Tris·Cl; 0.5 mM EDTA, pH 9.0)) and other coagulants, and Acids Citrate Dextronse (e.g., for blood specimens). In some embodiments, special containers may be used for collecting and/or storing a biological sample. For example, a vacutainer may be used to store blood. In some embodiments, a vacutainer may comprise a preservant (e.g., a coagulant, or an anticoagulant). In some embodiments, a container in which a biological sample is preserved may be contained in a secondary container, for the purpose of better preservation, or for the purpose of avoid contamination.

Any of the biological samples from a subject described herein may be stored under any condition that preserves stability of the biological sample. In some embodiments, the biological sample is stored at a temperature that preserves stability of the biological sample. In some embodiments, the sample is stored at room temperature (e.g., 25° C.). In some embodiments, the sample is stored under refrigeration (e.g., 4° C.). In some embodiments, the sample is stored under freezing conditions (e.g., −20° C.). In some embodiments, the sample is stored under ultralow temperature conditions (e.g., −50° C. to −800° C.). In some embodiments, the sample is stored under liquid nitrogen (e.g., −1700° C.). In some embodiments, a biological sample is stored at −60° C. to −80° C. (e.g., −70° C.) for up to 5 years (e.g., up to 1 month, up to 2 months, up to 3 months, up to 4 months, up to 5 months, up to 6 months, up to 7 months, up to 8 months, up to 9 months, up to 10 months, up to 11 months, up to 1 year, up to 2 years, up to 3 years, up to 4 years, or up to 5 years). In some embodiments, a biological sample is stored as described by any of the methods described herein for up to 20 years (e.g., up to 5 years, up to 10 years, up to 15 years, or up to 20 years).

In some embodiments, obtaining the biological sample may include: (1) collecting tissue from a subject; (2) fixing the tissue (e.g., using FFPE preparation); (3) placing portions of the fixed tissue on one or more slides and staining the tissue; and (4) imaging the slides to produce one or more images of the tissue (e.g., whole slide images).

In some embodiments, the tissue may be collected using any suitable method such as a biopsy (e.g., excisional biopsy) or surgical resection. For example, the tissue may be obtained by skin excision with melanoma, breast tissue excision with carcinoma, liver tissue excision with carcinoma, muscles tissue excision with leiomyosarcoma. The type of biopsy and the location of the tissue being biopsied or resected may be determined by the type of tumor, tumor localization and tumor stage.

In some embodiments, after the tissue sample has been collected, the tissue sample may be fixed in formalin to preserve its structure, for example, using formalin-fixed paraffin-embedded (FFPE) tissue preparation techniques described herein. In some embodiments, the tissue may be dehydrated and then embedded in paraffin wax and cut into thin sections (e.g., 4-5 micrometers) using a microtome.

In some embodiments, the thin tissue sections may be placed on slides and stained with hematoxylin and eosin (H&E) stain. The H&E stain allows for the visualization of different tissue components such as nuclei, cytoplasm, and extracellular matrix. The H&E stain may be applied in stages. The tissue sections may be stained with hematoxylin, which binds to the basic structures in the tissue, such as the nuclei, and turns them blue. The tissue sections may then be washed and stained with eosin, which binds to acidic structures, such as the cytoplasm, and turns them pink.

In some embodiments, the H&E stained tissue sections on the slides may be imaged using a slide scanner. A slide scanner may be any suitable high-resolution digital microscope that captures high-quality images of the tissue sections. The images so obtained may then be analyzed including by using the neural network techniques described herein to identify tertiary lymphoid structures and obtain information about any such identified structures.

### Subjects

Aspects of this disclosure relate to a biological sample that has been obtained from a subject. In some embodiments, a subject is a mammal (e.g., a human, a mouse, a cat, a dog, a horse, a hamster, a cow, a pig, or other domesticated animal). In some embodiments, a subject is a human. In some embodiments, a subject is an adult human (e.g., of 18 years of age or older). In some embodiments, a subject is a child (e.g., less than 18 years of age). In some embodiments, a human subject is one who has or has been diagnosed with at least one form of cancer.

In some embodiments, a cancer from which a subject suffers is a carcinoma (e.g., squamous cell carcinoma, basal cell carcinoma, adenocarcinoma, transitional cell carcinoma, etc., of different localizations such as cervix, lung, head & neck, skin, stomach, intestine, colon, rectum, liver, pancreas), a sarcoma, or a myeloma. Carcinoma refers to a malignant neoplasm of epithelial origin or cancer of the internal or external lining of the body. Sarcoma refers to cancer that originates in supportive and connective tissues such as bones, tendons, cartilage, muscle, and fat. Myeloma is cancer that originates in the plasma cells of bone marrow.

In some embodiments, a subject is at risk for developing cancer, e.g., because the subject has one or more genetic risk factors, or has been exposed to or is being exposed to one or more carcinogens (e.g., cigarette smoke, or chewing tobacco).

### Methods of Treatment

In certain methods described herein, an effective amount of anti-cancer therapy described herein may be administered or recommended for administration to a subject (e.g., a human) in need of the treatment via a suitable route (e.g., intravenous administration).

The subject to be treated by the methods described herein may be a human patient having, suspected of having, or at risk for a cancer. Examples of a cancer are provided herein. At the time of diagnosis, the cancer may be cancer of unknown primary. The subject to be treated by the methods described herein may be a mammal (e.g., may be a human).

A subject having a cancer may be identified by routine medical examination, e.g., laboratory tests, biopsy, PET scans, CT scans, or ultrasounds. A subject suspected of having a cancer might show one or more symptoms of the disorder, e.g., unexplained weight loss, fever, fatigue, cough, pain, skin changes, unusual bleeding or discharge, and/or thickening or lumps in parts of the body. A subject at risk for a cancer may be a subject having one or more of the risk factors for that disorder. For example, risk factors associated with cancer include, but are not limited to, (a) viral infection (e.g., herpes virus infection), (b) age, (c) family history, (d) heavy alcohol consumption, (e) obesity, and (f) tobacco use.

The dosage of anti-cancer therapy administered to a subject may vary, as recognized by those skilled in the art, depending on the particular condition being treated, the severity of the condition, the individual patient parameters including age, physical condition, size, gender and weight, the duration of the treatment, the nature of concurrent therapy (if any), the specific route of administration and like factors within the knowledge and expertise of the health practitioner.

Empirical considerations, such as the half-life of a therapeutic compound, generally contribute to the determination of the dosage. For example, antibodies that are compatible with the human immune system, such as humanized antibodies or fully human antibodies, may be used to prolong half-life of the antibody and to prevent the antibody being attacked by the host's immune system. Frequency of administration may be determined and adjusted over the course of therapy and is generally (but not necessarily) based on treatment, and/or suppression, and/or amelioration, and/or delay of a cancer. Alternatively, sustained continuous release formulations of an anti-cancer therapeutic agent may be appropriate. Various formulations and devices for achieving sustained release are known in the art.

In some embodiments, dosages for an anti-cancer therapeutic agent as described herein may be determined empirically in individuals who have been administered one or more doses of the anti-cancer therapeutic agent. Individuals may be administered incremental dosages of the anti-cancer therapeutic agent. To assess efficacy of an administered anti-cancer therapeutic agent, one or more aspects of a cancer (e.g., tumor formation, tumor growth, molecular category identified for the cancer using the techniques described herein) may be analyzed.

For the purpose of the present disclosure, the appropriate dosage of an anti-cancer therapeutic agent will depend on the specific anti-cancer therapeutic agent(s) (or compositions thereof) employed, the type and severity of cancer, whether the anti-cancer therapeutic agent is administered for preventive or therapeutic purposes, previous therapy, the patient's clinical history and response to the anti-cancer therapeutic agent, and the discretion of the attending physician. Typically, the clinician will administer an anti-cancer therapeutic agent, such as an antibody, until a dosage is reached that achieves the desired result.

Administration of an anti-cancer therapeutic agent can be continuous or intermittent, depending, for example, upon the recipient's physiological condition, whether the purpose of the administration is therapeutic or prophylactic, and other factors known to skilled practitioners. The administration of an anti-cancer therapeutic agent (e.g., an anti-cancer antibody) may be essentially continuous over a preselected period of time or may be in a series of spaced dose, e.g., either before, during, or after developing cancer.

As used herein, the term “treating” refers to the application or administration of a composition including one or more active agents to a subject, who has a cancer, a symptom of a cancer, or a predisposition toward a cancer, with the purpose to cure, heal, alleviate, relieve, alter, remedy, ameliorate, improve, or affect the cancer or one or more symptoms of the cancer, or the predisposition toward a cancer.

Alleviating a cancer includes delaying the development or progression of the disease or reducing disease severity. Alleviating the disease does not necessarily require curative results. As used therein, “delaying” the development of a disease (e.g., a cancer) means to defer, hinder, slow, retard, stabilize, and/or postpone progression of the disease. This delay can be of varying lengths of time, depending on the history of the disease and/or individuals being treated. A method that “delays” or alleviates the development of a disease, or delays the onset of the disease, is a method that reduces probability of developing one or more symptoms of the disease in a given period and/or reduces extent of the symptoms in a given time frame, when compared to not using the method. Such comparisons are typically based on clinical studies, using a number of subjects sufficient to give a statistically significant result.

“Development” or “progression” of a disease means initial manifestations and/or ensuing progression of the disease. Development of the disease can be detected and assessed using clinical techniques known in the art. However, development also refers to progression that may be undetectable. For purpose of this disclosure, development or progression refers to the biological course of the symptoms. “Development” includes occurrence, recurrence, and onset. As used herein “onset” or “occurrence” of a cancer includes initial onset and/or recurrence.

Conventional methods, known to those of ordinary skill in the art of medicine, may be used to administer the anti-cancer therapeutic agent to the subject, depending upon the type of disease to be treated or the site of the disease. The anti-cancer therapeutic agent can also be administered via other conventional routes, e.g., administered orally, parenterally, by inhalation spray, topically, rectally, nasally, buccally, vaginally or via an implanted reservoir. The term “parenteral” as used herein includes subcutaneous, intracutaneous, intravenous, intramuscular, intraarticular, intraarterial, intrasynovial, intrasternal, intrathecal, intralesional, and intracranial injection or infusion techniques. In addition, an anti-cancer therapeutic agent may be administered to the subject via injectable depot routes of administration such as using 1-, 3-, or 6-month depot injectable or biodegradable materials and methods.

In one embodiment, an anti-cancer therapeutic agent is administered via site-specific or targeted local delivery techniques. Examples of site-specific or targeted local delivery techniques include various implantable depot sources of the agent or local delivery catheters, such as infusion catheters, an indwelling catheter, or a needle catheter, synthetic grafts, adventitial wraps, shunts and stents or other implantable devices, site specific carriers, direct injection, or direct application. See, e.g., PCT Publication No. WO 00/53211 and U.S. Pat. No. 5,981,568, the contents of each of which are incorporated by reference herein for this purpose.

In some embodiments, more than one anti-cancer therapeutic agent, such as an antibody and a small molecule inhibitory compound, may be administered to a subject in need of the treatment. The agents may be of the same type or different types from each other. At least one, at least two, at least three, at least four, or at least five different agents may be co-administered. Generally anti-cancer agents for administration have complementary activities that do not adversely affect each other. Anti-cancer therapeutic agents may also be used in conjunction with other agents that serve to enhance and/or complement the effectiveness of the agents.

Treatment efficacy can be assessed by methods well-known in the art, e.g., monitoring tumor growth or formation in a patient subjected to the treatment. Alternatively, or in addition to, treatment efficacy can be assessed by monitoring tumor type over the course of treatment (e.g., before, during, and after treatment).

In some embodiments, an anti-cancer therapeutic agent is an antibody, an immunotherapy, a radiation therapy, a surgical therapy, and/or a chemotherapy.

Examples of the antibody anti-cancer agents include, but are not limited to, alemtuzumab (Campath), trastuzumab (Herceptin), Ibritumomab tiuxetan (Zevalin), Brentuximab vedotin (Adcetris), Ado-trastuzumab emtansine (Kadcyla), blinatumomab (Blincyto), Bevacizumab (Avastin), Cetuximab (Erbitux), ipilimumab (Yervoy), nivolumab (Opdivo), pembrolizumab (Keytruda), atezolizumab (Tecentriq), avelumab (Bavencio), durvalumab (Imfinzi), and panitumumab (Vectibix).

Examples of an immunotherapy include, but are not limited to, a PD-1 inhibitor or a PD-L1 inhibitor (e.g., nivolumab (Opdivo), pembrolizumab (Keytruda), atezolizumab (Tecentriq), avelumab (Bavencio), durvalumab (Imfinzi)), a CTLA-4 inhibitor, adoptive cell transfer, therapeutic cancer vaccines, oncolytic virus therapy, T-cell therapy, and immune checkpoint inhibitors.

Examples of radiation therapy include, but are not limited to, ionizing radiation, gamma-radiation, neutron beam radiotherapy, electron beam radiotherapy, proton therapy, brachytherapy, systemic radioactive isotopes, and radiosensitizers.

Examples of a surgical therapy include, but are not limited to, a curative surgery (e.g., tumor removal surgery), a preventive surgery, a laparoscopic surgery, and a laser surgery.

Examples of the chemotherapeutic agents include, but are not limited to, Carboplatin or Cisplatin, Docetaxel, Gemcitabine, Nab-Paclitaxel, Paclitaxel, Pemetrexed, and Vinorelbine. Additional examples of chemotherapy include, but are not limited to, Platinating agents, such as Carboplatin, Oxaliplatin, Cisplatin, Nedaplatin, Satraplatin, Lobaplatin, Triplatin, Tetranitrate, Picoplatin, Prolindac, Aroplatin and other derivatives; Topoisomerase I inhibitors, such as Camptothecin, Topotecan, irinotecan/SN38, rubitecan, Belotecan, and other derivatives; Topoisomerase II inhibitors, such as Etoposide (VP-16), Daunorubicin, a doxorubicin agent (e.g., doxorubicin, doxorubicin hydrochloride, doxorubicin analogs, or doxorubicin and salts or analogs thereof in liposomes), Mitoxantrone, Aclarubicin, Epirubicin, Idarubicin, Amrubicin, Amsacrine, Pirarubicin, Valrubicin, Zorubicin, Teniposide and other derivatives; Antimetabolites, such as Folic family (Methotrexate, Pemetrexed, Raltitrexed, Aminopterin, and relatives or derivatives thereof); Purine antagonists (Thioguanine, Fludarabine, Cladribine, 6-Mercaptopurine, Pentostatin, clofarabine, and relatives or derivatives thereof) and Pyrimidine antagonists (Cytarabine, Floxuridine, Azacitidine, Tegafur, Carmofur, Capacitabine, Gemcitabine, hydroxyurea, 5-Fluorouracil (5FU), and relatives or derivatives thereof); Alkylating agents, such as Nitrogen mustards (e.g., Cyclophosphamide, Melphalan, Chlorambucil, mechlorethamine, Ifosfamide, mechlorethamine, Trofosfamide, Prednimustine, Bendamustine, Uramustine, Estramustine, and relatives or derivatives thereof); nitrosoureas (e.g., Carmustine, Lomustine, Semustine, Fotemustine, Nimustine, Ranimustine, Streptozocin, and relatives or derivatives thereof); Triazenes (e.g., Dacarbazine, Altretamine, Temozolomide, and relatives or derivatives thereof); Alkyl sulphonates (e.g., Busulfan, Mannosulfan, Treosulfan, and relatives or derivatives thereof); Procarbazine; Mitobronitol, and Aziridines (e.g., Carboquone, Triaziquone, ThioTEPA, triethylenemalamine, and relatives or derivatives thereof); Antibiotics, such as Hydroxyurea, Anthracyclines (e.g., doxorubicin agent, daunorubicin, epirubicin and relatives or derivatives thereof); Anthracenediones (e.g., Mitoxantrone and relatives or derivatives thereof); Streptomyces family antibiotics (e.g., Bleomycin, Mitomycin C, Actinomycin, and Plicamycin); and ultraviolet light.

Having thus described several aspects and embodiments of the technology set forth in the disclosure, it is to be appreciated that various alterations, modifications, and improvements will readily occur to those skilled in the art. Such alterations, modifications, and improvements are intended to be within the spirit and scope of the technology described herein. For example, those of ordinary skill in the art will readily envision a variety of other means and/or structures for performing the function and/or obtaining the results and/or one or more of the advantages described herein, and each of such variations and/or modifications is deemed to be within the scope of the embodiments described herein. Those skilled in the art will recognize or be able to ascertain using no more than routine experimentation many equivalents to the specific embodiments described herein. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, kits, and/or methods described herein, if such features, systems, articles, materials, kits, and/or methods are not mutually inconsistent, is included within the scope of the present disclosure.

The above-described embodiments can be implemented in any of numerous ways. One or more aspects and embodiments of the present disclosure involving the performance of processes or methods may utilize program instructions executable by a device (e.g., a computer, a processor, or other device) to perform, or control performance of, the processes or methods. In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement one or more of the various embodiments described above. The computer readable medium or media can be transportable, such that the program or programs stored thereon can be loaded onto one or more different computers or other processors to implement various ones of the aspects described above. In some embodiments, computer readable media may be non-transitory media.

The terms “program” or “software” are used herein in a generic sense to refer to any type of computer code or set of computer-executable instructions that can be employed to program a computer or other processor to implement various aspects as described above. Additionally, it should be appreciated that according to one aspect, one or more computer programs that when executed perform methods of the present disclosure need not reside on a single computer or processor but may be distributed in a modular fashion among a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a Personal Digital Assistant (PDA), a smartphone, a tablet, or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible formats.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The terms “approximately,” “substantially,” and “about” may be used to mean within ±20% of a target value in some embodiments, within ±10% of a target value in some embodiments, within ±5% of a target value in some embodiments, within ±2% of a target value in some embodiments. The terms “approximately,” “substantially,” and “about” may include the target value.

1. A method for using a trained neural network model to identify at least one tertiary lymphoid structure (TLS) in an image of tissue obtained from a subject having, at risk of having, or suspected of having cancer, the method comprising:
using at least one computer hardware processor to perform:
obtaining a set of overlapping sub-images of the image of tissue;
processing the set of overlapping sub-images using the trained neural network model to obtain a respective set of pixel-level sub-image masks, each of the set of pixel-level sub-image masks indicating, for each particular pixel of multiple individual pixels in a respective particular sub-image, a respective probability that the particular pixel is part of a tertiary lymphoid structure;
determining a pixel-level mask for at least a portion of the image of the tissue covered by at least some of the sub-images in the set of overlapping sub-images, the determining comprising determining the pixel-level mask using at least some of the set of pixel-level sub-image masks corresponding to the at least some of the set of overlapping sub-images covering at least the portion of the image;
identifying boundaries of at least one TLS in at least the portion of the image using the pixel-level mask; and
identifying one or more features of the at least one TLS using the identified boundaries and at least the portion of the image.

2. The method of claim 1, wherein the image of the tissue is a whole slide image (WSI).

3. (canceled)

4. The method of claim 1, wherein the image is a three-channel image comprising at least 10,000 by 10,000 pixel values per channel.

5-9. (canceled)

10. The method of claim 1, wherein the trained neural network model comprises at least 10 million, at least 25 million, at least 50 million, or at least 100 million parameters.

11. The method of claim 1, wherein the trained neural network model comprises an encoder sub-model, a decoder sub-model, and an auxiliary classifier sub-model.

12. The method of claim 11, wherein the encoder sub-model comprises: a plurality of resolution-separation neural network portions and a plurality of resolution-fusion neural network portions.

13. The method of claim 11, wherein the encoder sub-model comprises:
an adapter neural network portion;
a bottleneck neural network portion having an input coupled to the output of the adapter neural network portion;
a first resolution-separation neural network portion having an input coupled to the output of the bottleneck neural network portion;
a first resolution-fusion neural network portion having an input coupled to the output of the first resolution-separation neural network portion;
a second resolution-separation neural network portion having an input coupled to the output of the first resolution-fusion neural network portion; and
a second resolution-fusion neural network portion having an input coupled to the output of the second resolution-separation neural network portion.

14. The method of claim 13, wherein the encoder sub-model further comprises:
a third resolution-separation neural network portion having an input coupled to the output of the second resolution-fusion neural network portion; and
a third resolution-fusion neural network portion having an input coupled to the output of the third resolution-separation neural network portion.

15. The method of claim 11, wherein the decoder sub-model further comprises:
an atrous spatial pyramid pooling (ASPP) neural network portion;
an upsampling layer having an input coupled to the output of the ASPP neural network portion;
a projection neural network portion;
a classification neural network portion having an input coupled to the output of the upsampling layer and the projection neural network portion, wherein the classification neural network portion is configured to output a pixel-level mask, indicating, for each particular pixel of multiple individual pixels in an image being processed by the trained neural network model, a respective probability that the particular pixel is part of a tertiary lymphoid structure.

16. The method of claim 14, wherein the decoder sub-model further comprises:
an atrous spatial pyramid pooling (ASPP) neural network portion having an input coupled to an output of the third resolution-fusion neural network portion;
an upsampling layer having an input coupled to the output of the ASPP neural network portion;
a projection neural network portion having an input coupled to an output of the bottleneck neural network portion; and
a classification neural network portion having an input coupled to the output of the upsampling layer and the projection neural network portion, wherein the classification neural network portion is configured to output a pixel-level mask, indicating, for each particular pixel of multiple individual pixels in an image being processed by the trained neural network model, a respective probability that the particular pixel is part of a tertiary lymphoid structure.

17. (canceled)

18. The method of claim 1, wherein determining the pixel-level mask for at least the portion of the image by at least some of the sub-images comprises:
determining weighting matrices for the at least some of the set of pixel-level sub-image masks; and
determining the pixel-level mask as a weighted combination of the pixel-level sub-image masks weighted, element-wise, by the respective weighting matrices.

19. The method of claim 1, wherein identifying the boundaries of the at least one TLS in at least the portion of the image comprises:
generating a binary version of the pixel-level mask; and
identifying contours of the at least one TLS by applying a border-following algorithm to the binary version of the pixel-level mask.

20. The method of claim 1, wherein identifying the one or more features of the at least one TLS comprises identifying at least one feature selected from the group consisting of: a number of TLSs in at least the portion of the image, the number of TLSs in at least the portion of the image normalized by area of at least the portion of the image, a total area of TLSs in at least the portion of the image, the total area of TLSs in at least the portion of the image normalized by the area of at least the portion of the image, median area of TLSs in at least the portion of the image, the median area of TLSs in at least the portion of the image normalized by the area of at least the portion of the image.

21.-27. (canceled)

28. The method of claim 1, wherein the cancer is lung adenocarcinoma, breast cancer, cervical squamous cell carcinoma, lung squamous cell carcinoma, head & neck squamous cell carcinoma, gastric adenocarcinoma, colorectal adenocarcinoma, liver adenocarcinoma, pancreatic adenocarcinoma, or melanoma.

29. The method of claim 1, further comprising:
determining, based on the one or more features of the at least one TLS, to administer an immunotherapy to the subject; and
administering the immunotherapy to the subject.

30-31. (canceled)

32. The method of claim 1, wherein at least the portion of the image includes at least 75%, at least 80%, at least 90%, at least 95%, at least 99%, or 100% of pixels of the image.

33. At least one non-transitory computer readable storage medium storing processor executable instructions that, when executed by at least one processor, cause the at least one processor to perform the method for using a trained neural network model to identify at least one tertiary lymphoid structure (TLS) in an image of tissue obtained from a subject having, at risk of having, or suspected of having cancer, the method comprising:
obtaining a set of overlapping sub-images of the image of tissue;
processing the set of overlapping sub-images using the trained neural network model to obtain a respective set of pixel-level sub-image masks, each of the set of pixel-level sub-image masks indicating, for each particular pixel of multiple individual pixels in a respective particular sub-image, a respective probability that the particular pixel is part of a tertiary lymphoid structure;
determining a pixel-level mask for at least a portion of the image of the tissue covered by at least some of the sub-images in the set of overlapping sub-images, the determining comprising determining the pixel-level mask using at least some of the set of pixel-level sub-image masks corresponding to the at least some of the set of overlapping sub-images covering at least the portion of the image;
identifying boundaries of at least one TLS in at least the portion of the image using the pixel-level mask; and
identifying one or more features of the at least one TLS using the identified boundaries and at least the portion of the image.

34. A system, comprising:
at least one computer hardware processor; and
at least one non-transitory computer readable storage medium storing processor executable instructions that, when executed by at least one processor, cause the at least one processor to perform the method for using a trained neural network model to identify at least one tertiary lymphoid structure (TLS) in an image of tissue obtained from a subject having, at risk of having, or suspected of having cancer, the method comprising:
obtaining a set of overlapping sub-images of the image of tissue;
processing the set of overlapping sub-images using the trained neural network model to obtain a respective set of pixel-level sub-image masks, each of the set of pixel-level sub-image masks indicating, for each particular pixel of multiple individual pixels in a respective particular sub-image, a respective probability that the particular pixel is part of a tertiary lymphoid structure;
determining a pixel-level mask for at least a portion of the image of the tissue covered by at least some of the sub-images in the set of overlapping sub-images, the determining comprising determining the pixel-level mask using at least some of the set of pixel-level sub-image masks corresponding to the at least some of the set of overlapping sub-images covering at least the portion of the image;
identifying boundaries of at least one TLS in at least the portion of the image using the pixel-level mask; and
identifying one or more features of the at least one TLS using the identified boundaries and at least the portion of the image.
